(19) United States
(12) Patent Application Publication
(10) Pub. No.: US 2011/0072494 A1
(43) Pub. Date: Mar. 24, 2011

(54) INTERFACE APPARATUS, CONTROL METHOD OF INTERFACE APPARATUS, CONTROL PROGRAM OF INTERFACE APPARATUS, AND COMPUTER-READABLE STORAGE MEDIUM STORING THE CONTROL PROGRAM

(75) Inventor: Koji SATO, Osaka (JP)

(73) Assignee: SHARP KABUSHIKI KAISHA, Osaka-shi (JP)

(21) Appl. No.: 12/708,797

(22) Filed: Feb. 19, 2010

(30) Foreign Application Priority Data
Feb. 20, 2009 (JP) 2009-37995
Jun. 4, 2009 (JP) 2009-135287

(51) Int. Cl. G06N 5/02; G06F 3/048; H04L 9/32

(52) U.S. Cl. 726/4; 706/47; 715/776; 715/845

(57) ABSTRACT

Various kinds of content items are dealt with by a single interface apparatus. A content processing apparatus 1 of the present invention includes: a metaphor managing section 13 for selecting one metaphor from among a plurality of metaphors, each of the metaphors including information for displaying the basic operation screen and information for interpreting a nature of an entry operation in a situation where the basic operation screen is being displayed; a layout control section 11 for displaying the basic operation screen according to a metaphor selected by the metaphor managing section 13; and an operation information interpreting section 10 for interpreting a nature of a user's entry operation according to a metaphor selected by the metaphor managing section 13. This makes it possible to deal with various kinds of content items using a single interface apparatus.

This Nonprovisional application claims priority under 35 U.S.C. §119(a) on Patent Application No. 037995/2009 filed in Japan on Feb. 20, 2009, and No. 135287/2009 filed in Japan on Jun. 4, 2009, the entire contents of which are hereby incorporated by reference.

### TECHNICAL FIELD

The present invention relates to an interface apparatus that provides an interface presenting a content item so that a user can perform on the content item various kinds of operations such as viewing. More specifically, the present invention relates to: an interface apparatus that provides consistent and accessible means through which the user can manipulate and view the content item and perform other operations on the content item; a control method of the interface apparatus; a control program of the interface apparatus; and a computer-readable storage medium storing the control program.

### BACKGROUND ART

With the advance in the network technologies, an environment where various kinds of information are accessible anywhere at anytime has been on its way to becoming established. For example, such an infrastructure is being developed that allows users to access information or services online through the use of a mobile device or a mobile phone regardless of time and place.

Thus, the basic infrastructure for obtaining multimedia information has been developed in recent years. However, the problem is how the user accesses various kinds of information or services. That is, in general, in order to access various kinds of information or services via a network, a user must use different access methods, depending on an application used, a target service, the content of target information, the type of the device used, and/or others.

Therefore, the user must be thoroughly familiar with how to access services and information and how to use an application, according to the services and information. Otherwise, the user cannot easily obtain multimedia information, or even if the user could obtain the multimedia information, the user would not be able to use it.

Therefore, how smoothly a user can access necessary information is important. In order to achieve this, studies on what man-machine interfaces should be are now being conducted. In particular, devices and application software used by many users are expected to be user-friendly and intuitive to operate.

For example, Patent Literature 1 listed below describes that a data file is displayed in a book format. Specifically, Patent Literature 1 displays, as a menu screen, an image showing a bookshelf that stores books each having a filename of a file stored in a memory on its spine label. When any one of the books displayed is selected, a moving image of the selected book being opened is displayed, and then the opened page of the selected book displays an initial screen which is to be displayed when a file corresponding to a filename shown on the selected book is executed.

According to the above arrangement, it is possible to deal with a file with a self-explanatory, book-like interface. This makes it possible even for a user unfamiliar with computers to easily view files.

Patent Literature 2 listed below describes a method for displaying information on a network with use of a book-like interface, i.e. a method for displaying a web book.

Specifically, the arrangement described in Patent Literature 2 is as follows: Firstly, link documents constituting one web book are collected by following a link (URL: Uniform Resource Locator) on a homepage or by user's manual entry of an URL. Then, the link documents collected are reconfigured and displayed as a book image.

According to the above arrangement, the user can view and edit web pages to which links are provided and user-specified web pages in much the same way the user turns over pages of one book. According to the above arrangement, it is therefore possible to provide a self-explanatory and user-friendly interface.

### Citation List

Patent Literature 1

Japanese Patent Application Publication, Tokukaihei, No. 9-44327 A (Publication Date: Feb. 14, 1997)

Patent Literature 2

Japanese Patent Application Publication, Tokukaihei, No. 9-138745 A (Publication Date: May 27, 1997)

### SUMMARY OF INVENTION

### Technical Problem

The technique of Patent Literature 1, however, is merely a technique for simply mapping book icons or mapping file names on the book icons and executing (activating) a certain file or an application associated with that file.

This method just performs mapping using a conventional computer-based file system, and is troublesome in a case where the number of files to be operated is great. Further, this method uses a hierarchical directory as it is. Therefore, as the file hierarchy under the file system becomes deeper, required operation necessarily becomes more complex.

The technique of Patent Literature 2 focuses on constituting link documents as a book. Therefore, this technique provides user-friendliness, since web pages inherently have a document-like nature. However, uses of an interface employing this technique are limited.

An interface enabling access to various services or information through various routes needs to provide accessible approaches and a mechanism applicable more widely. Further, it is desirable that such an interface provides consistent approaches for accessing various kinds of information, including searching and sorting methods.

The present invention has been attained in view of the foregoing problems, and an object of the present invention is to provide an interface apparatus that enables manipulation of a content item in various manners by itself, and thus makes it possible to deal with content items obtained through various channels of distribution.

### Solution to Problem

An interface apparatus according to the present invention, in order to solve the above problem, is an interface apparatus which displays an entry operation acceptance screen for causing a user to select one or more content items from among a plurality of content items and interprets an entry operation inputted by the user according to the displayed entry operation acceptance screen so as to determine a content item selected by the user, the interface apparatus comprising: a ruleset selecting section for selecting one ruleset from among a plurality of rulesets, each of the rulesets including information for displaying the entry operation acceptance screen and information for interpreting a nature of an entry operation in a situation where the entry operation acceptance screen is displayed; a screen display section for displaying the entry operation acceptance screen according to a ruleset selected by the ruleset selecting section; and an operation information interpreting section for interpreting a nature of a user's entry operation according to a ruleset selected by the ruleset selecting section.

A control method of an interface apparatus according to the present invention, in order to solve the above problem, is a control method of an interface apparatus which displays an entry operation acceptance screen for causing a user to select one or more content items from among a plurality of content items and interprets an entry operation inputted by the user according to the displayed entry operation acceptance screen so as to determine a content item selected by the user, the control method comprising: a ruleset selecting step of selecting one ruleset from among a plurality of rulesets, each of the rulesets including information for displaying the entry operation acceptance screen and information for interpreting a nature of an entry operation in a situation where the entry operation acceptance screen is displayed; a screen display step of displaying the entry operation acceptance screen according to a ruleset selected in the ruleset selecting step; and an operation information interpreting step of interpreting a nature of a user's entry operation according to a ruleset selected in the ruleset selecting step.

According to the above arrangement and method, display of the screen and interpretation of the user's entry operation are performed according to a single ruleset selected from among a plurality of rulesets. That is, the displayed screen and the interpretation of the entry operation vary according to the selected ruleset.

Therefore, the above arrangement and method allows the user to manipulate content items in various manners using a single interface apparatus. This also makes it possible to deal with various kinds of content items obtained through various channels of distribution, using a single interface apparatus.

Additional objects, features, and strengths of the present invention will be made clear by the description below. Further, the advantages of the present invention will be evident from the following explanation in reference to the drawings.

### ADVANTAGEOUS EFFECTS OF INVENTION

As described above, an interface apparatus according to the present invention includes: a ruleset selecting section for selecting one ruleset from among a plurality of rulesets, each of the rulesets including information for displaying the entry operation acceptance screen and information for interpreting a nature of an entry operation in a situation where the entry operation acceptance screen is being displayed; a screen display section for displaying the entry operation acceptance screen according to a ruleset selected by the ruleset selecting section; and an operation information interpreting section for interpreting a nature of a user's entry operation according to a ruleset selected by the ruleset selecting section.

As described above, a control method of an interface apparatus according to the present invention includes: a ruleset selecting step of selecting one ruleset from among a plurality of rulesets, each of the rulesets including information for displaying the entry operation acceptance screen and information for interpreting a nature of an entry operation in a situation where the entry operation acceptance screen is displayed; a screen display step of displaying the entry operation acceptance screen according to a ruleset selected in the ruleset selecting step; and an operation information interpreting step of interpreting a nature of a user's entry operation according to a ruleset selected in the ruleset selecting step.

This yields the effect that allows the user to manipulate content items in various manners using a single interface apparatus. This also makes it possible to deal with various kinds of content items obtained through various channels of distribution, using a single interface apparatus.

### BRIEF DESCRIPTION OF DRAWINGS

FIG. 1 is a block diagram showing essential components of a content processing apparatus according to one embodiment of the present invention.

FIG. 2 is a view showing an exemplary content management table stored in the content processing apparatus.

FIG. 3 is a view showing an exemplary processing pattern ruleset stored in the content processing apparatus.

FIG. 4 is a view showing another exemplary processing pattern ruleset stored in the content processing apparatus.

FIG. 5 is a view showing an exemplary metaphor display management table stored in the content processing apparatus.

FIG. 6 is a view showing an exemplary book information management table stored in the content processing apparatus.

FIG. 7 is a view showing another exemplary book information management table stored in the content processing apparatus.

FIG. 8 is a view showing an exemplary operation history management table stored in the content processing apparatus.

FIG. 9 is a flow chart showing an exemplary process executed by the content processing apparatus.

FIG. 10 is a flow chart showing an exemplary layouting and displaying process executed by the content processing apparatus.

FIG. 11 is a flow chart showing an exemplary metaphor changing process executed by the content processing apparatus.

FIG. 12 is a sequence diagram showing an exemplary authentication process performed in the metaphor changing process.

FIG. 13 is a flow chart showing an exemplary book management information reconfiguration process performed in the metaphor changing process.

FIG. 14 is a view illustrating an exemplary screen layout of an image for entry operation displayed by the content processing apparatus.

FIG. 15(a) is a view showing an exemplary display screen displayed for one user when an image for entry operation is displayed according to the screen layout.

FIG. 15(b) is a view showing an exemplary display screen displayed for another user when an image for entry operation is displayed according to the screen layout.

FIG. 16 is a view showing an exemplary index list screen displayed when a book having “DOC” on its spine label is selected in the image for entry operation, in the content processing apparatus.

FIG. 17 is a view showing an exemplary viewer screen displayed when a document is selected in the index list screen.

FIG. 18 is a view showing an exemplary display screen observed when “New arrival” is caused to appear in a shelf display class display field included in the image for entry operation.

FIG. 19 is a view showing an exemplary index list screen to be displayed when a book having “Movie” on its spine label is selected in the image for entry operation, in the content processing apparatus.

FIG. 20 is a view showing an exemplary display screen observed when “Viewed” is caused to appear in the shelf display class display field.

FIG. 21 is a view showing an exemplary index list screen to be displayed when a History book is selected in the content processing apparatus.

FIG. 22 is a view showing an exemplary index list screen to be displayed when the History book is selected, wherein content names of content items viewed on the date previous to the current date are shown.

FIG. 23 is a view showing an exemplary display screen observed before the shelf display class display field is touched.

FIG. 24 is a view showing an exemplary display screen observed after the shelf display class display field is touched.

FIG. 25 is a view showing an exemplary display screen observed when “New arrival” is selected from a drop-down list that appears with a touch of the shelf display class display field.

FIG. 26 is a view showing an exemplary display screen observed when “Recommend” is caused to appear in the shelf display class display field.

FIG. 27 is a view showing an exemplary index list screen displayed when a Recommend book is selected.

FIG. 28 is a view showing an exemplary display screen observed when a processing pattern ruleset is switched to another, in a state where a drop-down menu appears with a touch of a name display field.

FIG. 29 is a view showing an exemplary display screen observed when a processing pattern ruleset is switched to another, in a state where a processing pattern ruleset designated by entry operation for the switchover is selected from drop-down menu options.

FIG. 30 is a view showing an exemplary display screen observed when a processing pattern ruleset is switched to another, and showing an exemplary basic operation screen observed after the switchover.

FIG. 31 is a view showing an exemplary index list screen displayed when a Data book is selected.

FIG. 32 is a view showing an exemplary display screen observed when “Date” is caused to appear in the shelf display class display field.

FIG. 33 is a view showing an exemplary index list screen displayed when a Sensor book is selected.

FIG. 34 is a view showing an exemplary image displayed when “Snapshot14” is selected in the index list screen for the Sensor book.

FIG. 35 is a view showing another exemplary index list screen displayed when a Sensor is selected.

FIG. 36 is a view showing an exemplary image displayed when “Value14” is selected from the index list screen for the Sensor book.

FIG. 37 is a view showing an exemplary display screen observed when a plurality of items are selected at a time in the index list screen for the Sensor book.

FIG. 38 is a view showing an exemplary display screen observed after the plurality of items are selected at a time in the index list screen for the Sensor book.

FIG. 39 is a view showing an exemplary display screen observed when a sort button is selected in the index list screen.

FIG. 40 is a view showing an exemplary display screen observed after sorting is performed in the index list screen.

### DESCRIPTION OF EMBODIMENTS

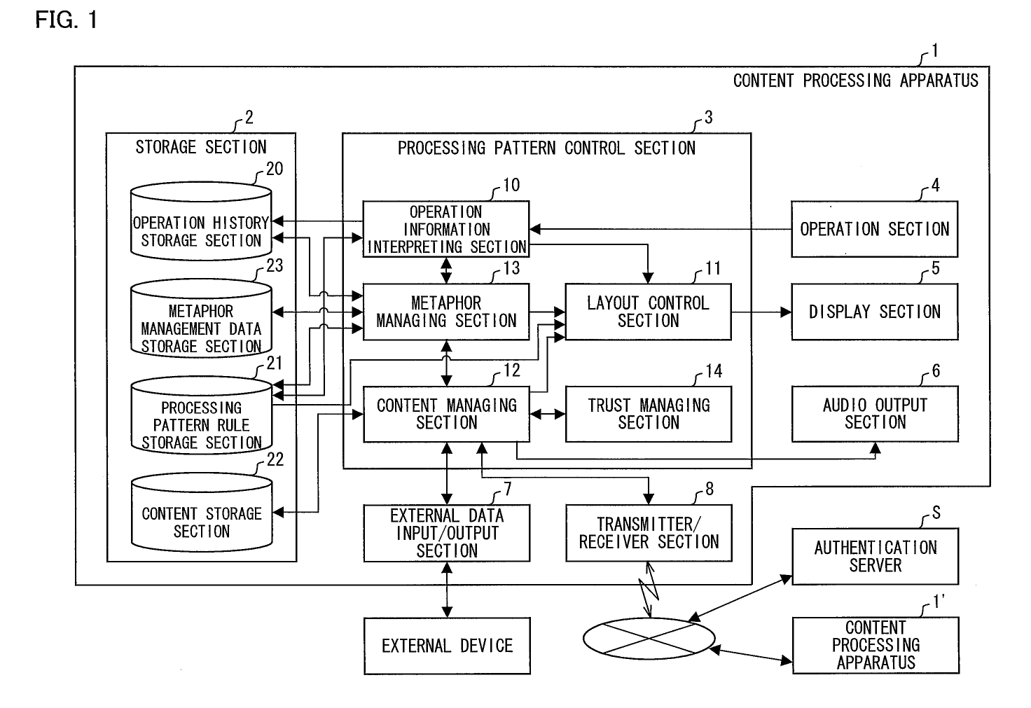

One embodiment of the present invention is described below with reference to FIGS. 1 through 39.

[Configuration of a Content Processing Apparatus According to the Embodiment]

First, a schematic configuration of a content processing apparatus according to the present embodiment is described with reference to FIG. 1. FIG. 1 is a block diagram showing essential components of the content processing apparatus of the present embodiment.

As shown in FIG. 1, a content processing apparatus (interface apparatus) 1 includes a storage section 2, a processing pattern control section 3, an operation section 4, a display section 5, audio output section 6, an external data input/output section 7, and a transmitter/receiver section (communication section) 8. Further, as shown in FIG. 1, the processing pattern control section 3 includes an operation information interpreting section (operation information interpreting section) 10, a layout control section (screen display section) 11, a content managing section 12, a metaphor managing section (ruleset selecting section, ruleset obtaining section) 13, and a trust managing section (sub-rule authenticating section, ruleset authenticating section) 14. The storage section 2 includes an operation history storage section 20, a processing pattern rule storage section 21, a content storage section 22, and a metaphor management data storage section (selected content item information storage section, yet-to-be selected content item information storage section) 23.

The content processing apparatus 1 performs content management and content output. The content processing apparatus 1 displays an image for entry operation on the display section 5 to accept user's entry operation. The content processing apparatus 1 executes processing on a content item selected by the user's entry operation and then outputs the result of the processing.

As will be described in detail, the content processing apparatus 1 groups content items into groups according to a processing pattern ruleset that defines a processing pattern of a content item. Then, using a metaphor display management table that defines a presentation manner of a content item to a user, the content processing apparatus 1 displays an image of the groups depicted respectively as books arranged in a bookshelf. Such an image that depicts the arrangement of the books corresponding to the respective groups in the bookshelf is a basic screen for entry operation (hereinafter referred to as basic operation screen) in the content processing apparatus 1.

More specifically, the content processing apparatus 1 determines the processing pattern of a content item and the presentation manner of a content item to the user according to the processing pattern ruleset and the metaphor display management table. A metaphor herein refers to a collection of a series of rules, including the processing pattern of a content item and the presentation manner of a content item to the user, for presenting a content item to the user so as to prompt the user to manipulate the content item.

When any of the books is selected through the basic operation screen, the content processing apparatus 1 displays a screen showing an animation (moving image) of the selected book being opened, together with a screen showing an index list of content items contained in the selected book.

On the screen showing the index list (hereinafter referred to as an index list screen) are displayed a list of e.g. (i) content element information items included in a group corresponding to the selected book, content names, and thumbnail images. The list is displayed in a form like an index list in a book. When a content item shown on the index list screen is selected, the result of processing concerning the selected content item is outputted (for example, in a visual form and/or in an audio form) by the content processing apparatus 1. Note that the elements constituting the index list of the book can be information managed in a content management table, and the settings of the content management table may be changed, as will be described later in detail.

Further, as described above, the content processing apparatus 1 implements the selection of a content item or information classified in a book format according to the processing pattern ruleset. This allows the user to check content items to be manipulated in the same way the user turns to a desired page in a real book and then select a content item so that the content processing apparatus 1 executes processing for the selected content item and then outputs the processing result.

A key feature of the content processing apparatus 1 is that it allows for a switchover among metaphors. That is, the content processing apparatus 1 can collectively switch criteria on which content items are grouped, a processing pattern, a display format, and the like. This allows the user to carry out content management, content viewing, and the like in a manner defined by the metaphor. Moreover, every single metaphor includes various kinds of rules on content processing. This allows the user to deal with various kinds of content items by means of a common interface using a single content processing apparatus 1.

Another feature of the content processing apparatus 1 is that it allows for obtaining of a metaphor from an external entity. That is, the content processing apparatus 1 can introduce metaphor information that has not presented therein from outside the content processing apparatus 1. This allows the user of the content processing apparatus 1 to use content classification, processing pattern, and display format which have been used by another user, as if they are of the content processing apparatus 1.

In addition, the content processing apparatus 1 can realize information extraction by an interface using a bookshelf metaphor. This makes it possible to provide a classification method that effectively facilitates visual understanding of information, such as arrangement of the latest information in a shelf for new arrivals, resulting in access to one information item through various routes.

Each of the metaphors has a metaphor ID. Upon switchover to another metaphor, the management tables associated with a corresponding metaphor ID to be referred to are all changed. That is, upon switchover to another metaphor, data to be referred to are changed in the tables containing the metaphor ID (the processing pattern ruleset, the metaphor display management table, and a book information management table that will be described later). In other words, switchover to another metaphor is carried out by switchover to another series of rules (the processing pattern ruleset, the metaphor display management table, and the book information management table (described later)).

Further, in the content processing apparatus 1, conditions for authentication can be set up for each of the metaphors. Unless the authentication required for the reference to the metaphor has been made, access to necessary information is not permitted. Moreover, different conditions for authentication can be set up for the processing pattern ruleset associated with the metaphor ID. In such a case, after an authentication process demanded has been undergone, updating of each table and reference to each table are permitted.

The storage section 2 is a device that stores various kinds of data used in the content processing apparatus 1 in such a manner that the processing pattern control section 3 can read out the data. To realize the functions of the processing pattern control section 3 by means of software, a program for realizing the functions of the processing pattern control section 3 is stored in the storage section 2.

The processing pattern control section 3 is a functional module for determining the processing pattern of a content item on the basis of a particular ruleset and defining control methods including display and operation of a content item. The functions of the processing pattern control section 3 are realized by the following sub-modules: the operation information interpreting section 10; the layout control section 11; the content management section 12; the metaphor managing section 13, and the trust managing section 14.

The operation section 4, upon receipt of user's entry into the content processing apparatus 1, outputs operation information indicating the nature of user's entry operation to the operation information interpreting section 10. The operation section 4 is herein assumed to be a touch panel although the operation section 4 can be realized by an input device, such as a keyboard, a mouse, a keypad, or operation buttons, for example. That is, the operation section 4 detects the location where a touch of the display section 5 is made and then outputs information indicative the detected location (e.g. coordinates) and information on manipulation (e.g. information indicating being pressed or released), both of which serve as operation information, to the operation information interpreting section 10.

The display section 5 is output equipment that displays e.g. a content item and information related to the content item. For example, the layout control section 11 displays the above-described basic operation screen on the display section 5. The user performs an entry operation according to the basic operation screen displayed on the display section 5, so that reproduction (output) results of information on a desired content item or a content item can be outputted onto the display section 5. As the display section 5, an output device can be used such as a liquid crystal display, an LED display, a projector, or an electronic paper, for example.

The audio output section 6 outputs audio in accordance with an incoming audio signal or the like. For example, in a case where the content processing apparatus 1 outputs a content item containing sound, such as an audio file or a moving image file, the audio output section 6 outputs the corresponding sound. As the audio output section 6, general audio output equipment can be used such as a speaker or an earphone, for example.

The external data input/output section (external data receiving section) 7 performs data input/output from/to an external device, content acquisition, and the like operation via an input/output interface prepared in advance. For example, in a case where a content item to be outputted from the content processing apparatus 1 has not been stored in the storage section 2, the external data input/output section 7, in response to instruction from the content managing section 12, makes access to the external device to acquire a required content item. Note that the external data input/output section 7 may be a device capable of communications with the external device and performing input/output from/to the external device via a communication interface. Communications between the external data input/output section 7 and the external device may be made through wired or wireless connection. Further, the external device may be a storage device (a recording medium such as BD (Blu-Ray Disk®)), DVD (Digital Versatile Disk), CD-ROM (Compact Disk Read Only Memory), SD card, or flash memory, for example, or hard disk).

The transmitter/receiver section 8 is an interface via which access to a communication network is made for communications with other apparatus. Through the transmitter/receiver section 8, information for construction of the metaphor obtained from outside the content processing apparatus 1 is inputted and outputted to and from the content processing apparatus 1.

More specifically, the transmitter/receiver section 8 can communicate with a content processing apparatus 1′ (apparatus arranged in a manner similar to the content processing apparatus 1) via a communication network. Through the communications therebetween, input, output, or the like operation of metaphor data itself and information contained in the metaphor data is performed. In other words, the content processing apparatus 1 can obtain a metaphor from the content processing apparatus 1′ and offer a metaphor to the content processing apparatus 1′.

Note that a target apparatus for metaphor transmission and reception is not limited to the content processing apparatus 1′. For example, the content processing apparatus 1 transmits a metaphor stored therein to a server that performs metaphor distribution and management, so that the metaphor can be used in another apparatus, or a metaphor distributed from such a server can be used in the content processing apparatus 1. Processing concerning metaphor transmission and reception is performed under control of the metaphor managing section 13, as will be described in detail later.

Further, the transmitter/receiver section 8 can communicate with an authentication server (ruleset authentication server, extraction criteria authentication server) S via a communication network. The authentication server S authorizes the use of a metaphor in the content processing apparatus 1. That is, some of the metaphors require authorization for the use in the content processing apparatus 1. A process for obtaining authorization for the use of a metaphor through communications with the authentication server S is performed under control of the trust managing section 14, as will be described in detail later.

The operation information interpreting section 10 interprets user's operation information supplied from the operation section 4, with reference to the processing pattern ruleset stored in the processing pattern rule storage section 21. Then, the operation information interpreting section 10 notifies the content managing section 12, via the metaphor managing section 13, of control information that has been generated on the basis of the results of the above interpretation and is information for performing a content reproduction process and the like process.

As will be described in detail later, the processing pattern ruleset defines a collection of rules for presenting information of any content item in a book form and also defines a collection of rules for enabling manipulation of a content item on the basis of the processing pattern ruleset. With reference to the processing pattern ruleset, the operation information interpreting section 10 interprets an operation concerning a content item classified in each book, so that content-related processing is performed.

Further, the operation information interpreting section extracts the user's operation information and then accumulates the extracted information into the operation history storage section 20. The content processing apparatus 1 displays the nature of the user's entry operation as well in a book format with reference to the operation information, so that access to a content item can be accomplished in the foregoing manner.

The layout control section 11 determines and changes a layout of a screen display in accordance with instructions from the operation information interpreting section 10. Specifically, the layout control section 11 performs screen display control in the following manner. That is, the layout control section 11, with reference to the processing pattern ruleset stored in the processing pattern rule storage section 21, the metaphor display management table stored in the metaphor management data storage section 23, and the book information management table (described later), performs combination and extraction of elements constituting each book required for display of the image for entry operation, elements constituting the index list, and data elements constituting each page as a unit, and lays out information on the basis of the result of the combination and extraction, and then outputs the corresponding signals to the display section 5.

The content managing section 12 performs management of content items that can be outputted from the content processing apparatus 1, using the content management table. The content items that can be outputted from the content processing apparatus 1 are content items stored in the content storage section 22, content items available via the external data input/output section 7 or the transmitter/receiver section 8. Management information of these content items is retained on the content management table.

More specifically, the content managing section 12, upon receipt of instructions from the operation information interpreting section 10 to output a content item, checks on the presence of the target content item to be outputted, with reference to the content management table. If the target content item is stored in the content storage section 22, the content managing section 12 reads the target content item from the content storage section 22, executes the target content item, and then outputs the execution result. On the other hand, if the target content item is not stored in the content storage section 22, the content managing section 12 obtains the target content item via the external data input/output section 7 or the transmitter/receiver section 8 and then executes the obtained target content item.

Further, the content managing section 12 performs updating of the content management table in the event of addition of a new content item to the content storage section 22, in the event of deletion of any content item from the content storage section 22, in the event of modification to a content item available via the external data input/output section 7 or the transmitter/receiver section 8, and in the like event. This allows the user to accurately recognize content items that can be currently outputted from the content processing apparatus 1, even if changes occur in the content item that can be outputted from the content processing apparatus 1.

The metaphor managing section 13 performs metaphor management in an internal system of the content processing apparatus 1 and performs switchover to another metaphor in accordance with the user's entry operation or the instructions from the internal system to change the metaphor. More specifically, when the operation information interpreting section 10 detects an entry operation for switchover to another metaphor, the metaphor managing section 13 changes, out of information to be referred to in the metaphor display management table stored in the metaphor management data storage section 23, the sets of rule sets to be used for the metaphor of interest, including the processing pattern ruleset and the metaphor display management table. With this arrangement, it is possible to accordingly change interpretation rules of the user's operation information and the presentation manner of an image to be displayed as well.

With this arrangement, an image to be displayed for prompting the user to select any of content items presented and interpretation of the user's entry operation are changed. Besides, interpretation of the entry operation performed on the user-selected content item is changed, and an image to be displayed is changed according to the interpretation results.

The trust managing section 14 performs an authentication process required for the metaphor managing section 13 to obtain a metaphor via the transmitter/receiver section 8. Further, there are cases where separate authentication needs to be performed for each rule contained in an obtained metaphor, as will be described in detail later. Thus, the trust managing section 14 performs authentication of each rule contained in the metaphor. Moreover, there are also cases where authentication needs to be performed for output of a content item obtained from outside the content processing apparatus 1. In such cases, the trust managing section 14 performs authentication of such a content item.

The operation history storage section 20 stores operation information indicating the nature of the user's operation, as which the output of the operation section 4 has been interpreted by the operation information interpreting section 10. Further, the information on the user's operation is not the only information to be stored in the operation history storage section 20. In a case where the system has detected a status update at the occurrence of an event of operation, information containing such updated information may be stored in the operation history storage section 20.

The processing pattern rule storage section 21 stores the processing pattern ruleset, which is used for grouping of content items, determination of the interpretation of the nature of the user's operation by the operation information interpreting section 10, and the like purposes.

Note that the processing pattern ruleset may be stored in advance in the processing pattern rule storage section 21, or may be obtained from an external device. Thus, the processing pattern ruleset obtained from the external device can also be used. This makes it possible to flexibly change the rules for grouping of content items and the rules for interpretation of the nature of the user's operation by the operation information interpreting section 10.

The content storage section 22 stores the target content items to be outputted from the content processing apparatus 1. The content processing apparatus 1 is herein assumed to have the functions, including display of document data and any other data in text format, display of photograph data and any other pictorial data, output of music files and any other audio data, display of Web pages, execution of programs, decompression of archived files, audio and video output of television programs, reproduction of moving image files, and administration of e-mail addresses and any other addresses. Therefore, the content storage section 22 stores data in text format, pictorial data, audio data, HTML data, program data, archived data, data of television programs, moving image data, address data, and any other data.

Note that the content processing apparatus 1 can connect with the external device via the external data input/output section 7, and also can connect with an apparatus on the communication network via the transmitter/receiver section 8. Thus, the content processing apparatus 1 can use content items that are not stored in the content storage section 22.

[Details of the Content Management Table]

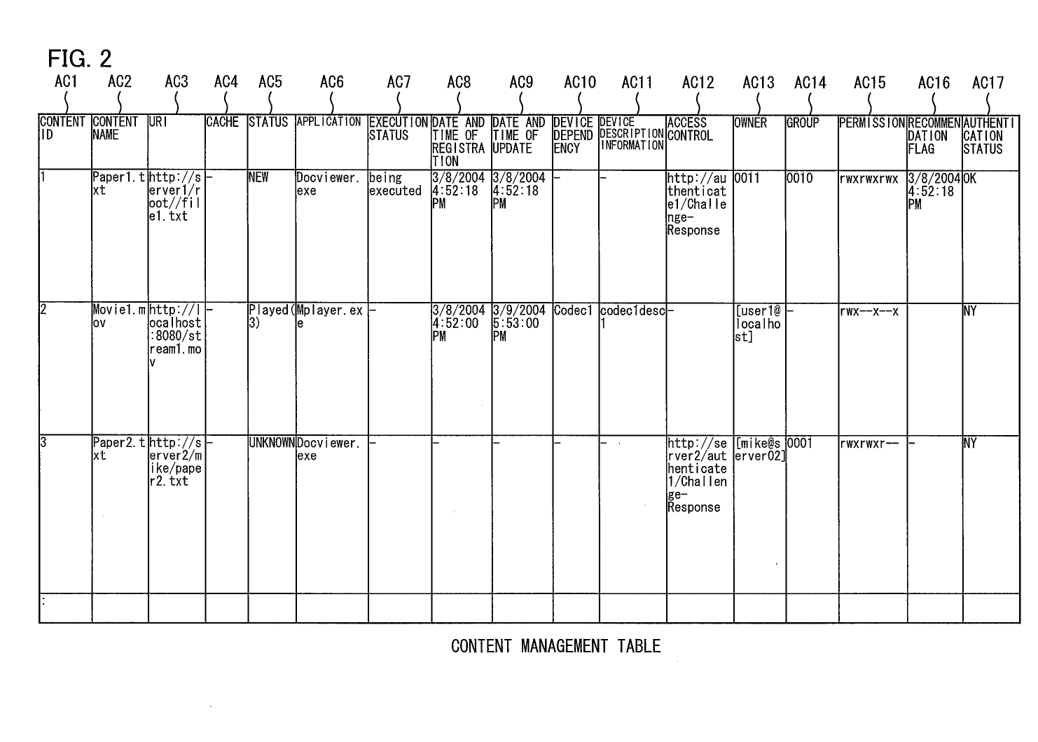

Now, details of the content management table stored in the content storage section 22 will be described with reference to FIG. 2. FIG. 2 is a view showing an exemplary content management table.

As described previously, the content management table manages content items that can be outputted from the content processing apparatus 1. The operation information interpreting section 10 determines a content item that can be outputted by the content processing apparatus 1, with reference to the content management table, and then instructs the layout control section 11 to display the determined content item on the display section 5. Further, if the content item that can be outputted by the content processing apparatus 1 has been modified, the content managing section 12 updates the content management table accordingly.

The content management table shown in FIG. 2 includes the following categories: “content ID”; “content name”; “URI”; “cache”; “status”; “application”; “execution status”; “registration date and time”; “update date and time”; “device dependency”; “device description information”; “access control”; “owner”; “group”; “permission”; “recommendation flag”; and “authentication status”.

In a field on a column AC1, a content ID is stored. The content ID is a number for identification of a content item managed by the content managing section 12. The content ID is a unique number given to a content item at the registration of the content item into the content management table. Using the content ID, the content item is referred to.

As described previously, the content items managed by the content managing section 12 are not necessarily stored in the content storage section 22. The content managing section 12 also manages content items that are available via the external data input/output section 7 or the transmitter/receiver section 8, with content IDs given to such content items.

In a field on a column AC2, a character string indicating a content name is stored. The character string stored in the column AC2 is not necessarily identical with a unique ID under a file system of the content processing apparatus 1, i.e. identification information used to identify a content item of interest under the file system. A convenient content name may be stored therein.

In a field on a column AC3 is stored location information of the content item identified by the content ID on the column AC1. In the example shown in FIG. 2, URI (Universal Resource Identifier) is used as the location information. Through the use of URI as the location information, the content item that is not stored in the content processing apparatus 1 (e.g. the content item stored in the external device) can be obtained in a similar process to the content item stored in the content processing apparatus 1. This makes it possible to maintain general versatility of the content processing apparatus 1.

Note that the information stored in the field on the column AC3 is not limited to the above exemplary information as long as it is the information uniquely indicating the location of the content item. For example, assume that the content item that is identified by the content ID stored on the column AC1 is stored in the file system of the content processing apparatus 1 (e.g. the content storage section 22). In such a case, it is safe that a path indicating where the content item is located in the file system may be stored in the field on the column AC3, or that a particular address on memory and its offset may be stored in the field on the column AC3.

In a field on a column AC4 is stored information on cache data. That is, in a case where the content item that is identified by the content ID stored in the field on the column AC1 has cached data, location information of the cached data is stored in the field on the column AC4. Thus, in a case where the content item to be read has cached data, the content managing section 12 can shorten the time required for a reading process by reading the cached data, instead of reading the content item.

Note that a cache region is provided in the content storage section 22. Upon reading of a content item from the content storage section 22, the content managing section 12 stores cashed data of the thus read content item in the cache region. At the same time, the content managing section 12 stores the location information of the cashed data in the field on the column AC4.

In a field on a column AC5 is stored information indicating a content status. The content status is information indicating that a new content item has been registered and indicating the number of times a content item has been reproduced. The information stored in the field on the column AC5 is not particularly limited as long as the operation information interpreting section 10 can recognize the status of a content item from the information stored in the field on the column AC5.

For example, the character string defined in advance according to the content status may be stored in the field on the column AC5. For example, in the example shown in FIG. 2, the character string “NEW” indicates a newly registered content item, and the character string “Played (3)” indicates a content item reproduced three times. Further, the character string “UNKNOWN” indicates that the status of a content item of interest is unknown.

In the field on the column AC6 is stored a name of an application used to output a content item that is identified by the content ID stored in the field on the column AC1. More specifically, if the content item of interest has been outputted from the content processing apparatus 1 in the past, a name of an application that has been used to output the content item of interest is stored in the field on the column AC6. If the content item of interest has not been outputted from the content processing apparatus 1 in the past, a name of a default application to be used to output the content item of interest is stored therein.

In the field on the column AC6, an optional process may be further stored. The optional process is performed in outputting the content item by means of the application defined in the field on the column AC6. This makes it possible to execute the optional process automatically at the time of output of the content item. Note that the application for use in outputting the content item is not confined to those listed on the column AC6. If necessary, the content item may be outputted by means of an application that is not listed on the column AC 6.

In a field on a column AC7, an execution status is stored. The execution status is information indicating whether the content item that is identified by the content ID stored in the field on the column AC1 is being outputted by the content processing apparatus 1. For example, in a case where the content item that is identified by the content ID stored in the field on the column AC1 is being executed (e.g. initiated or reproduced), information indicating that the content item of interest is “being executed” is stored in the field on the column AC7. On the other hand, in a case where the content item that is identified by the content ID stored in the field on the column AC1 is not outputted, data is not stored in the field on the column AC.

In a field on a column AC8 is stored date and time when a content item of interest has been registered into the content management table. The registration date and time is stored when the content managing section 12 registers management information into the content management table.

In a field on a column AC9, date and time of update is stored if the status, content, and the like of a content item of interest has been changed.

In a field on a column AC10, a name of a logic device is stored if there is any depending logic device used when a content item of interest is outputted. The depending logic device is a device essential for output of the content item. The name of the logic device stored in the field on the column AC10 is not necessarily a single name. If there are a plurality of functional dependencies, the respective names of the logic devices are stored therein.

In a field on a column AC11, description information of a logic device is stored if the name of the logic device is stored in the field on the column AC10. The device description information is information indicating various settings required for the use of the logic device of interest. Therefore, the content managing section 12 can determine hardware and software settings, a port to be accessed, and the like for the use of the logic device required for output of the content item, with reference to the column AC11.

In a field on a column AC12, information on access control is stored. On the basis of the information stored in the field on the column AC12, access control of a content item of interest is performed. Exemplary access control includes authentication. For a content item that requires authentication for the output thereof, information indicating an authentication method is stored in the field on the column AC12.

For example, for a content item whose content ID is 1 in the example shown in FIG. 2, the character string “authenticate1: Challenge-Response” is stored in the field on the column AC12. This indicates that a content item of interest requires “Challenge-Response” authentication for output of thereof using “authenticate1” service (service defined in the content processing apparatus 1). With reference to this information, the content managing section 12 can perform an appropriate authentication process depending on a content item.

In a field on a column AC13 is stored information indicating an owner of a content item of interest. In a field on a column AC14 is stored information indicating a group to which a content item of interest belongs. In a field on a column AC15, is stored permission information indicating whether or not reading, writing, and execution of a content item of interest is permitted. With the information stored in the fields on the columns AC13, AC14, and AC15, the content managing section 12 controls reading, writing, and execution of a content item. A content item that is not desirable to be modified can be set to be read-only, and whether or not reading, writing, or execution of a content item is permitted may be set for each user.

In a field on a column AC16 is stored information indicating that a content item of interest is set to be “recommended”. In the example shown in FIG. 2, date and time when the content item has been set to be recommended is stored. This makes it possible to check when the content item has been set to be recommended.

In a field on a column AC17 is stored information indicating an authentication status of a content item of interest. In the example shown in FIG. 2, “OK” is stored in the field on the column AC17 for a content item of which authentication has succeeded, and “NY (not yet authenticated)” is stored in the field on the column AC17 for a content item which has not yet been authenticated. Although not shown in FIG. 2, “FAILED” is stored in the field on the column AC17 for a content item of which authentication has ended in failure. The content item having “OK” in the field on the column AC17 is permitted for its use in the content processing apparatus 1. The content item having “NY” or “FAILED” in the field on the column AC17 is permitted for its use if predetermined authentication thereof has succeeded.

[Details of the Processing Pattern Ruleset]

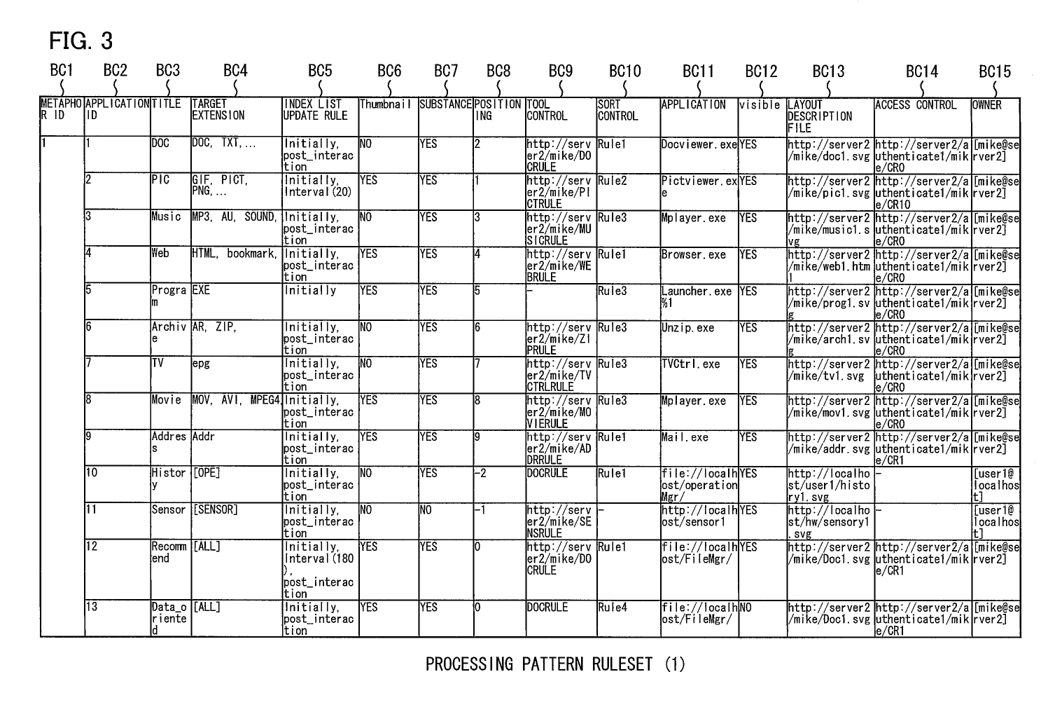

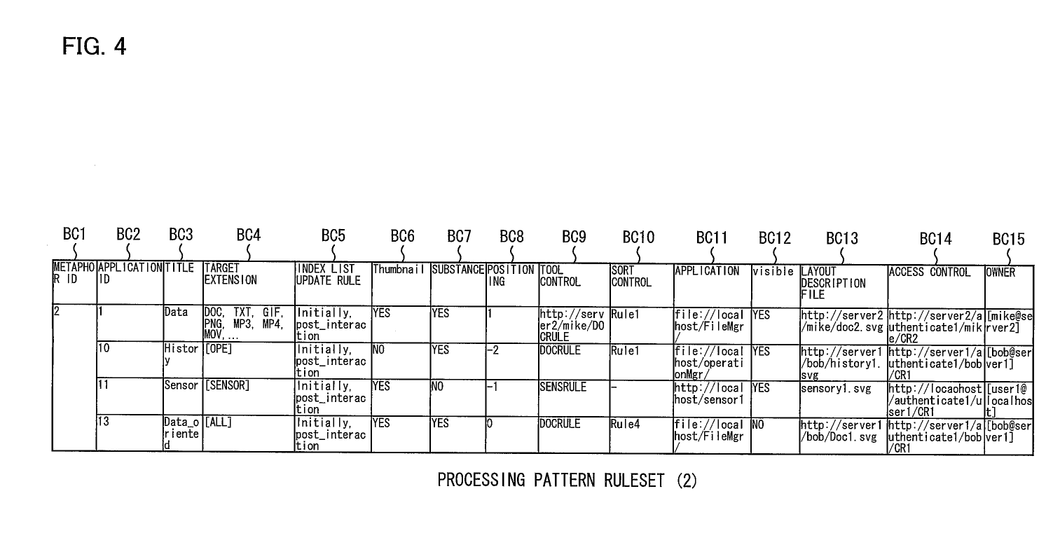

Next, details of the processing pattern ruleset stored in the processing pattern rule storage section 21 will be described with reference to FIGS. 3 and 4. FIGS. 3 and 4 are views each showing an exemplary processing pattern ruleset. As described previously, the processing pattern ruleset is used by the operation information interpreting section 10 to interpret the user's operation and determine control over a content item.

Each processing pattern ruleset shown in FIGS. 3 and 4 includes the following categories: “metaphor ID”; “application ID”; “title”; “target extension”; “index list update rule”; “Thumbnail”; “substance”; “positioning”; “tool control”; “sort control”; “application”; “visible”; “layout description file”; “access control”; and “owner”.

In a field on a column BC1, a metaphor ID is stored. The metaphor ID is a number for identification of a metaphor. In other words, one metaphor ID is allocated to each metaphor. The metaphor ID is 1 in the example shown in FIG. 3, and metaphor ID is 2 in the example shown in FIG. 4. The metaphor managing section 13 can switch the metaphor ID between 1 and 2. Note that metaphors target for the switching by the metaphor managing section 13 may be three or more metaphors. In such a case, the processing pattern ruleset additionally having a metaphor ID other than 1 and 2 is further stored.

In a filed on a column BC2, an application ID is stored. The application ID, which is a number for identification of a book that serves as an application for use in outputting a content item, is uniquely defined for each application. With reference to the application ID, content items that can be outputted by means of the same application can be identified. In the content processing apparatus 1, books corresponding to the respective application IDs are displayed separately. In other words, one group is set to each application ID, and one book is displayed for each group. Note that in a case where there are no content items in a book (e.g. in a case where there are no content items that can be executed by an application identified by an application ID of interest), no books are displayed.

In a field on a column BC3, a title is stored. As described above, the content processing apparatus 1 displays one book for each application ID. In doing this, the title stored in the field on the column BC3 is used as a title of the book of interest. Therefore, as the title stored in the field on the column BC3, a character string that varies from application ID to another is determined.

In a field on a column BC4, a target extension is stored. The field on the column BC4 indicates extraction criteria for extraction of a content item associated with a book corresponding to each application ID. For example, in the example shown in FIG. 4, extensions “DOC” and “TXT” are stored as target extensions corresponding to the application ID 1. With this arrangement, when the book corresponding to the application ID 1 is selected, document-type content items with the extension “DOC” or “TXT” are displayed in a list form, out of the content items contained in the content management table.

Note that a content item that cannot be executed by the application identified by the application ID on the column BC2 may be associated with a book. For example, a content item other than items in text format may be associated with the book corresponding to the application ID 1. However, such a content item is excluded from uniformly performed processing (e.g. sorting) on every content item contained in one book.

Further, the extraction criteria for content extraction, which criteria is stored in the field on the column BC4, is not limited to an extension. For example, the extraction criteria may be a filename or an update date of a file. Alternatively, the extraction criteria may be a keyword or a date inputted by user's data entry.

In a field on a column BC5, an index list update rule is stored. As described previously, the content processing apparatus 1 displays one book for each application ID, and when the user selects any of books displayed, content names of content items having a target extension of the selected book are displayed in a list form. The index list update rule defines an update timing of the index list.

The index list update rule may be defined using a character string. For example, in the examples shown in FIGS. 3 and 4, the character string “INITIALLY” indicates that the index list is to be updated initially (when the book is first displayed). The character string “post_interaction” indicates that upon completion of the user's operation, the table of content is to be updated after an operation history has been obtained from the operation history storage section 20. The character string “Interval (20)” indicates that the index list is to be updated once every 20 minutes. As in the examples shown in FIGS. 3 and 4, only a single index list update rule may be determined for each application ID, or a plurality of index list update rules may be determined.

In a field on a column BC6 is stored information indicating whether or not a thumbnail image is to be displayed with display of the index list image. In the examples shown in FIGS. 3 and 4, it is assumed that if “YES” is stored therein, the thumbnail image is displayed, and if “NO” is stored therein, the thumbnail image is not displayed.

In a field on a column BC7 is stored information indicating whether or not a content item, which is a constitutive element of a book corresponding to the application ID stored in the field on the column BC2, is stored in the content storage section 22. That is, a content item having “YES” in a substance field on the column BC7 has an entity in the content storage section 22, whereas a content item having “NO” therein has no entity in the content storage section 22.

In a field on a column BC8 is stored information indicating positioning of the books in the bookshelf. As described previously, the content processing apparatus 1 displays one book for each application ID. In addition, the content processing apparatus 1 displays the book in such a manner that an image of the book is superimposed on an image of the bookshelf. This displays an image showing the state where the book is in the bookshelf. This image is a basic operation screen in the content processing apparatus 1.

The positioning of books in the on-screen bookshelf is determined by information stored in the field on the column BC8. In the example in FIGS. 3 and 4, a book to be positioned on the leftmost position in the bookshelf is numbered “1”, and a book to be positioned second from the left in the bookshelf is numbered “2”. In this manner, the positions of the books are determined by numbers assigned to the books from the left in the bookshelf. Further, books numbered “0” are not displayed in the bookshelf. Moreover, the book to be positioned on the rightmost position in the bookshelf is numbered “−1”, and the book to be positioned second from the right in the bookshelf is numbered “−2”. In this manner, the positioning of the books determined based on the leftmost position as a starting position in the bookshelf is defined separately from the positioning of the books determined based on the rightmost position as a starting position in the bookshelf.

In a field on a column BC9, a rule for tool control is defined. Note that the tool control is a process that can be executed when the image for entry operation is being displayed. In the examples shown in FIGS. 3 and 4, the rule on the column BC9 can be determined for each application ID. This makes it possible to perform different tool controls for the respective books displayed.

In a field on a column BC10, a rule for sort control is defined. Note that the sort control is a process that can be executed when the image for entry operation is being displayed. In the examples shown in FIGS. 3 and 4, the rule on the column BC10 can be determined for each application ID. This makes it possible to perform different sort controls for the respective books displayed.

In a field on a column BC11 is stored a path to a default application for use in executing the content item contained in the book which is identified by the application ID stored in the field on the column BC2, and then outputting the result of the execution. When a content item is selected from the index list for the book, the content managing section 12 launches an application for use in execution of the selected content item, with reference to the column BC11.

In a field on a column BC12 is stored information indicating whether or not a book that is identified by the application ID stored in the field on the column BC2 can be displayed as an on-screen book on the basic operation screen. More specifically, a book has “YES” in the Visible field can be displayed as an on-screen book on the basic operation screen (arranged as an on-screen book in the bookshelf). On the other hands, a book has “NO” in the Visible field is not be displayed as an on-screen book on the basic operation screen

In a field on a column BC13, a layout description file is stored. The layout description file is information for determining a page layout of the book that is identified by the application ID stored in the field on the column BC2. With reference to the layout description file is determined a display layout at the display of items relating to the book of interest (e.g. display of the index list). Further, the layout description file contains image information indicating the appearance of a book. Such information enables each book identified by the corresponding application ID to be displayed as an on-screen book.

That is, the layout description file provides a drawing resource and rule for displaying a content item associated with each application ID (content item extracted according to the extraction criteria on the column BC4) on the screen.

In a field on a column BC14 is stored authentication-related information required to use rules included for each application ID (rules defined by information on the columns BC1 through BC15). Through authentication using such information, the use of a book corresponding to each application ID is permitted. In the examples in FIGS. 3 and 4, a URI of a server that provides authentication services is assumed to be stored in the field on the column BC14.

In a field on a column BC15 is stored information indicating an owner of rules included for each application ID. The owner represents an entity having the authority to create and manage the rules of interest.

As in the case with the processing pattern ruleset shown in FIG. 3, the processing pattern ruleset shown in FIG. 4 includes categories on the columns BC1 through BC15. It is herein assumed that the processing pattern ruleset shown in FIG. 3 is stored in the processing pattern rule storage section 21, and the processing pattern ruleset shown in FIG. 4 is obtained via the transmitter/receiver section 8. The metaphor managing section 13 selects either of the processing pattern rulesets shown in FIGS. 3 and 4. According to the processing pattern ruleset selected by the metaphor managing section 13, control over a content item and interpretation of the user's operation are performed.

This allows the user to perform checking and viewing of content items and the like operations in a variety of processing patterns. Note that the processing pattern rulesets, which are the subjects for selection, do not necessarily include the same categories. That is, the processing pattern rulesets do not necessarily include all of the categories represented on the columns BC1 through BC15, and may include categories other than the categories represented on the columns BC1 through BC15.

As shown in FIG. 4, the processing pattern ruleset (processing pattern ruleset (2)) of FIG. 4 includes four application IDs 1, 10, 11, and 13. That is, the processing pattern ruleset (2) defines four kinds of books. Out of these four application IDs, the application IDs 10, 11, and 13 are identical to those in the processing pattern ruleset (processing pattern ruleset (1)) of FIG. 3.

On the contrary, the application ID 1 is defined differently in FIGS. 3 and 4. That is, in the example shown in FIG. 3, the application ID 1 is a book titled “DOC”, which is a grouping of content items with extensions “DOC” and “TXT”. In the example shown in FIG. 4, the application ID 1 is a book titled “Data”, which is a grouping of not only document files with target extensions “DOC” and “TXT”, but also pictorial files such as GIF files and audio and video files such as MP3 files and MOV files.

[Details of the Metaphor Display Management Table]

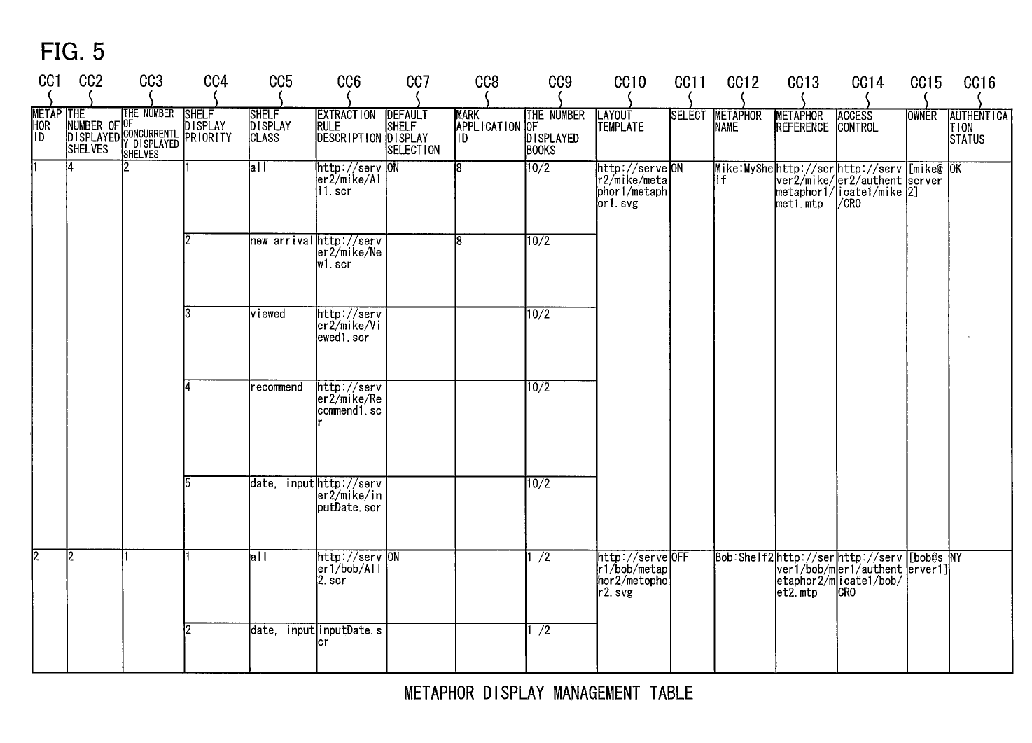

Next, the metaphor display management table which is used by the layout control section 11 for display of the basic operation screen will be described in detail with reference to FIG. 5. FIG. 5 is a view showing an exemplary metaphor display management table.

The metaphor display management table is a table for determining display formats and the like of the bookshelf and books. The layout control section 11 creates the basic operation screen where books are positioned in the bookshelf according to the metaphor display management table, and then causes the display section 5 to display the basic operation screen thus created.

The metaphor display management table shown in FIG. 5 includes the following categories: “metaphor ID”; “the number of displayed shelves”; “the number of concurrently displayed shelves”; “shelf display priority”; “shelf display class”; “extraction rule description”; “default shelf display selection”; “mark application ID”; “the number of displayed books”; “layout template”; “select”; “metaphor name”; “metaphor reference”; “access control”; “owner”; and “authentication status” (respectively corresponding to fields on columns CC1 through CC16).

In a field on a column CC1, a metaphor ID is stored. The metaphor display management table shown in FIG. 5 includes both metaphor ID 1 and metaphor ID 2. Alternatively, separate tables may be provided for the respective metaphor IDs, as is the case with the processing pattern rulesets (1) and (2) shown in FIGS. 3 and 4, respectively.

In a field on a column CC2 is stored information indicating the number of displayed shelves. The number of displayed shelves is the number of shelves selected in the content processing apparatus 1. On each shelf is displayed the image of a book. In the example shown in FIG. 5, the number of displayed shelves is 4. In a case where the metaphor display management table shown in FIG. 5 is used, a bookshelf with four shelves is selected.

In a field on a column CC3 is stored information indicating the number of concurrently displayed shelves. The number of concurrently displayed shelves is the number of shelves that can be displayed concurrently on one screen. The number of concurrently displayed shelves is selected so as to be not larger than the number of displayed shelves, which is defined on the column CC2. In the example shown in FIG. 5, the number of concurrently displayed shelves is 2. In a case where the metaphor display management table shown in FIG. 5 is used, two out of four shelves in total are concurrently displayed.

The number of concurrently displayed shelves is preferably selected according to the size of a display area of the display section 5. If the number of concurrently displayed shelves is increased in the situation where the display section 5 has a small display area, the size of a book displayed on each shelf decreases, which causes decrease in user viewability. Therefore, it is preferable that the number of concurrently displayed shelves can be changed by user's entry operation. Alternatively, the layout control section 11 determines the size of the display area of the display section 5 so as to appropriately select the number of concurrently displayed shelves according to the result of the determination.

In a field on a column CC4, a shelf display priority is stored. The shelf display priority is information indicating a display priority assigned to each shelf display class, which is stored in the field on the column CC5. According to the shelf display priority is determined the shelf display class for selection of books to be positioned in each shelf of the bookshelf. This determines the books to be positioned in each shelf of the bookshelf.

In a field on a column CC5, the shelf display class is stored. The shelf display class is selection criteria for selection of books to be displayed in an on-screen predetermined area (in the present embodiment, each shelf of a on-screen bookshelf). For example, in the example shown in FIG. 5, the fields on the column CC5 have the following five kinds of shelf display classes: “all”, “new arrival”; “viewed”; “recommend”; and “date, input”.

The shelf display class “all” indicates display of books corresponding to all of the application IDs stored in the processing pattern ruleset. In a shelf to which the shelf display class “all” is applied, books are positioned corresponding to all of the application IDs defined in the processing pattern ruleset as applied.

The shelf display class “new arrival” indicates display of a book corresponding to the application ID of which status field on the column EC8 has “UPDATED” in the book information management table, which will be described later.

The shelf display class “viewed” indicates display of a book for reference to a viewing history of content items in the content processing apparatus 1. More specifically, the shelf display class “viewed” indicates display of a book with the application ID “10” (book titled “History”, hereinafter referred to as History book) in the processing pattern ruleset. In the shelf with the shelf display class “viewed” is displayed the History book only. Details of the History book will be described layer.

The shelf display class “recommend” indicates display of a book for reference to a content item for which a recommendation flag on the column AC16 in the content management table is set. More specifically, the shelf display class “recommend” indicates display of a book with the application ID “12” (book titled “Recommend”, hereinafter referred to as Recommend book) in the processing pattern ruleset. In the shelf with the shelf display class “recommend” is displayed the Recommend book only. Details of the Recommend book will be described layer.

The shelf display class “date, input” is a shelf display class for reference to a book with the application ID “13” (book titled “Data_oriented”, hereafter referred to as Data_oriented book) in the processing pattern ruleset. The Data_oriented book, which has “NO” in the Visible field on the column BC12, is not displayed as a book in the on-screen bookshelf.

The Data_oriented book is used when the user searches for a content item. When the shelf display class is “date” or “input”, a screen is displayed for entry of a date or a keyword or the like for content searching. When a search criteria, such as a keyword or a date, is inputted, a list of content items matching the inputted search criteria is displayed in the form of an index list of a book on the screen. This allows the user to easily look for a desired content item.

Note that the shelf display class does not prevent one book from being positioned in a plurality of shelves. For example, a “new arrival” book is positioned in both of the shelves named “all” and “new arrival”.

In a field on a column CC6, a file describing extraction rules is stored. The extraction rule description file is a file of settings that defines the manner in which a content item is to be dealt with as a book, or the manner in which books are to be collectively presented to the user.

In a field on a column CC7 is stored information indicating the shelf display class to be applied to default shelf display. In the example shown in FIG. 5, the fields on the column CC7 have “ON”, corresponding to the fields where the shelf display class is set to “all”. This indicates that the shelf display class “all” is applied to default shelf display.

Therefore, when the basic operation screen is displayed for the first time using the metaphor display management table shown in FIG. 5, a book with “all” set in the shelf display class field is positioned in the first shelf of the on-screen bookshelf. The books to be positioned in the second shelf and following shelves are determined according to the shelf display priorities defined in the fields on the column CC4.

In a field on a column CC8 is stored an application ID of a book to be displayed with a mark on the image for entry operation. In displaying the book corresponding to the application ID stored in the field on the column CC7, the layout control section 11 displays such a book in a form that can be distinguished from the other books.

In a field on a column CC9, the number of displayed books is stored. The number of displayed books indicates an upper limit of the number of books that can be concurrently positioned in one shelf. In the example shown in FIG. 5, a number on the left side of a delimiter (/) indicates an upper limit of the number of books that can be displayed from left to right in the shelf, and a number on the right side thereof indicates an upper limit of the number of books that can be displayed from right to left in the shelf. If the number of books selected according to the shelf display class exceeds the upper limit, excess books beyond the upper limit are not displayed.

If the number of books to be displayed exceeds the number of displayed books determined in the field on the column CC9, which of the books is to be displayed is determined according to preset priorities. The present priorities correspond to numbers in the “positioning” fields on the column BC8, which is presented in the processing pattern ruleset shown in FIGS. 3 and 4. That is, the positioning of the book having “1” in the “positioning” field is first determined in one shelf of the bookshelf, and the positioning of the books having the following numbers in the “positioning” fields are then determined in order. When the number of books positioning of which have been determined reaches the number of displayed books (number on the left side of the delimiter (/)) in the field on the column CC9, the positioning of the books in the shelf of interest is completed. That is, a higher priority is placed to a book having a smaller number assigned in the “positioning” field. Similarly, in a case where the number in the “positioning” field is a negative number, the positioning of the book having “−1” in the “positioning” field is first determined, and the positioning of the books having the following numbers in the “positioning” fields are then determined in order. When the number of books positioning of which have been determined reaches the number of displayed books (number on the right side of the delimiter (/)) in the field on the column CC9, the positioning of the books in the shelf of interest is completed.

In a field on a column CC10, a layout template is stored. The layout template is a template for display of a layout prepared for each metaphor ID. Using the layout template, the basic operation screen and the like are displayed in accordance with the metaphor.

In a field on a column CC11 is stored information indicating the presence or absence of a select. The select indicates whether or not a metaphor ID of interest is currently selected. For example, in the example shown in FIG. 5, the select field corresponding to the metaphor ID 1 has “ON”, and the select field corresponding to the metaphor ID 2 has “OFF”. This shows that the metaphor ID 1 is currently applied.

In a field on a column CC12, a metaphor name is stored. In the example shown in FIG. 5, “Mike:MyShelf” is stored as the metaphor name corresponding to the metaphor ID 1, and “Bob:Shelf2” is stored as the metaphor name corresponding to the metaphor ID 2. Display of such a metaphor name together with images of a book and bookshelf allows the user to easily recognize what kind of display settings are currently applied. Note that the metaphor name corresponding to each metaphor ID may be specified at will by the user.

In a field on a column CC13 is stored information indicating the location of a metaphor. In the example shown in FIG. 5, URI is stored in the field on the column CC13. The use of the URI enables reference to data making up the metaphor, such as the processing pattern ruleset.

In a field on a column CC14 is stored authentication-related information required for the use of a metaphor corresponding to each metaphor ID. Authentication using such information enables the use of a metaphor corresponding to each metaphor ID. In the example shown in FIG. 5, a URI of a server that provides authentication services is assumed to be stored on the column CC14.

In a field on a column CC15 is stored information indicating an owner of a metaphor corresponding to each metaphor ID. The owner represents an entity having the authority to create and manage the metaphor.

In a field on the column CC16 is stored information indicating whether or not a metaphor corresponding to each metaphor ID has been authenticated. In the example shown in FIG. 5, “OK” is stored in the field on the column CC16 for the metaphor that has been authenticated, and “NY” is stored therein for the metaphor that has not been authenticated yet.

[Details of the Book Information Management Table]

In the content processing apparatus 1, a format and the like of each book is determined according to the processing pattern ruleset. However, for a substance of actual management for the books, a table created as the book information management table is referred to. Moreover, for resources for layouting performed at the display of an image of a book, the book information management table is referred to.

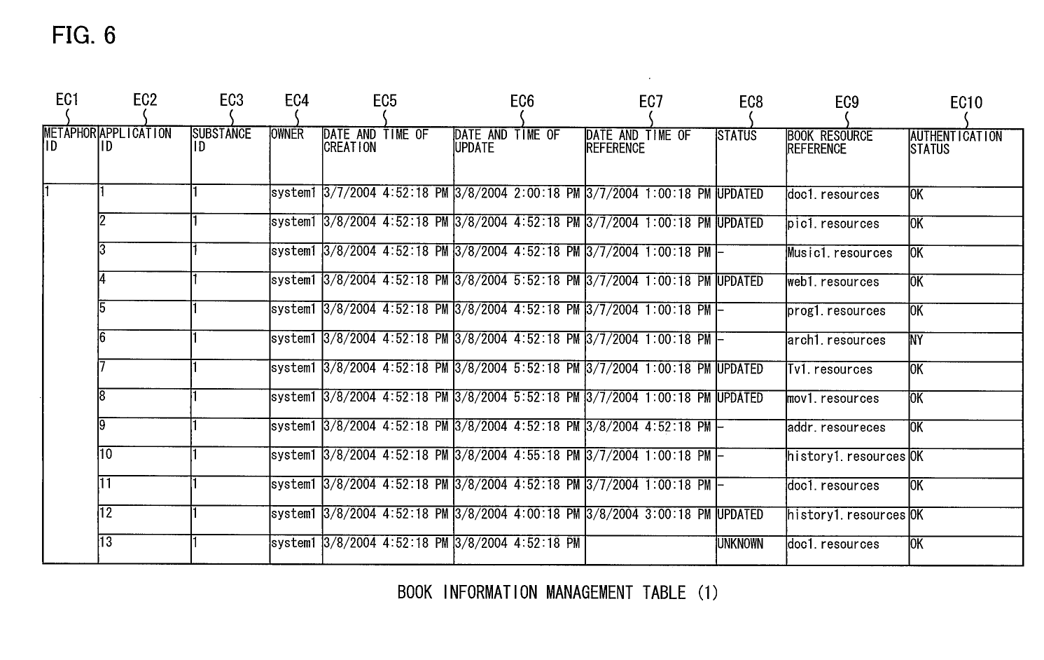

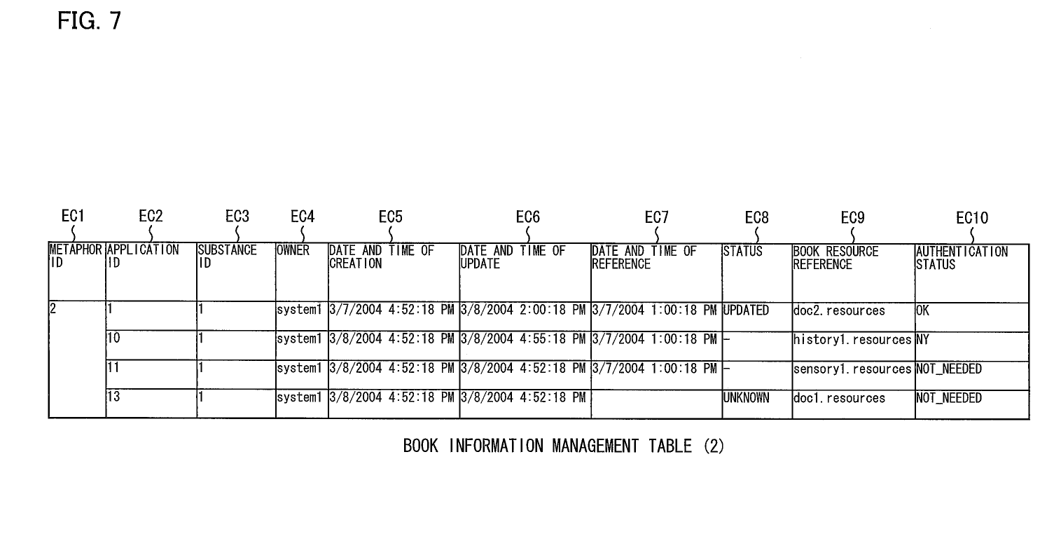

Now, details of the book information management table will be described with reference to FIGS. 6 and 7. FIGS. 6 and 7 are views showing exemplary book information management tables. Book information management tables (1) and (2) respectively shown in FIGS. 6 and 7 include the following categories: “metaphor ID”; “application ID”; “substance ID”; “owner”; “date and time of creation”; “date and time of update”; “date and time of reference”; “status”; “book resource reference”; and “authentication status” (respectively corresponding to columns EC1 through EC10).

In the book information management table (1) shown in FIG. 6, “1” is set in the metaphor ID field on the column EC1. In the book information management table (2) shown in FIG. 7, “2” is set in the metaphor ID field on the column EC1. That is, one book information management table is created for each metaphor ID.

In a field on the column EC2, the application ID is stored. As shown in FIGS. 6 and 7, the application IDs for the metaphor ID 1 are 1 through 13, as in the processing pattern ruleset shown in FIG. 3. Similarly, the application IDs for the metaphor ID 2 are the following four IDs, 1, 10, 11, and 13, as in the processing pattern ruleset shown in FIG. 4. That is, the book information management table is a table for management of information on each book, and also a collection of data items on the columns EC1 through EC10 (hereinafter referred to as book management information items) for each application ID.

In a field on the column EC3, the substance ID is stored. In the example shown in FIGS. 6 and 7, “1” is set in substance ID fields for the books corresponding to all of the application IDs. Variation of the substance ID enables multiple definitions of a book corresponding to the same application ID. The data items on the columns EC1 through EC3 can uniquely identify each book. Therefore, it is also possible to use a combination of data items on the columns EC1 through EC3 as an ID for each book.

In a field on the column EC4 is stored information indicating an owner of each book. The owner represents an entity having the authority to create and manage the book of interest. In the examples shown in FIGS. 6 and 7, the owners of the books corresponding to the respective application IDs are all “system 1”, which indicates that these books have been created by the content processing apparatus 1.

In a field on the column EC5 is stored date and time of creation of a book corresponding to each application ID. In a field on the column EC6 is stored date and time of update of a book corresponding to each application ID. In a field on the column EC7 is stored date and time of reference to a book corresponding to each application ID.

In a field on the column EC8 is stored information indicating an update status of a book corresponding to each application ID. That is, for a book that has been updated after the last reference (selection) of the book by the user or for a book that has never been referenced (selected) by the user, “UPDATED” is set in the “status” field on the column EC8.

In the example shown in FIG. 6, “UPDATED” is set in the “status” fields for the application IDs 1, 2, 4, 7, 8, and 12. Therefore, in a case where such a book information management table is used, books corresponding to the application IDs 1, 2, 4, 7, and 8 are positioned in the shelf named “new arrival”. Although “UPDATED” is set in the “status” field for the application ID 12, the book corresponding to the application ID 12 is not positioned in the bookshelf. This is because “0” is set in the “positioning” field for the application ID 12, as shown in FIG. 3.

It is herein assumed that “UPDATED” is set in the “status” field if the comparison between the date and time of update on the column EC6 and the date and time of reference on the column EC7 has showed that the date and time of update is later. For the application ID 13 having no data in the “date and time of reference” field on the column EC7 as shown in FIG. 6, the above comparison cannot be carried out. Therefore, “UNKNOW” is set in the “status” field for the application ID 13.

In a field on the column EC9 is stored a file for reference to resources for each book. On the basis of such a file can be determined a book layout of each book (display layout of the index list screen and the like screen displayed upon selection of a book in the bookshelf).

In a field on the column EC10 is stored information indicating whether or not each application ID has been authenticated. In the examples shown in FIGS. 6 and 7, “OK” is set in the field on the column EC10 for the application ID that has been authenticated, and “NY” is set in the field on the column EC10 for the application ID that has not been authenticated yet. For the application ID that does not need to be authenticated, “NOT_NEEDED” is set therein.

[Details of the Operation History Management Table]

As described previously, the content processing apparatus 1 displays the History book in the shelf named “viewed”. When the History book is selected, content items past viewed or subjected to other operation by the user are displayed in an index list form on the index list screen. The index list screen is displayed according to the operation history management table stored in the operation history storage section 20.

The operation history management table is a table for management of information indicating a history of operations performed on each content item. The operation history management table is updated when the operation information interpreting section 10 has interpreted the nature of user's operation and then performed a process according to the interpretation result.

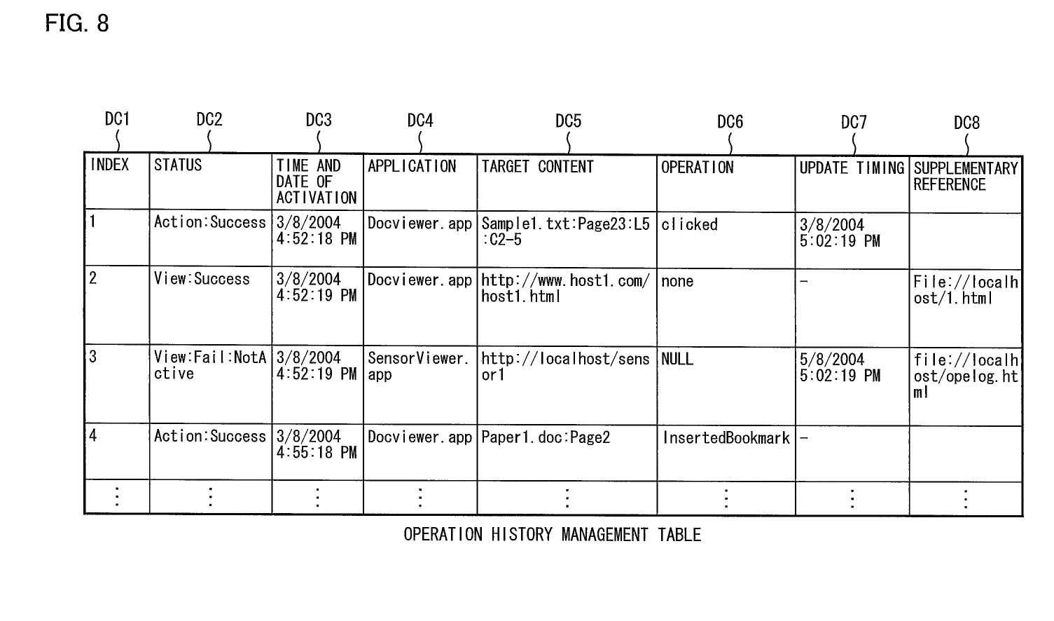

Now, details of the operation history management table stored in the operation history storage section 20 will be described with reference to FIG. 8. FIG. 8 is a view showing an exemplary operation history management table. The operation history management table shown in FIG. 8 includes the following categories; “index”; “status”; “time and date of activation”; “application”; “target content”; “operation”; “update timing”; and “supplementary reference”.

In a field on the column DC1, an index is stored. The index is a number for identification of each record included in the operation history management table, and the number is assigned at the time when the operation information interpreting section 10 stores an operation history.

In a field on the column DC2, a status is stored. The status stored in the field on the column DC2 indicates the result of the interpretation of user's entry operation by the operation information interpreting section 10. For example, in a record for the index 1, “Action:Success” is set in the status field, which shows that processing has been successfully completed by the entry operation corresponding to the index 1.

In a field on the column DC3, an activation time is stored. The date and time of activation is date and time when the user's operation has been started.

In a field on the column DC4, an application is stored. The application stored in the field on the column DC4 indicates an application that has been launched by user's entry operation.

In a field on the column DC5 is stored information indicating a content item for which entry has been made and what has been entered for the content item of interest. For example, in the record for the index 1, the “Sample1.txt:Page23:L5:C2-5” is set in the “target content” field. This indicates that the second to fifth characters on page 23, line 5 in a content item with a content name “Sample1.txt” has been entered.

In a field on the column DC6 is stored information indicating the result of interpretation of user's entry operation by the operation information interpreting section 10. For example, “clicked” is stored in the “operation” field. This indicates that a click operation (a touch on the display screen of the display section 5) has been carried out.

In a field on the column DC7 is stored information indicating a timing when the status stored in the field on the column DC2 has been updated. For example, in a case where the execution of processing has ended in failure due to a timeout or in the like case, date and time later than the date and time of activation provided in the field on the column DC3 is stored in the “update timing” field on the column DC7. If a content item is selected by the user, a status of the content item is updated. Accordingly, date and time is stored in the “update timing” field. On the other hand, if a content item is not selected by the user, a status of the content item is updated. Accordingly, date and time is not stored in the “update timing” field. That is, whether or not date and time is stored in the “update timing” field indicates whether or not a content item of interest has been selected.

In a field on the column DC8, a supplementary reference is stored. The supplementary reference is information for access to a log file or the like on processing executed. With such information, it is possible to track down the cause of the failure in the execution of processing or of the like problem.

[Flow of a Process Executed by the Content Processing Apparatus 1]

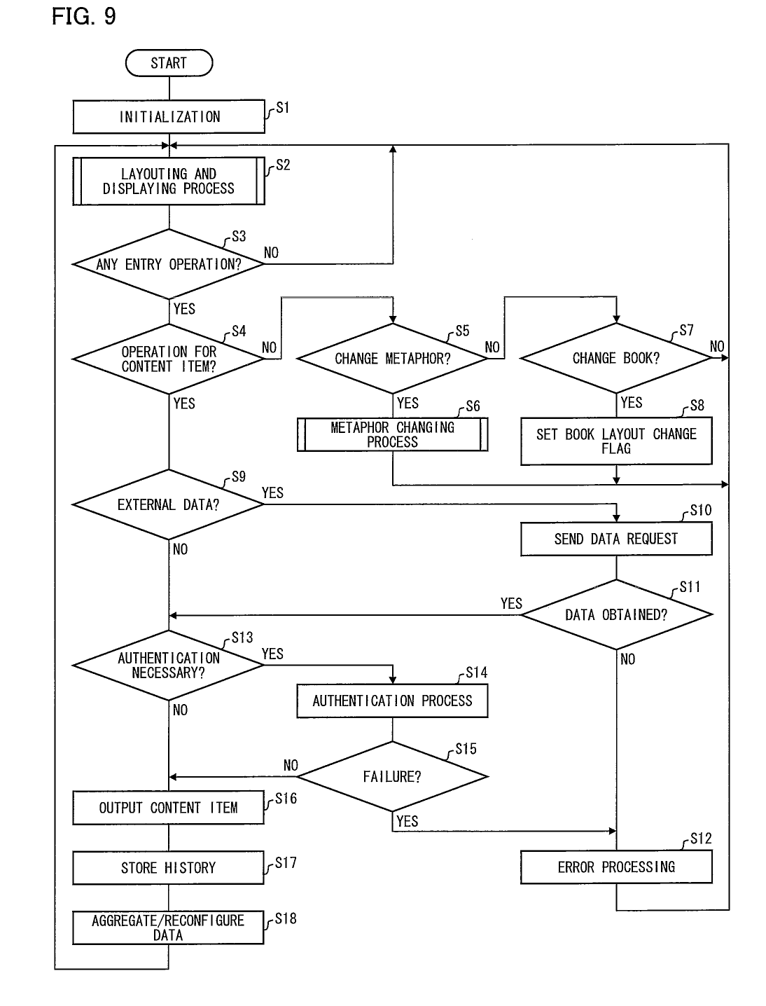

Next, a flow of a process executed by the content processing apparatus 1 will be described with reference to FIG. 9. FIG. 9 is a flow chart showing an exemplary process executed by the content processing apparatus 1.

First, the operation information interpreting section 10 initializes drawing and all resources (S1). With this, the process is performed by the content processing apparatus 1 with use of a default processing pattern ruleset. Here, it is assumed that the processing pattern ruleset (1) shown in FIG. 3 is the default.

Subsequently, the operation information interpreting section 10 instructs the layout control section 11 to perform a layouting and displaying process (S2). This causes display of a screen (e.g., a basic operation screen or an index list screen for a book) through which a user selects a content item and on which the content item is displayed. The layouting and displaying process will be described in detail later.

Upon display of the screen, the operation information interpreting section 10 waits for user's entry operation (S3). If no entry operation is detected (No in S3), the process returns to S2. Since the operation history management table and the like have not been updated in this case, the screen displayed on the display section 5 is not changed.

On the other hand, if entry operation is detected (YES in S3), the operation information interpreting section 10 determines whether or not the nature of the user's operation is related to operation for output of a content item (S4). Here, the operation information interpreting section 10 interprets the nature of the operation according to the screen displayed in S2 so as to determine whether or not the nature of the user's operation is related to the operation for output of the content item.

If the nature of the user's operation is determined not to be related to the operation for output of the content item (No in S4), the operation information interpreting section 10 determines whether or not the entry operation detected is intended to change (switch) a metaphor (S5). If the entry operation detected is intended to change the metaphor (YES in S5), the operation information interpreting section 10 performs a metaphor changing process (S6). This changes the processing pattern ruleset and the like to be applied. The metaphor changing process will be described in detail later.

On the other hand, if the entry operation detected is not intended to change the metaphor (NO in S5), the operation information interpreting section 10 determines whether or not the entry operation detected is intended to change a book (S7). In the event of addition, deletion, updating, or the like of a content item constituting the book, the operation information interpreting section 10 determines that the book is to be changed.

Further, if the entry operation detected is intended to change the book (YES in S7), the operation information interpreting section 10 sets a book layout change flag (S8), and then the process returns to S2. Performing the process of S2 with the book layout change flag set updates the screen (e.g., the index list screen) to be displayed. In the case where the screen is updated, the operation information interpreting section 10 interprets the nature of an operation according to the screen updated.

If the entry operation detected is not intended to change the book (NO in S7), the process returns to S2. Then, after the layouting and displaying process is performed, an entry operation is waited for (S3). However, since the display layout is not changed in the case of “NO” in S7, the process of S2 may be skipped to perform the process of S3.

In S4, if the entry operation is determined to be related to the operation for output of the content item (YES in S4), the operation information interpreting section 10 instructs the content managing section 12 to output the content item of interest.

Here, in a case where the content item to be outputted is not stored in the content storage section 22, the content managing section 12 which has received the instruction must obtain the content item of interest from outside the content processing apparatus 1. Therefore, the content managing section 12 first refers to the content management table in order to determine whether or not the content item to be outputted is external data (S9).

If the content item to be outputted is the external data (YES in S9), the content managing section 12 instructs the external data input/output section 7 or the transmitter/receiver section 8 to send a data request to an external device identified by location information (in the example shown in FIG. 2, an URI in the field on the column AC3) included in the content management table (S10).

If the content item is obtained in response to the data request (YES in S11), the process proceeds to S13. On the other hand, if the content items cannot be obtained (NO in S11), the process proceeds to S12. In S12, error processing is performed. The error processing clears an internal variable, updates the operation history management table, and/or performs other operation. This causes e.g., release of a resource which is secured for display of a screen but is determined not to be displayed due to the failure to obtain the content item.

After the error processing ends, the process returns to S2. In the case where the process transfers from S12 to S2, the content managing section 12 may provide display of an image for informing the user of the failure to obtain the content item.

Here, if the content item to be outputted is not the external data, i.e., if the content item to be outputted is stored in the content storage section 22 (YES in S9) or if the external data is successfully obtained (YES in S11), the content managing section 12 instructs the trust managing section 14 to determine whether or not authentication is necessary for output of the content item of interest (S13).

In response to the instruction as to determination of whether or not the authentication is necessary, the trust managing section 14 refers to the column AC17 of the content management table in order to determine which of “OK” and “NY” is set for that content item in the authentication status field.

If “OK” is confirmed, the trust managing section 14 determines that no authentication is necessary (NO in S13), and then informs the content managing section 12 as such. In this case, the process proceeds to S16, and the content managing section 12 outputs the content item of interest.

On the other hand, if “NY” is confirmed, the trust managing section 14 determines that the authentication is necessary (YES in S13), and performs an authentication process on the content item of interest (S14). Here, if the authentication is failed (YES in S15), the process proceeds to S12 to perform the error processing, and then the process returns to S2. On the other hand, if the authentication is succeeded (NO in S15), the process proceeds to S16, and the content managing section 12 outputs the content item of interest. Note that the authentication process for the content item can be performed in the same manner as the later-described authentication process for a metaphor.

Upon output of the content item, the operation information interpreting section 10 stores, in the operation history management table, the nature of the user's operation as an operation history (S17). Then, the operation information interpreting section 10 aggregates and reconfigures data according to the nature of the process performed (S18). That is, in S15, various tables (at least one of the processing pattern ruleset, the book information management table, the metaphor display management table, and the content management table) are reconfigured (updated) so that the nature of the process performed is reflected thereto. Thereafter, the process returns to S2.

In S2, the layouting and displaying process is performed. Here, the processing pattern ruleset and/or the like has been updated in the process of S18, and the operation history management table has also been updated in the process of S17. Consequently, an image generated and displayed in S2 reflects the processing pattern ruleset, the book information management table, the metaphor display management table, the content management table, and the operation history management table, each of which is the one after updating. Further, since the screen has been updated, the operation information interpreting section 10 interprets the nature of an operation according to the screen updated.

[Details of the Layouting and Displaying Process]

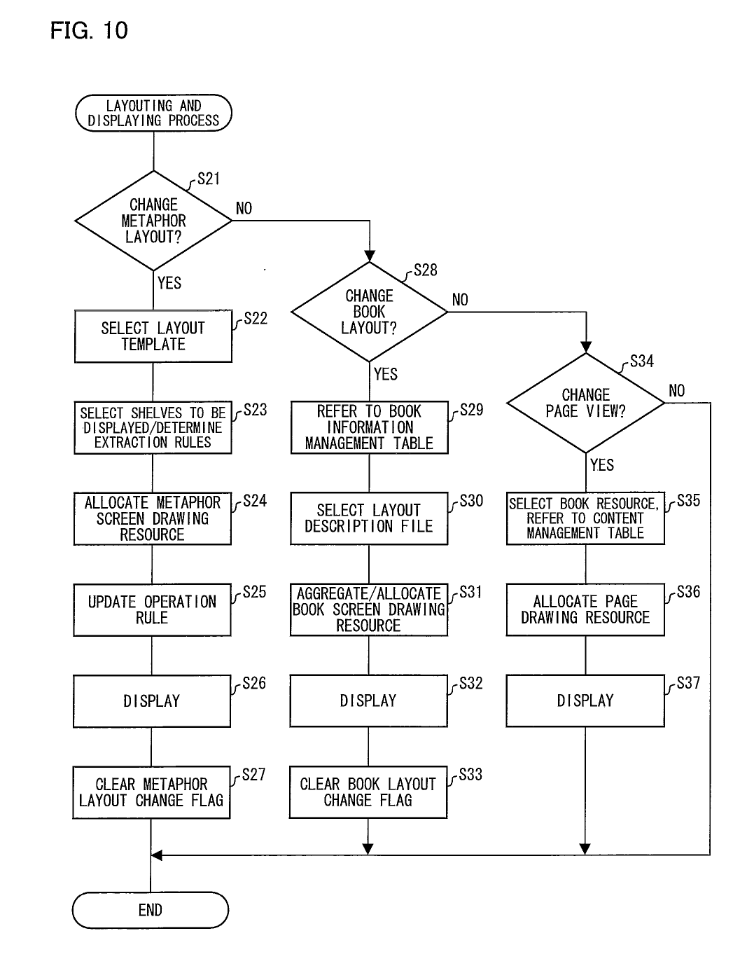

Next, details of the layouting and displaying process performed in S2 in FIG. 9 will be described with reference to FIG. 10. FIG. 10 is a flow chart showing an example of the layouting and displaying process.

First, the layout control section 11 determines whether to change a metaphor layout (S21). This determination is made based on whether or not the later-described metaphor layout change flag is set. If the layout is determined to be changed (YES in S21), the layout control section 11 selects a layout template (see FIG. 5) in the field on the column CC10 of the metaphor display management table.

Note that the layout template selected by the layout control section 11 is the one conforming to the user's operation. For example, in a case where the user performs entry operation for switching a processing pattern ruleset for metaphor ID 1 to a processing pattern ruleset for metaphor ID 2, a layout template for metaphor ID 2 is selected.

Next, the layout control section 11 selects shelves to be displayed and determines extraction rules therefor (S23). Specifically, the layout control section 11 refers to the columns CC2 to CC5 and CC7 of the metaphor display management table so as to determine the shelves to be displayed. Further, the layout control section 11 reads out, from the column CC6, an extraction rule description for each of the shelves determined to be displayed.

For example, there is a case where the metaphor display management table shown in FIG. 5 is used with a metaphor applied corresponding to metaphor ID 1. In this case, according to the columns CC2 to CC5 and CC7, the total number of shelves is determined to be four, the number of shelves to be displayed in one screen is determined to be two, the first shelf is determined to be a shelf for “all”, and the second shelf is determined to be a shelf for “new arrival”. Then, respective extraction rule descriptions for the first to fourth shelves are read out.

Further, the layout control section 11 determines a format for a book to be displayed. That is, the layout control section 11 reads out, from the processing pattern ruleset, a title (the column BC3), substance (the column BC7), and visible (the column BC12) for a book to be displayed in each shelf. Furthermore, the layout control section 11 reads out a status (the column EC8) from the book information management table.

The title read out here is presented on a spine label of the book. Further, if the status of the book is “UPDATED”, a mark indicating that the book contains a newly arrived content item is displayed. For a book having “NO” in the substance field and “YES” in the visible field, a predetermined display format is decided. That is, a book containing a content item whose entity is absent is displayed in such a manner as to be distinguishable from other books.

The above process determines an image to be displayed. The layout control section 11 performs allocation of drawing resources for displaying the image (S24, S26). Specifically, the layout control section 11 first determines positioning of books.

For example, according to the metaphor display management table shown in FIG. 5, a shelf display class to which the default shelf display selection is set is “all”; therefore, all books are positioned to the first shelf of the bookshelf. Similarly, since a shelf display class to which the shelf display priority “2” is set is “new”, new books are positioned to the second shelf of the bookshelf.

Subsequently, the layout control section 11 determines an arrangement of the books in each shelf of the bookshelf, according to the number of displayed books on the column CC8 of the metaphor display management table and the positioning on the column BC8 of the processing pattern ruleset.

For example, according to the processing pattern ruleset shown in FIG. 3, positioning for application ID “2” is set to “1”, and positioning for application ID “1” is set to “2”; therefore, a book corresponding to application ID “2” is positioned to the leftmost position in the shelf, and a book corresponding to application ID “1” is positioned next to the book corresponding to application ID “2”. In this manner, the process for determining the arrangement of the books is performed according to the positioning on the column BC8 of the processing pattern ruleset, until the number of books arranged reaches the number of displayed books on the column CC9 of the metaphor display management table.

Note that, if the processing pattern ruleset includes an application ID having no integer of 1 or greater in the “positioning” field, the shelf may be displayed in such a manner that a space for a book corresponding to that application ID is closed up by the following books or the space is left as it is. For example, there may be a case where the following books are allocated to a shelf of a bookshelf: (i) a book corresponding to application ID “2” and having “1” in the “positioning” field, which book is not to be displayed and (ii) a book corresponding to application ID “1” and having “2” in the “positioning” field, which book is to be displayed. In this case, the book corresponding to application ID “1” may be positioned on the leftmost position in the shelf; alternatively, a space for one book may be left on the leftmost position in the shelf, and the book corresponding to application ID “1” may be positioned next to the space.

Further, in a case where a book to be displayed here has a mark application ID set in the field on the column CC8 of the metaphor display management table, the layout control section 11 displays this book in a format different from those of other books. For the book to which the mark application ID is set, a certain display format is predetermined.

Note that a book to be positioned to a shelf of the shelf display class (CC5 in FIG. 5) “viewed”, “recommend”, or “date, input” is defined by an extraction rule description (CC6 in FIG. 5), rather than by a processing pattern ruleset. Specifically, an extraction rule description “Viewed1.scr” specifies that a shelf of the shelf display class “viewed” displays a History book. Likewise, an extraction rule description “Recommend1.scr” specifies that a shelf of the shelf display class “recommend” displays a Recommend book; and an extraction rule description “inputDate.scr” specifies that a shelf of the shelf display class “date, input” displays a screen to which a date or a keyword, each serving as a search key, is entered. Of course, all books may be configured such that display formats therefor are defined by extraction rule descriptions.

Thus, an image of the bookshelf having books arranged in each shelf is generated. This image is positioned on the layout template (see the column CC10 in FIG. 5) stored in the metaphor display management table, and thus the basic operation screen is completed.

Further, the layout control section 11 instructs the operation information interpreting section 10 to update an operation rule to one corresponding to the currently-set metaphor ID (S25). This allows the operation information interpreting section 10 to interpret user's entry operation (e.g., the tool control and/or the sort control; see FIG. 3) according to a processing pattern ruleset for the currently-set metaphor ID.

Lastly, the layout control section 11 clears the metaphor layout change flag (S27). Then, the layouting and displaying process is completed.

On the other hand, if the layout control section 11 determines, in S21, that the metaphor layout is not to be changed (NO in S21), the layout control section 11 determines whether to change a book layout (S28). The determination of whether to change the book layout is made in S8 in FIG. 9 depending on whether or not the book layout change flag is set. Note that the book layout means a display layout of e.g., an index list screen, which is displayed when a book is selected from the bookshelf.

If the layout control section 11 determines that the book layout is to be changed (YES in S28), the layout control section 11 refers to a book information management table associated with the currently-set metaphor ID (S29). More specifically, the layout control section 11 refers to a file stored in the book resource reference field on the column EC9 (see FIGS. 6 and 7) of the book information management table, in order to obtain a resource of a book corresponding to each application ID.

Subsequently, the layout control section 11 reads out, from the processing pattern ruleset, a layout description file for the currently-set metaphor ID (S30). Since this determines an image to be displayed and its layout, the layout control section 11 performs allocation of the drawing resources onto a book screen (a screen for displaying a book), so as to display the image (S31, S32).

Then, the layout control section 11 clears the book layout change flag (S33), and then the layouting and displaying process is completed.

In S28, if the layout control section 11 determines that the book layout is not to be changed (NO in S28), the layout control section 11 determines whether to change a page view (S34). The change of the page view is to be performed, e.g., in a case where a book is selected from the bookshelf or search criteria for a content item is entered (this corresponds to the shelf display class “date, input”). Change of the page view causes the screen displayed on the display section 5 to be updated.

Here, if the layout control section 11 determines that the page view is not to be changed (NO in S34), the layout control section 11 completes the layouting and displaying process. On the other hand, if the layout control section 11 determines that the page view is to be changed (YES in S34), the layout control section 11 refers to the content management table so as to select a book resource according to the change of the page view (S35).

Then, the layout control section 11 draws a book page in which the book resource selected is allocated, so as to display the book page (S36, S37). This leads to display (output) of the content item selected from the index list screen. Then, the layouting and displaying process is completed.

[Details of the Metaphor Changing Process]

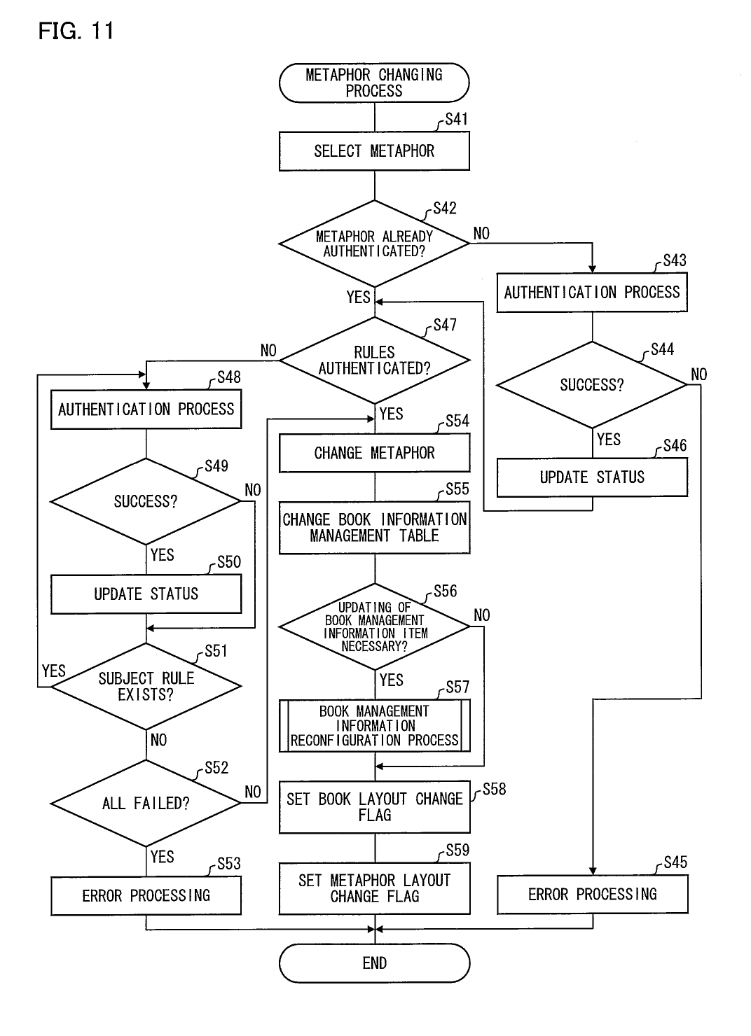

Next, details of the metaphor changing process performed in S6 in FIG. 9 will be described with reference to FIG. 11. FIG. 11 is a flow chart showing an example of the metaphor changing process. The metaphor changing process is performed by the metaphor managing section 13, in a case where the operation information interpreting section 10 determines that entry operation for changing a metaphor has been performed.

First, the metaphor managing section 13 selects a metaphor that the operation information interpreting section 10 has detected as a metaphor designated by the entry operation for changing the metaphor (S41). Subsequently, the metaphor managing section 13 refers to an authentication status (the column CC16 in FIG. 5) in the metaphor display management table, in order to determine whether or not the metaphor selected has been authenticated (S42). If the metaphor selected is not stored in the content processing apparatus 1, it is impossible to refer to the metaphor display management table. In such a case, the metaphor managing section 13 determines that the metaphor has not been authenticated.

Here, if the metaphor managing section 13 determines that the metaphor selected has not been authenticated (NO in S42), the metaphor managing section 13 instructs the trust managing section 14 to perform the authentication process (S43), and then determines whether or not the authentication has succeeded (S44). If the authentication has been failed (NO in S44), the metaphor managing section 13 performs the error processing (S45), and then completes the metaphor changing process. In this case, the metaphor is not changed.

Note that the authentication process varies depending on whether or not the metaphor selected is stored in the content processing apparatus 1. The description here first deals with a process to be performed in a case where the metaphor selected is stored in the content processing apparatus 1, and thereafter a process to be performed in a case where the metaphor selected is not stored in the content processing apparatus 1.

In the case where the metaphor selected is stored in the content processing apparatus 1, the trust managing section 14 uses an URI stored in the access control field (CC14 in FIG. 5) in the metaphor display management table in order to access a server (here, the authentication server S (see FIG. 1)) that performs authentication on the metaphor. Then, the trust managing section 14 requests the authentication server S to authorize the use of the metaphor. If the authentication server S authorizes the use of the metaphor, the authentication process is regarded as succeeded; if the authentication server S does not authorize the use of the metaphor, the authentication process is regarded as being failed. The authentication process will be described in detail later.

On the other hand, if the metaphor selected is not stored in the content processing apparatus 1, it is necessary to perform, prior to the above process, a process for downloading the metaphor to the content processing apparatus 1.

For this purpose, the trust managing section 14 first accesses a management server in order to obtain access information of the metaphor selected. The management server manages (i) access information used to access a metaphor and (ii) a metaphor name, both of which are associated with each other. Specifically, the trust managing section 14 accesses the management server via the transmitter/receiver section 8, and searches for the access information by using a metaphor name of the metaphor selected. Thus, the trust managing section 14 obtains the access information.

Note that the access information may be, e.g., a communication address (URI) in the access control field (CC14 in FIG. 5) in the metaphor display management table. Further, the access information of the metaphor may be stored in the storage section 2 in advance. This makes it possible to omit e.g., the process for the access to the management server.

Subsequently, the trust managing section 14 downloads the metaphor by using the access information obtained as a result of the search, and stores the metaphor in the storage section 2. Then, by using information in an access control field (CC14 in FIG. 5) of a metaphor display management table included in the metaphor stored, the trust managing section 14 performs authentication of the metaphor.

Alternatively, the trust managing section 14 may operate as follows: When accessing the metaphor by using the access information, the trust managing section 14 performs authentication of the metaphor by using the information in the access control field (CC14 in FIG. 5) in the metaphor display management table included in the metaphor, and downloads the metaphor after the authentication succeeds. This has an advantage of preventing an unusable metaphor from being stored in the storage section 2.

Performing the above-described authentication process and succeeding in the authentication makes the metaphor (the metaphor display management table, the processing pattern ruleset, the book information management table) usable by the content processing apparatus 1.

Here, if the authentication is succeeded (YES in S44), the metaphor managing section 13 updates the status (S46). Specifically, for the metaphor which has been successfully authenticated, the metaphor managing section 13 updates an authentication status (see FIG. 5) to “OK” in the field on the column CC16 of the metaphor display management table.

Next, after the status is updated in S46 or if the metaphor is determined in S42 to have been authenticated (YES in S42), the metaphor managing section 13 determines whether or not rules included in the metaphor have been authenticated (S47). Note that the rules herein mean items included in the processing pattern ruleset and the book information management table, which items respectively correspond to the application IDs. Respective authentication states for the rules are stored in the authentication status field on the column EC10 of the book information management table; therefore, the metaphor managing section 13 refers to the authentication status field in order to determine whether or not the rules have been authenticated.

Here, if a rule which has not been authenticated is determined to exist (NO in S47), i.e., if a rule having “NY” in the authentication status field of the book information management table is determined to exist, the metaphor managing section 13 instructs the trust managing section 14 to perform the authentication process on the rule (S48), and determines whether or not the authentication has been succeeded (S49). Note that the trust managing section 14 performs this authentication process by access to an authentication server (here, the authentication server S) identified by the address in the access control field (the column BC13 in FIG. 3) in the processing pattern ruleset.

Note that the authentication process is the same as that in S43. That is, the authentication server S is requested to authorize use of the rule. If the authentication server S authorizes the use of the rule, the authentication process is regarded as being succeeded; if the authentication server S does not authorize the use of the rule, the authentication process is regarded as being failed.

Here, if the authentication is determined to have been succeeded (YES in S49), the metaphor managing section 13 updates the status (i.e., the authentication status on the column EC10 of the book information management table) of the rule to “OK”.

After the status is updated or if the authentication is failed (NO in S49), the metaphor managing section 13 determines whether or not a rule to be subjected to authentication, i.e., a rule having “NY” in the authentication status field still exists (S51). If the rule to be subjected to authentication is determined to exist (YES in S51), the process returns to S48 and the metaphor managing section 13 causes the trust managing section 14 to perform the authentication process on the rule of interest.

On the other hand, if the rule to be subjected to authentication is determined not to exist (NO in S51), the metaphor managing section 13 determines whether or not the authentication for all of the rules has been failed (S52). If the metaphor managing section 13 determines that the authentication for all of the rules has been failed (YES in S52), the metaphor managing section 13 performs the error processing (S45), and then completes the metaphor changing process. In this case, the metaphor is not changed.

On the contrary, if the metaphor managing section 13 determines that there is a rule which has been successfully authenticated (NO in S52), the metaphor managing section 13 changes the metaphor (S54). Specifically, the metaphor managing section 13 changes the processing pattern ruleset to be applied, to one corresponding to a metaphor ID of the metaphor selected in S41.

Next, the metaphor managing section 13 changes the book information management table to one corresponding to the processing pattern ruleset thus changed (S55). Further, at this time, the metaphor managing section 13 determines whether or not updating of the book management information item is necessary (S56).

Specifically, if the book information management table set before the change and the book information management table set after the change are identical to each other in terms of all of the metaphor ID, the application ID, and the substance ID respectively shown in the fields on the columns EC1, EC2, and EC3, the metaphor managing section 13 determines that the updating of the book management information item is not necessary. On the contrary, if the book information management table set before the change and the book information management table set after the change are not identical to each other in terms of at least one of the above items, the metaphor managing section 13 determines that the updating of the book management information item is necessary.

If the updating of the book management information item is determined to be necessary (YES in S56), the metaphor managing section 13 performs a book management information reconfiguration process (S57), and then the process proceeds to S58. On the other hand, if the updating of the book management information item is determined not to be necessary (NO in S56), the process proceeds to S58, without the metaphor managing section 13 performing the book management information reconfiguration process. The book management information reconfiguration process will be described in detail later.

In S58, the metaphor managing section 13 sets the book layout change flag. Then, in the subsequent S59, the metaphor managing section 13 sets the metaphor layout change flag. Accordingly, the layouting and displaying process in FIG. 10 is performed, so that the metaphor layout and book layout are changed. Alternatively, the processes of S58 and S59 may be performed concurrently, or the process of S59 may be performed prior to the process of S58.

[Details of the Authentication Process]

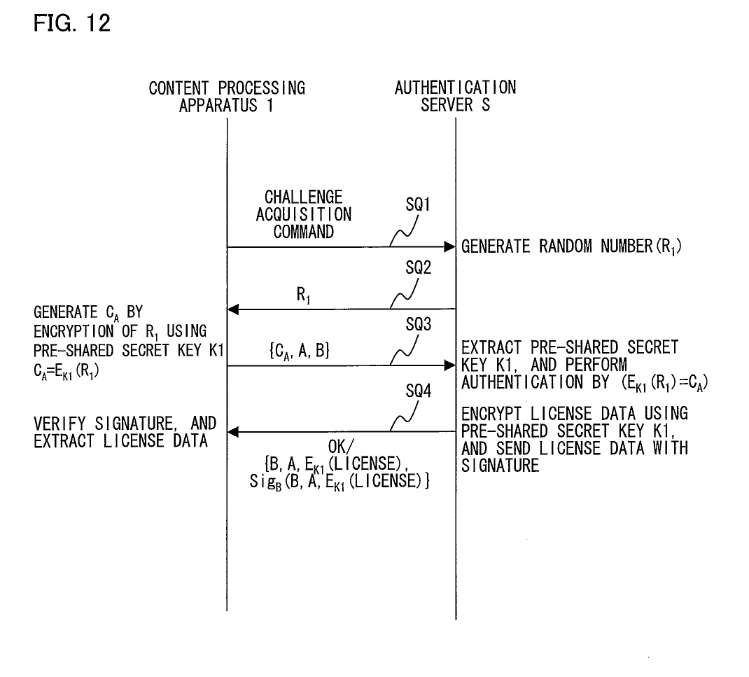

Now, details of the authentication process performed in S43 in FIG. 11 will be described with reference to FIG. 12. FIG. 12 is a sequence diagram showing an example of the authentication process. The description herein deals with an exemplary case where the authentication process is performed by communications with the authentication server S. Here, it is assumed that a metaphor to be subjected to authentication is stored in the storage section 2.

First, the trust managing section 14 reads out a metaphor display management table included in the metaphor stored in the storage section 2, and reads out an URI stored in an access control field (on the column CC14 in FIG. 5) in this table. Then, the trust managing section 14 issues, for the URI read out, a challenge acquisition command, i.e., an encryption key request command preceding a request for authentication of the metaphor, and sends the challenge acquisition command to the authentication server S (SQ1).

Next, the authentication server S, upon receipt of the challenge acquisition command, generates a random number, and temporarily stores in the authentication server S the random number R₁ generated, while also sending the random number R₁ to the content processing apparatus 1 (SQ2).

Next, in the content processing apparatus 1 which has received the random number R₁, the trust managing section 14 performs an encryption operation on the random number R₁ with use of a pre-shared secret key K1 that is pre-held, in order to perform the authentication process in corporation with the authentication server S. This encryption operation is represented by E_{K1}(R₁). Further, output of the encryption operation is represented by C_{A}. That is, the following relationship is established: C_{A}=E_{K1}(R₁).

Subsequently, the trust managing section 14 sends a data group {C_{A}, A, B} to the authentication server S (SQ3). The “A” denotes data (identification information) for identifying the user of the content processing apparatus 1 or the content processing apparatus 1. For example, the data A can be a device ID uniquely assigned to the content processing apparatus 1 or a user ID. The “B” denotes data for identifying the metaphor to be subjected to the authentication. For example, the data B can be the metaphor reference (the column CC13 in FIG. 5) in the metaphor display management table. Note that the data A and the data B may be prestored in the trust managing section 14, or may be stored in the storage section 2. The data B, alternatively, may be entered by the user via the operation section 4.

The authentication server S, upon receipt of the data group, searches in a prestored list for the device or the user identified by the data A. In this list, the device or the user for which the use of the metaphor is to be authorized is associated with the pre-shared secret key used to perform the authentication process in corporation with the device.

As described above, it is predetermined that the authentication server S and the content processing apparatus 1 perform authentication with use of the pre-shared secret key K1. Therefore, in a case where the authentication server S receives the data A identifying the content processing apparatus 1, the authentication server S identifies the pre-shared secret key K1 according to the above list.

Next, the authentication server S performs an encryption operation on the random number R₁ stored in the authentication server S, with use of the pre-shared secret key K1 identified. Then, if output of the encryption operation is identical to C_{A} received from the content processing apparatus 1, it is determined that the authentication of the content processing apparatus 1 has been succeeded.

In the case where the authentication of the content processing apparatus 1 is determined to have been succeeded, the authentication server S first identifies the metaphor to be subjected to authentication, with use of the data B received from the content processing apparatus 1. Subsequently, the authentication server S identifies and extracts license data of the metaphor identified, from a prestored list in which the metaphor is associated with the license data used to make the metaphor usable.

Note that the license data is data which makes the metaphor usable. The license data may be stored in the authentication server S together with management information of the metaphor. Alternatively, the license data itself may exist in another server. In this case, a process for sending the license data is performed between the authentication server S and said another server.

Subsequently, the authentication server S encrypts the license data extracted, with use of the pre-shared secret key K1. Further, the authentication server S attaches, to the license data encrypted, an electronic signature generated with use of a private key of the authentication server S. Then, the authentication server S sends to the content processing apparatus 1 a notification of successful authentication including the license data attached with the electronic signature (SQ4).

In the content processing apparatus 1 which has received the notification of the successful authentication, the trust managing section 14 verifies the signature of the notification of the successful authentication received, in order to determine whether or not the notification of the successful authentication is one supplied from the authentication server S. If the notification of the successful authentication is determined to be the one supplied from the authentication server S, the license data is extracted from the notification of the successful authentication.

Then, the trust managing section 14 refers to the license data extracted, so as to update the authentication status (the column CC16 in FIG. 5) of the metaphor to “OK” in the update metaphor display management table.

Note that, although the metaphor whose authentication status has been updated to “OK” is usable by the content processing apparatus 1, a restriction may be put on a period in which the metaphor is usable by the content processing apparatus 1 or the number of times the metaphor can be used by the content processing apparatus 1.

For example, the following arrangement may be employed: (i) when a predetermined period of time has passed after the updating of the authentication status to “OK”, the authentication status is updated back to “NY”; or (ii) when the number of times of access to the metaphor reaches a predetermined number after the updating of the authentication status to “OK”, the authentication status is updated back to “NY”. Of course, an arrangement without the restriction as above may be employed in which the authentication status is not updated after the authentication status is updated to “OK”.

Such a restriction is performed under control of the trust managing section 14. Note that the restriction on the use of the metaphor is not limited to the above examples, and what kind of authority with regard to the use of the metaphor is to be given is optionally determined by one who defines a service.

[Details of the Book Management Information Reconfiguration Process]

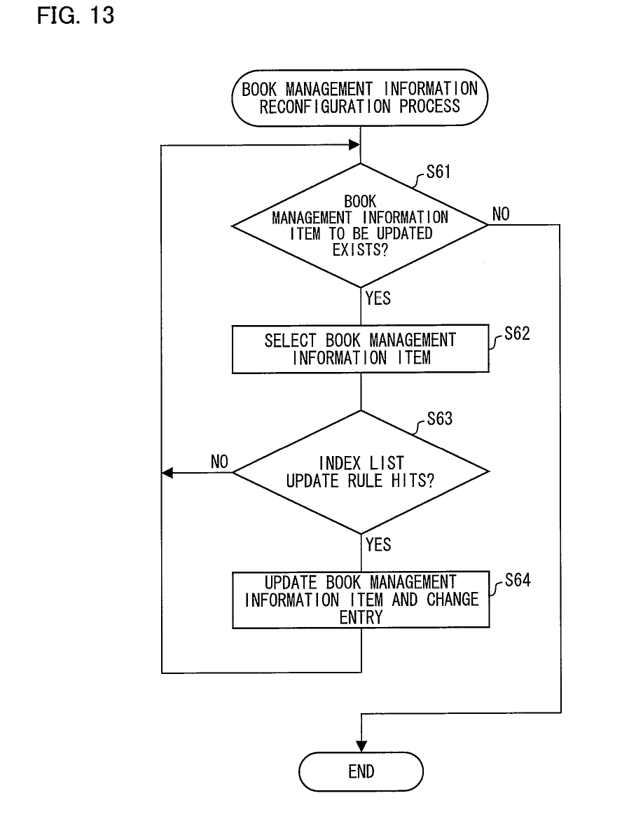

Next, details of the book management information reconfiguration process performed in S57 in FIG. 11 will be described with reference to FIG. 13. FIG. 13 is a flow chart showing an example of the book management information reconfiguration process.

First, the metaphor managing section 13 determines whether or not a book management information item to be updated exists (S61). Specifically, the metaphor managing section 13 compares (i) book management information items included in the book information management table set before the change with (ii) book management information items included in the book information management table set after the change, respectively. That is, the metaphor managing section 13 compares (i) a metaphor ID, application IDs, and substance IDs respectively shown in the fields on the columns EC1, EC2, and EC3 of the book information management table set before the change with (ii) those of the book information management table set after the change, respectively. Then, the metaphor managing section 13 determines whether or not there is a book management information item which has not been updated yet, among book management information items in which these book information management tables are different from each other.

If a book management information item to be updated is determined to exist (YES in S61), the metaphor managing section 13 selects that book management information item (S62). Then, the metaphor managing section 13 refers to the processing pattern ruleset so as to determine whether or not an index list update rule for a book identified by an application ID corresponding to the book management information item of interest hits (S63).

For example, in the example shown in FIG. 3, an index list update rule for a book (DOC book) corresponding to the application ID 1 is “Initially” or “post_interaction”. If either of them applies, the metaphor managing section 13 determines that the index list update rule has hit; if none of them applies, the metaphor managing section 13 determines that the index list update rule has not hit.

Here, if the index list update rule is determined not to hit (NO in S63), the process returns to S61. On the other hand, if the index list update rule is determined to hit (YES in S63), the metaphor managing section 13 updates the book management information item and changes the entry (S64). Thereafter, the process returns to S51.

The processes of S61 through S64 are repeatedly performed until no book management information item to be updated is detected, that is, until the determination “NO” is made in S61. When the determination “NO” is made in S61, the book management information reconfiguration process is completed.

[Example of a Screen Layout]

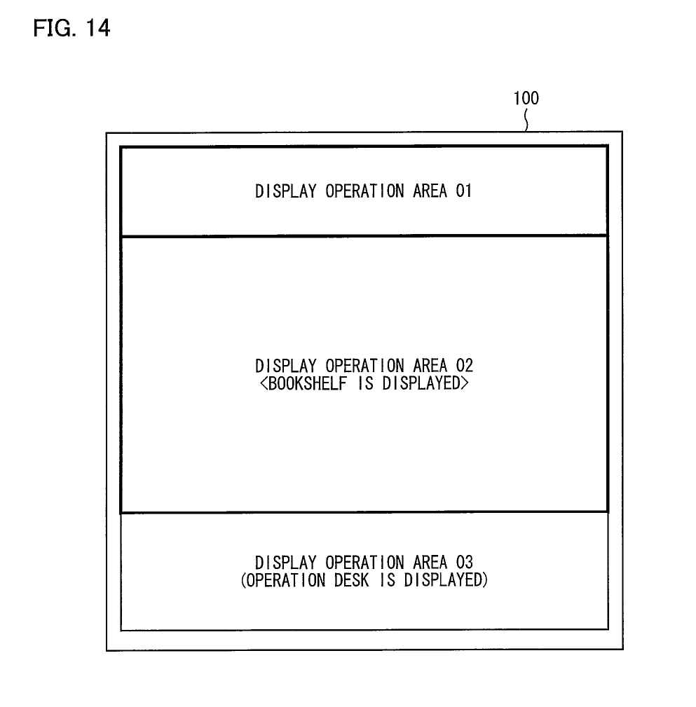

Next, an example of a screen layout used when an image for entry operation is displayed will be described with reference to FIG. 14. FIG. 14 is a view illustrating an example of the screen layout for the image for entry operation. In the example shown in FIG. 14, a display screen 100 of the display section 5 is separated into three areas. Specifically, of the three separate areas of the display screen 100, a first area from the top is referred to as display operation area 01, a second area from the top is referred to as display operation area 02, and a third area from the top is referred to as display operation area 03.

The display operation area 01 is used for display of e.g., (i) a name set to an image (e.g., an image of a bookshelf or a book) displayed on the display operation area 02 and/or (ii) a selection object for changing the shelf display class.

The display operation area 02 is used for display of e.g., an image of a bookshelf or a book. Further, the display operation area 02 is also used for display of a content item selected from an index list of the book.

The display operation area 03 is used for display of an operation desk for viewing a book positioned in a bookshelf. Further, the display operation area 03 is also used as a region in which selection objects for performing the tool control and the sort control are displayed.

[Specific Operation Example (in a Case where a Document File is Selected)]

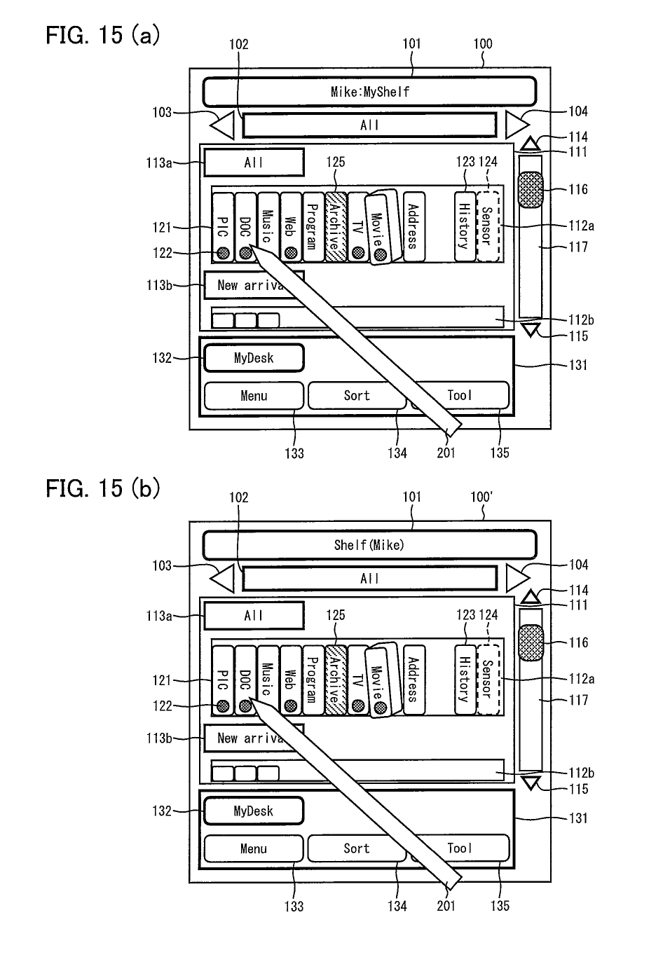

Next, the following describes, with reference to FIGS. 15 through 17, a specific operation example where an image for entry operation is displayed based on the screen layout of FIG. 14.

Each of FIG. 15(a) and FIG. 15(b) is a view showing an example of a display screen displayed when the image for entry operation is displayed based on the screen layout of FIG. 14. FIG. 15(a) shows the display screen 100 for a user, whereas FIG. 15(b) shows a display screen 100′ for another user. Note that each of these exemplary display screens is based on the assumption that the content processing apparatus 1 has a touch panel function and an entry operation is performed with use of a stylus 201.

[Display Operation Area 01]

As shown in FIG. 15(a), a region of the display screen 100 which region corresponds to the display operation area 01 (see FIG. 14) includes a name display field 101, a shelf display class display field 102, a shelf display class changing button (left) 103, and a shelf display class changing button (right) 104.

The name display field 101 shows a name of an image displayed on a region corresponding to the display operation area 02 (see FIG. 14). In the example shown in FIG. 15(a), the region corresponding to the display operation area 02 shows an image of a bookshelf, and the name display field 101 shows “Mike:MyShelf”. This is shown according to the metaphor name (on the column CC12 in FIG. 5) in the metaphor display management table, and indicates that a bookshelf for “Mike” is currently displayed on the name display screen 100.

The shelf display class display field 102 shows a shelf display class applied to books arranged in the first shelf of the bookshelf, which shelf display class has been read out from the column CC5 (see FIG. 5) of the metaphor display management table. The shelf display class shown in the shelf display class display field 102 can be changed by user's entry operation. Also, books to be arranged in the first shelf of the bookshelf can be changed with change in the shelf display class shown in the shelf display class display field 102.

Specifically, the shelf display class shown in the shelf display class display field 102 can be changed with an entry operation with respect to the shelf display class changing button (left) 103 or the shelf display class changing button (right) 104.

That is, each of the shelf display class changing button (left) 103 and the shelf display class changing button (right) 104 is a selection object for changing the shelf display class shown in the shelf display class display field 102 in the order according to the shelf display priorities defined in the field on the column CC4 (see FIG. 5) of the metaphor display management table.

For example, in a case where the shelf display class “new arrival” in the metaphor display management table shown in FIG. 5 is shown in the shelf display class display field 102, an entry operation with respect to the shelf display class changing button (left) 103 changes the shelf display class to “all”, whereas an entry operation with respect to the shelf display class changing button (right) 104 changes the shelf display class to “viewed”.

As will be described in detail, the following arrangement is also possible: An entry operation with respect to the shelf display class display field 102 shows a list of applicable shelf display classes, and a desired shelf display class is selected from the list for its application, or the list is sorted for change of the shelf display priorities.

[Display Operation Area 02]

Next, the following describes the region of the display screen 100 which region corresponds to the display operation area 02 (see FIG. 14). As shown in FIG. 15(a), this region includes a bookshelf 111, shelves 112a and 112b, per-shelf shelf display class display fields 113a and 113b, a display position shifting cursor (up) 114, a display position shifting cursor (down) 115, a scroll box 116, and a scroll bar 117.

The bookshelf 111 has shelves the number of which corresponds with the number of displayed shelves in the field on the column CC2 of the metaphor display management table, and displayed are, of the shelves of the bookshelf 111, shelves the number of which corresponds with the number of concurrently displayed shelves in the field on the column CC3 of the metaphor display management table. The example of FIG. 15(a) is the one displayed according to the metaphor display management table in FIG. 5; therefore, the example of FIG. 15(a) displays (i) the shelf 112a, which is the first shelf of the bookshelf 111 having a total of four shelves, and (ii) the shelf 112b, which is the second shelf of the bookshelf 111.

Further, as shown in the example of FIG. 15(a), the per-shelf shelf display class display field 113a is provided above the shelf 112a, and the per-shelf shelf display class display field 113b is similarly provided above the shelf 112b. The per-shelf shelf display class display fields 113a and 113b respectively show shelf display classes applied to their corresponding shelves. As described previously, a shelf display class assigned to each shelf is determined according to the shelf display priority on the column CC4 and the default shelf display selection on the column CC6 of the metaphor display management table.

That is, assigned to the first shelf is a shelf display class having “1” in the shelf display priority field or a shelf display class to which the default shelf display selection is set; and shelf display classes respectively assigned to the following shelves are determined according to an ascending order of the shelf display priorities. Then, the shelf display classes assigned are respectively shown in the per-shelf shelf display class display fields for their corresponding shelves.

The display position shifting cursor (up) 114, the display position shifting cursor (down) 115, the scroll box 116, and the scroll bar 117 are designed for scroll-display of the bookshelf 111. These allow the user to view a book stored in each shelf of the bookshelf 111.

The display position shifting cursor (up) 114 and the display position shifting cursor (down) 115 may be configured as follows: with a touch of either of the cursors, the bookshelf 111 is shifted by one shelf upward or downward; or while either of the cursors is being touched, the bookshelf 111 is scrolled upward or downward. Further, by dragging the scroll box 116 on the scroll bar 117, it is possible to display a given part of the bookshelf 111.

Further, as shown in FIG. 15(a), the shelf 112a has books 121, 123, 124, and 125 arranged therein. As described previously, a shelf to which books are to be positioned is determined according to the shelf display class on the column CC5 of the metaphor display management table, and an arrangement of the books in each shelf is determined according to (i) the positioning on the column BC8 of the processing pattern ruleset and (ii) the number of displayed books on the column CC8 of the metaphor display management table. In other words, the order in which the books are arranged is determined by the column BC8 of the processing pattern ruleset and the column CC8 of the metaphor display management table, and is also restricted by the column CC5, which indicate a presentation rule.

The books 121 are books to be arranged from the left side of the shelf in order. Further, each of the books 121 has an integer of 1 or greater in the “positioning” field on the column BC8 (see FIGS. 3 and 4) of the processing pattern ruleset. On the other hand, each of the books 123 and 124 is a book to be positioned on the right side of the shelf. Further, each of the books 123 and 124 has a negative number in the “positioning” field on the column BC8 of the processing pattern ruleset.

Further, as shown in FIG. 15(a), each of the books 121 and 123 has a contour made in continuous lines, whereas the book 124 has a contour made in broken lines. This happens because the book 124 (i.e., the book having “Sensor” on the spine label; hereinafter, referred to as “Sensor book”) has “NO” in the substance field on the column BC7 and “YES” in the visible field in the processing pattern ruleset (see FIG. 3).

This allows the user to easily recognize that an entity of the content item that is a component of the Sensor book is not stored in the content processing apparatus 1. Note that a book corresponding to a content item whose entity is not stored in the content processing apparatus 1 only needs to be displayed in such a manner that the user can distinguish that book from other books, and the manner of displaying such a book is not limited to the above example.

As shown in FIG. 15(a), new arrival marks 122 are given to some of the books 121. The new arrival mark 122 is shown in a case where “UPDATED” is stored in the status filed on the column EC8 of the book information management table. This allows the user to easily recognize a book including a content item that the user has not checked yet.

Furthermore, in the example shown in FIG. 15(a), a book (hereinafter, referred to as “Movie book”) having “Movie” on a spine label is displayed in such a manner as to protrude forward more than other books. This happens because this book has a mark application ID (see FIG. 5) in the field on the column CC7 of the metaphor display management table. That is, for this book, “8” is stored as the mark application ID in the field on the column CC7 in FIG. 5, and a title of the book having the application ID “8” is determined to be “Movie” according to the processing pattern ruleset in FIG. 3. Accordingly, the layout control section 11 displays the Movie book in such a manner that the Movie book protrudes forward more than other books.

Note that a display format for a book to which a mark application ID is set is not limited to the above example. By setting the display format in advance, it is possible to display, in a given display format, a book to which a mark application ID is set.

The book 125 is a book corresponding to an application ID which has not been authenticated yet. In the example shown in FIG. 15(a), the book 125 is a book (hereinafter, referred to as “Archive book”) having “Archive” on its spine label. As shown in FIG. 3, an application ID for the Archive book is “6”. Further, as shown in FIG. 6, an authentication status for the book of the application ID “6” is “NY”. Therefore, the Archive book is not available until it is subjected to authentication. This is shown by the marking as on the book 125.

[Display Operation Area 03]

Next, the following describes a region of the display screen 100 which region corresponds to the display operation area 03 (see FIG. 14). As shown in FIG. 15(a), this region includes a desk region 131, a desk name display field 132, a menu button 133, a sort button 134, and a tool button 135.

The desk region 131 is a region onto which a book displayed in the display operation area 02 is dragged and dropped and in which the book dropped is unfolded. That is, in the example shown in FIG. 15(a), a book can be selected by dragging and dropping the book onto the desk region 131, and the book selected can be opened therein. With the book opened, the user can view each content item corresponding to the book and perform other operation.

Note that the operation for selecting a book is not limited to the drag-and-drop. Alternatively, for example, the selection may be made by touching a book (once or twice in a succession). In a case where the operation section 4 is not a touch panel, the operation for selection may be set according to the type of the operation section 4. For example, a book may be selected by key entry.

The desk name display field 132 shows a name associated with the desk region 131. In the example shown in FIG. 15(a), the desk name display field 132 shows “MyDesk”. The name shown in the desk name display field 132 may be optionally set by the user.

The menu button 133 is a selection object for displaying an operation menu screen. The sort button 134 is a selection object for executing the sort control. The tool button 135 is a selection object for executing the tool control. Note that what the natures of the sort control and the tool control are respectively defined in the fields on the columns BC9 and BC10 (see FIGS. 3 and 4) of the processing pattern ruleset.

[Display Screen 100′]

The display screen 100′ shown in FIG. 15(b) also displays an image of a bookshelf similar to that displayed in the display screen 100 shown in FIG. 15(a). The display screen 100′ is the same as the display screen 100, except that the display screen 100′ has a name display field 101 showing “Shelf(Mike)”.

The display screen 100′ is a display screen displayed by the content processing apparatus 1′ (see FIG. 1) that is connected via a network with the content processing apparatus 1 displaying the display screen 100. That is, FIG. 15(b) shows an example where a metaphor used to display Mike's Myshelf is introduced to the content processing apparatus 1′ from the content processing apparatus 1 via the network so that Mike's Myshelf is reproduced and made usable in the content processing apparatus 1′.

In the case where the metaphor used to display Mike's Myshelf is introduced to the content processing apparatus 1′, “Mike:MyShelf” is supposed to be displayed, as in FIG. 15(a), in the name display field 101 of the content processing apparatus 1′. From such an indication, it is however difficult to see whether or not the metaphor has been introduced externally. In view of this, FIG. 15(b) shows a case where “Shelf(Mike)” is shown in the name display field 101 of the display screen 100′. Thus, the name display field 101 may show a name different from a metaphor name (on the column CC12 in FIG. 5) in the metaphor display management table.

[Index List Screen]

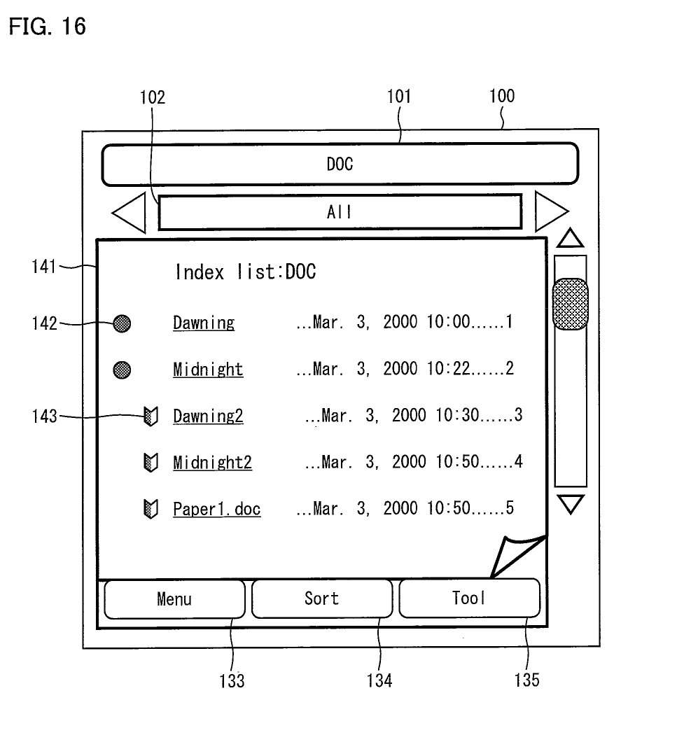

As described previously, in the case where a book is selected, the content processing apparatus 1 displays, in the form of an index list, a list of content items corresponding to the book selected. The following describes, with reference to FIG. 16, an exemplary index list screen displayed when a book (hereinafter, referred to as “DOC book”) having “DOC” on its spine label is dragged and dropped onto the desk region 131 in the basic operation screen shown in FIG. 14. FIG. 16 is a view showing an exemplary index list screen that is displayed when the DOC book is selected.

As shown in FIG. 16, the name display field 101 shows “DOC”, which is a title of the book whose index list is currently displayed. Further, the display operation area 02 shows an index list screen 141.

The index list screen 141 shows, in the form of an index list of a book, a list of content items corresponding to the book. In a case where the content items corresponding to the book are too many to be shown in one screen, the index list screen 141 is created with pages as many as they can cover all of the content items. Then, in response to an entry operation for turning over a page, the index list screen 141 including a desired content item appears.

In the above arrangement, when a book is selected, a list of content names of content items associated with the book selected appears. With such an arrangement, the user can recognize, at a glance, what content items can be referred to within the bounds of the book selected. This is not the only possibility. The index list screen only needs to include an image in which a content name of the content items extracted according to the extraction criteria (on the column BC4 of the processing pattern ruleset) for the book selected is positioned on a page of the opened book. This image can be defined by e.g., the layout description file (on the column BC13 of the processing pattern ruleset).

Further, in the example shown in FIG. 16, five content items are displayed. New arrival marks 142 are respectively given to the first and second content items from the top. The new arrival mark 142 is the same as the new arrival mark 122, and appears with a content item that includes information having not been checked by the user yet. Specifically, the new arrival mark 142 appears beside a content item having “NEW” in the status field on the column AC5 of the content management table (such a content item has “UPDATED” in the status field on the column EC8 of the book information management table).

Further, in the example shown in FIG. 16, bookmarker marks 143 are respectively given to the third and subsequent content items from the top. The content processing apparatus 1 is configured such that a bookmarker can be inserted into a document content item, and the bookmarker mark 143 is displayed in such a manner as to be associated with the document content item into which the bookmarker is inserted.

With the arrangement in which the new arrival mark 142 and the bookmarker mark 143 are displayed together with the list of the content items, the user can recognize, at a glance, a content item including information having not been checked by the user yet and a content item into which a bookmarker is inserted.

The index list screen appears when the operation information interpreting section 10 has detected a user's entry operation for selecting a book. At this time, the operation information interpreting section 10 links a content item included in the index list to a process required for output of the content item. Note that the process required for output of the content item can be identified with reference to the device dependency field on the column AC10 and the device description information field on the column AC11 of the content management table shown in FIG. 2, and the application field on the column BC11 of each processing pattern ruleset shown in FIGS. 3 and 4.

Then, in a case where it is determined that a content item included in the index list screen has been selected while the index list screen is displayed, the operation information interpreting section 10 determines that entry operation for outputting the content item has been performed. In this case, the operation information interpreting section 10 runs an application necessary for outputting the content item. Note that the application necessary for outputting the content item can be identified with reference to the application field on the column BC11 of each processing pattern ruleset shown in FIGS. 3 and 4. Consequently, the content item selected from the index list screen is outputted.

[Display Screen for a Document]

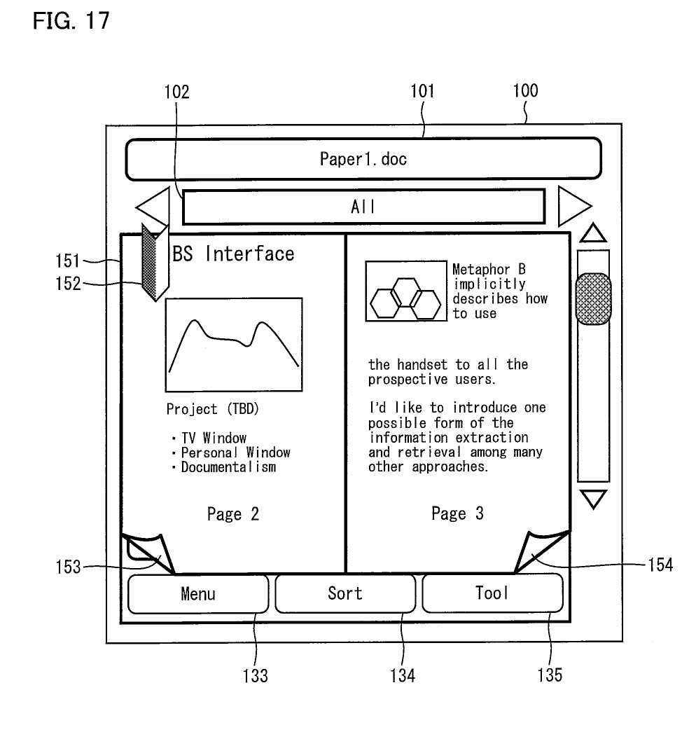

When “Paper1.doc” is selected from among the content items (document content items) displayed on the index list screen in FIG. 16, the content item “Paper1.doc” is outputted. That is, as shown in FIG. 17, a book image 151 appears which shows a two-page spread where the content of the “Paper1.doc” selected is displayed over both pages. The book image 151 is a viewer screen that the content processing apparatus 1 provides for the document. FIG. 17 is a view showing an exemplary viewer screen for the document selected.

As shown in FIG. 17, the bookmarker 152 is shown on the book image 151. That is, when the document content item to which the bookmarker 152 is inserted is selected from the index list screen 141, there appears a page of the document content item on which page the bookmarker 152 is inserted.

Further, as shown in FIG. 17, at a lower left corner 153 and a lower right corner 154 of the book image 151, the pages of the book are displayed as being turned up. The content processing apparatus 1 is configured such that with a touch of either of the lower left corner 153 and the lower right corner 154 of the book image 151, a page is turned over. That is, with a touch of the lower left corner 153, a page previous to the currently-displayed page appears, and with a touch of the lower right corner 154, a page following the currently-displayed page appears. With this, the user can view the document by performing an operation similar to an action of turning over a page of a real book. In other words, the arrangement shown in FIG. 17 enables an intuitive operation. Of course, the entry operation for turning over a page is not limited to the above example. Alternatively, any entry operation can be pre-set as the operation for turning over a page.

In the example shown in FIG. 17, the book image 151 displaying the two-page spread where the content of the document content item is displayed over both pages. Alternatively, only one page may be displayed. In the case where only one page is displayed, it is possible to display the content of the document content image in a larger scale, as compared with the case of displaying the two-page spread where the content of the document content item is displayed over both pages. Further alternatively, two-page spread display and single page display may be made switchable therebetween e.g., by operation of the tool button 135 or the like.

[Specific Operation Example (in a Case of the Shelf Display Class “New Arrival”)]

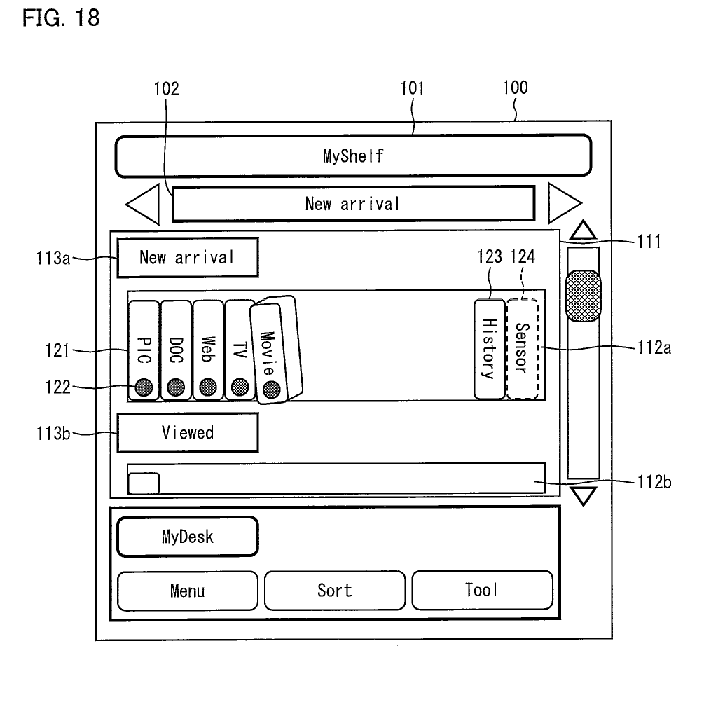

As described previously, the book 121 displayed in the shelf 112a is changed according to the shelf display class displayed in the shelf display class display field 102. The following describes, with reference to FIG. 18, an exemplary display screen observed when “New arrival” is caused to appear in the shelf display class display field 102. FIG. 18 is a view showing an exemplary display screen observed when “New arrival” is caused to appear in the shelf display class display field 102.

When the shelf display class is changed, the shelf display priorities (see FIG. 5) in the field on the column CC4 of the metaphor display management table are updated. Specifically, when the shelf display class is changed to “New arrival”, a shelf display priority for “new arrival” is updated to “1”. Note that a shelf display class which had a shelf display priority “1” before the change of the shelf display class is put on a lower priority.

Then, upon update of the shelf display priorities, the image to be displayed is also updated according to the shelf display priorities updated. This causes, as shown in FIG. 18, books of “new arrival”, i.e., books each having “UPDATED” in the status field in the book information management table to be arranged in the shelf 112a. Also, a book having “UNKNOWN” in the status field (see FIGS. 6 and 7) may be treated as a book of “new arrival”. Further, the per-shelf shelf display class display field 113a for the shelf 112a shows “New arrival”, and the per-shelf shelf display class display field 113b for the shelf 112b shows “Viewed”.

As described previously, the arrangement of the books is determined according to: the positioning on the column BC8 of the processing pattern ruleset; and the number of displayed books on the column CC9 of the metaphor display management table, and a display format for each book is determined by: the mark application ID on the column CC8 of the metaphor display management table; the visible on the column BC12 of the processing pattern ruleset; and the authentication status on the column EC10 of the book information management table. Further, for some of the shelf display classes, a display format for each book is determined according to the extraction rule description on the column CC6. In the case where the shelf display class is “new arrival”, the new arrival marks 122 are respectively displayed for all of the books 121, as shown in FIG. 18.

Here, in the example shown in FIG. 18, the books 123 and 124, which are not newly arrived books, are displayed in the shelf 112a. As such, it is also possible to set a book which is to be displayed all the time regardless of the shelf display class.

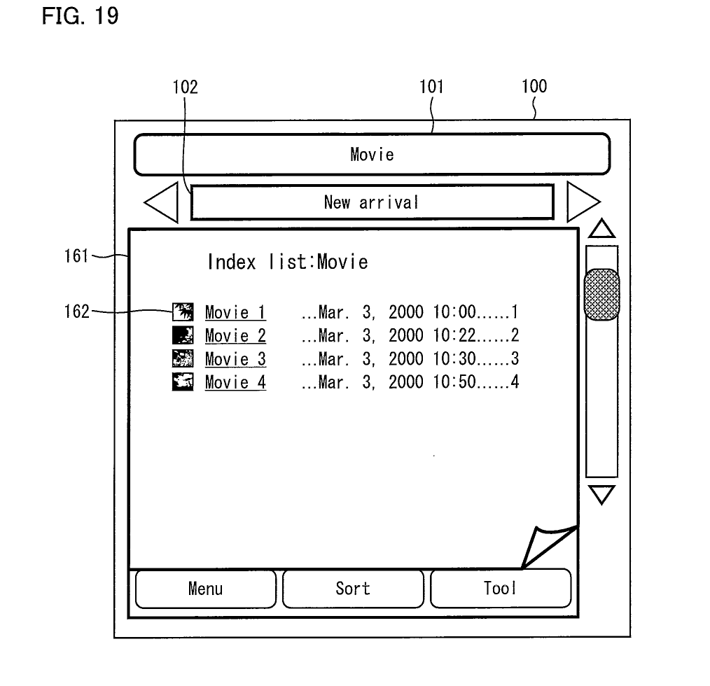

When a Movie book is selected in the basic operation screen shown in FIG. 18, an index list screen for the Movie book appears as in FIG. 19. FIG. 19 is a view showing an exemplary index list screen to be displayed when the Movie book is selected.

As shown in FIG. 19, an index list screen 161 for the Movie book shows a list of four content items, specifically, “Movie 1” to “Movie 4”. FIG. 19 shows an example where the Movie book is selected from the shelf for new arrival. Therefore, these content items are all newly arrived ones. That is, in the case where a book is selected from the shelf for new arrival, newly-arrived content items are extracted from content items associated with the book selected, and then a list of the content items extracted is displayed.

Specifically, when it is determined that an entry operation for selecting a book from the bookshelf has been performed, the operation information interpreting section 10 notifies the layout control section 11 of it. Then, the layout control section 11, upon receipt of the notification, determines that the page view is to be changed (YES in S34 in FIG. 10).

The layout control section 11, which has determined that the page view is to be changed, refers to the processing pattern ruleset in order to identify a target extension of the book selected, and refers to the metaphor display management table in order to identify the shelf display class of the shelf from which the book is selected.

Then, the layout control section 11 selects a book resource to be allocated on the index list screen (S35 in FIG. 10). That is, the layout control section 11 refers to the content management table in order to extract content names of content items each having the target extension identified and corresponding to the shelf display class identified.

Lastly, the layout control section 11 generates an image for displaying, in a list, the content names extracted, and causes the display section 5 to display the image generated (S36 and S37 in FIG. 10). Further, at this time, an element constituting the index list screen which element is not the content name is also allocated. Thus, the index list screen 161 as shown in FIG. 19 is displayed.

As shown in FIG. 19, the date and time is displayed beside each content name. The date and time displayed here is the date and time on which the content item is registered in the content management table, and is displayed according to the “update date and time” field on the column AC9 (see FIG. 2) of the content management table.

Further, as shown in FIG. 19, a thumbnail image 162 is shown beside each content name. The thumbnail image 162 is shown for a content item corresponding to an application ID having “YES” in the “thumbnail” field on the column BC6 (see FIGS. 3 and 4) of the processing pattern ruleset. With the thumbnail image 162 displayed, the user can easily recognize the content of the content item.

Here, the book has been selected from the shelf for “new arrival”. Therefore, the shelf display class display field 102 displays “New arrival”. Note that the content processing apparatus 1 is configured as follows: Also during display of the index list screen 161, an indication of the shelf display class display field 102 can be changed by the same operation as during the display of the bookshelf. Then, when the indication of the shelf display class display field 102 is changed, the index list screen 161 is updated so as to display a list of content names extracted according to the changed shelf display class.

[Specific Operation Example (in a Case of Setting the Shelf Display Class to “Viewed”)]

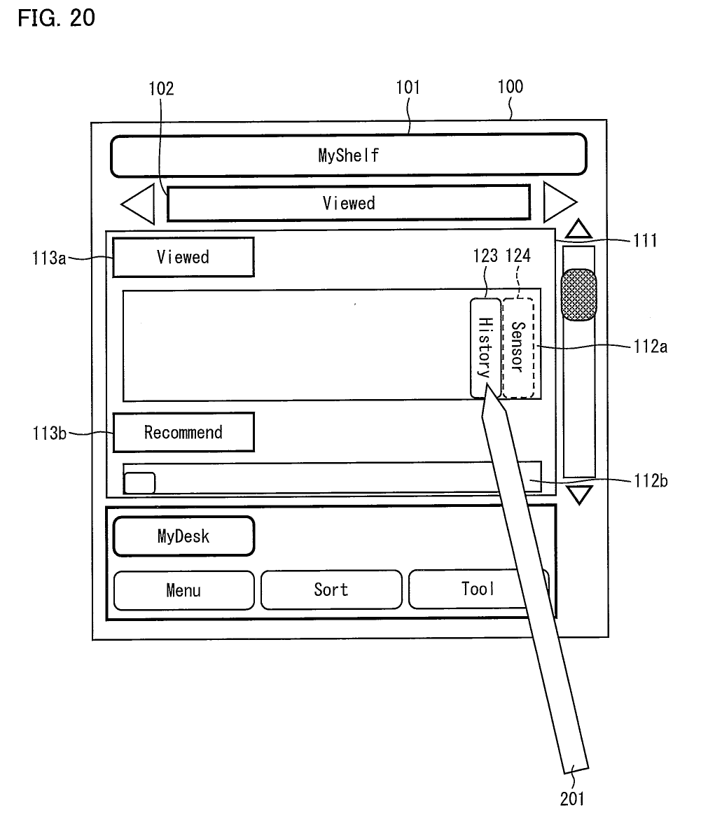

Next, the following describes, with reference to FIG. 20, an exemplary display screen observed when “Viewed” is caused to appear in the shelf display class display field 102. FIG. 20 is a view showing an exemplary display screen observed when “Viewed” is caused to appear in the shelf display class display field 102.

As shown in FIG. 20, when “Viewed” is displayed in the shelf display class display field 102, “Viewed” is also displayed in the per-shelf shelf display class display field 113a. Further, the book 123 for viewing a viewed content item is positioned to the shelf 112a associated with the per-shelf shelf display class display field 113a.

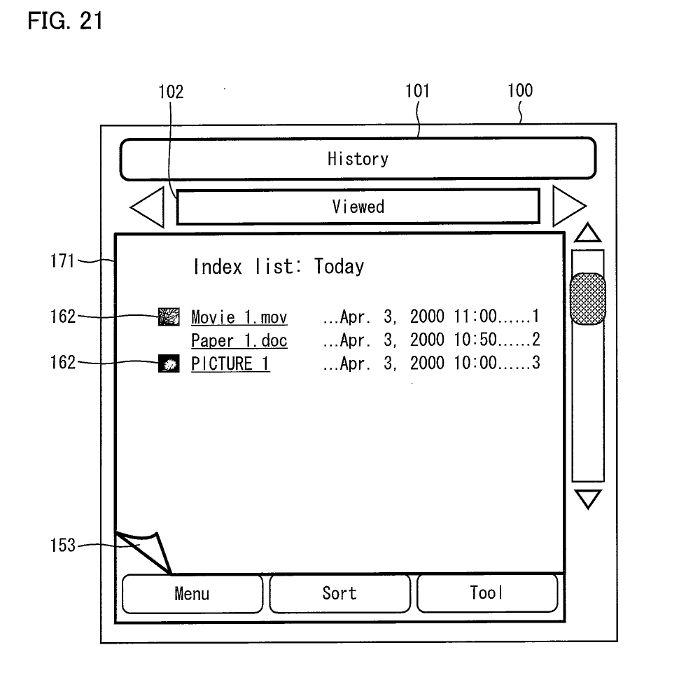

As shown in FIG. 20, the book 123 is a book having “History” on its spine label, i.e., History. When the History book is selected in the basic operation screen shown in FIG. 20, an index list screen for the History book as shown in FIG. 21 is displayed. FIG. 21 is a view showing an exemplary index list screen to be displayed when the History book is selected.

As shown in FIG. 21, an index list screen 171 for the History book shows three content items, specifically, “Movie 1.mov”, “Paper 1.doc”, and “PICTURE 1” in a list form. Further, the index list screen 171 also includes the indication “Index list: Today”. These content items are the ones which have been extracted (S35 in FIG. 10) according to the “update timing” (DC7 in FIG. 8) of the operation history management table and which were viewed today (in the example shown in FIG. 21, Apr. 3, 2008).

There is a case where the content names to be displayed in the list extend off screen. In such a case, the following arrangement is possible: the content names that extend off screen are made viewable with an operation of the scroll box 116 and the scroll bar 117.

Further, as shown in FIG. 21, the date and time is displayed beside each content name, and the thumbnail images 162 are respectively displayed beside “Movie 1.mov”, which is moving image data, and “PICTURE 1”, which is still image data. With the thumbnail images 162 displayed, the user can easily recognize the content of the content item.

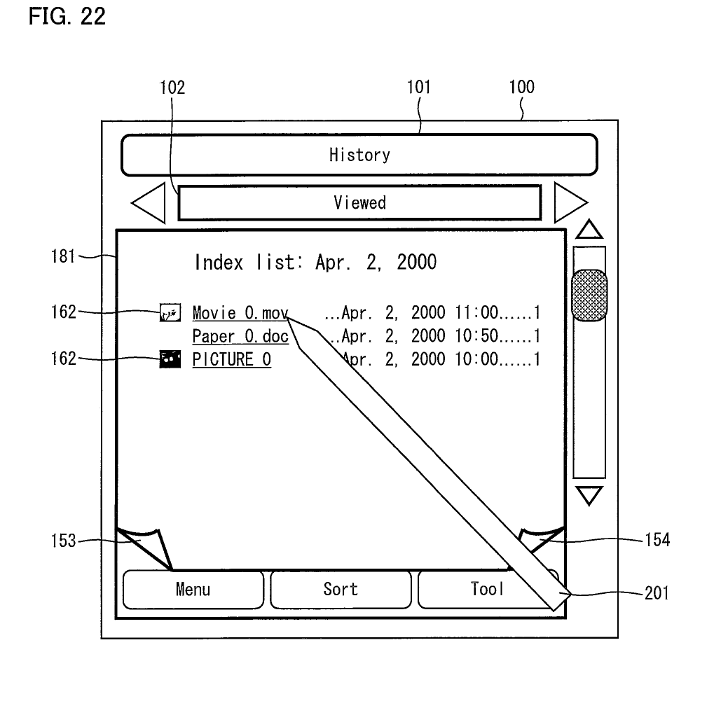

In addition, a lower left corner 153 of the index list screen 171 is configured to be selectable by the user. When the lower left corner 153 is selected, a moving image of the page being turned over is displayed, and the index list screen 171 is updated to a state as shown in FIG. 22 where a list of content names of content items viewed on the previous day (in the example shown in FIG. 22, Apr. 2, 2008) is displayed.

That is, when determining that entry operation for selecting the lower left corner 153 has been performed, the operation information interpreting section 10 notifies it to the layout control section 11. Then, the layout control section 11, upon receipt of the notification, determines that the page view is to be changed (YES in S34 in FIG. 10). Then, the processes of S35 through S37 in FIG. 10 are performed, so that the display screen is updated to the state described above.

FIG. 22 is a view showing an exemplary index list screen to be displayed when the History book is selected, and FIG. 22 illustrates an index list screen 181 that shows content names of the content items viewed on the date previous to the current date.

As shown in FIG. 22, the index list screen 181 shows the list of the content names of the content items viewed on Apr. 2, 2008. Further, a lower left corner 153 of the index list screen 181 is configured to be selectable by the user, and a lower right corner 154 thereof is also configured to be selectable by the user.

When the lower left corner 153 is selected, a moving image of the page being turned over is displayed, and the index list screen 181 is updated to a state where a list of content names of content items viewed on the previous day (in the example shown in FIG. 22, Apr. 1, 2008) is displayed. Likewise, when the lower right corner 154 is selected, a moving image of the page being turned over is displayed, and the index list screen 181 is updated to a state where a list of content names of content items viewed on the next day (in the example shown in FIG. 22, Apr. 3, 2008) is displayed, i.e., to the index list screen 171 shown in FIG. 21.

[Specific Operation Example (Change of the Shelf Display Class)]

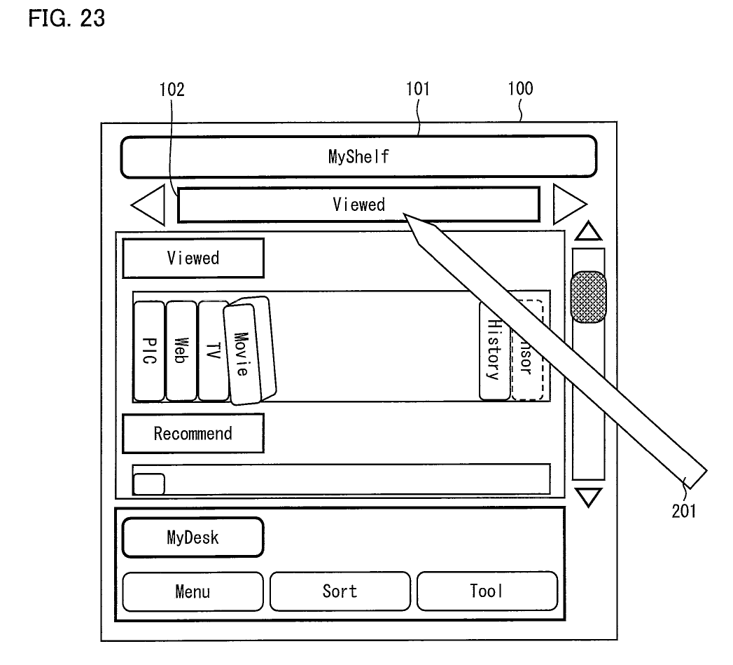

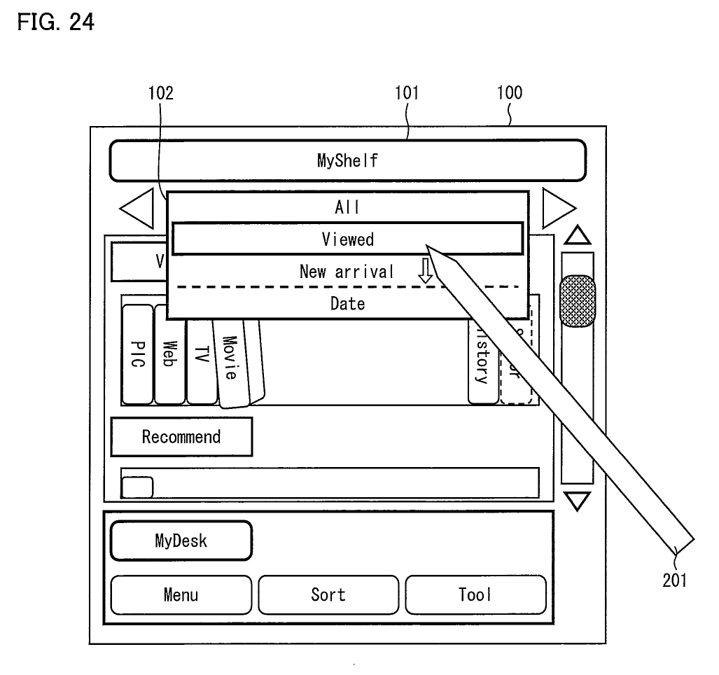

Next, the following describes, with reference to FIGS. 23 and 24, an exemplary display screen observed when the shelf display class is changed by entry operation performed with respect to the shelf display class display field 102. FIG. 23 is a view showing an exemplary display screen observed before the shelf display class display field 102 is touched, whereas FIG. 24 is a view showing an exemplary display screen observed after the shelf display class display field 102 is touched.

With a touch of the shelf display class display field 102 using e.g., the stylus 201 as shown in FIG. 23, a drop-down menu appears as shown in FIG. 24. The drop-down menu displays, as shown in FIG. 24, a list of shelf display classes.

The order in which the shelf display classes are shown in the drop-down menu corresponds to the shelf display priorities in the fields on the column CC4 (see FIG. 5) of the metaphor display management table. That is, in the example shown in FIG. 24, a shelf display priority for “all” is set to “1”, a shelf display priority for “viewed” is set to “2”, a shelf display priority for “new arrival” is set to “3”, and a shelf display priority for “date” is set to “4”.

Here, the content processing apparatus 1 is configured such that when a user's entry operation is performed with respect to the drop-down menu, a desired shelf display class is shown in the shelf display class display field 102 as well as the shelf display priority is changed.

Specifically, when determining that selection operation (e.g., touching once or touching twice in a succession) has been performed with respect to any one of the shelf display classes shown, the operation information interpreting section 10 applies, to the first shelf, the shelf display class for which the selection operation has been performed. Consequently, the books arranged in the first shelf are updated.

Further, in a case where entry operation for dragging and dropping any one of the shelf display classes shown is performed, the operation information interpreting section 10 updates a shelf display priority (in the metaphor display management table) for the shelf display class which has been dragged and dropped, according to the position onto which the shelf display class has been dragged and dropped.

For example, keeping touching the shelf display class “Viewed” for a predetermined period of time or longer makes the shelf display class “Viewed” movable. In a case where the shelf display class “Viewed” is dragged and dropped onto the position of the broken line shown in FIG. 24, the position at which the shelf display class “Viewed” is shown is replaced by the position at which the shelf display class “New arrival” is shown. Further, the shelf display priorities in the field on the column CC4 (see FIG. 5) of the metaphor display management table are updated accordingly so that they are arranged in the same order as the order in which the shelf display classes are shown in the drop-down menu.

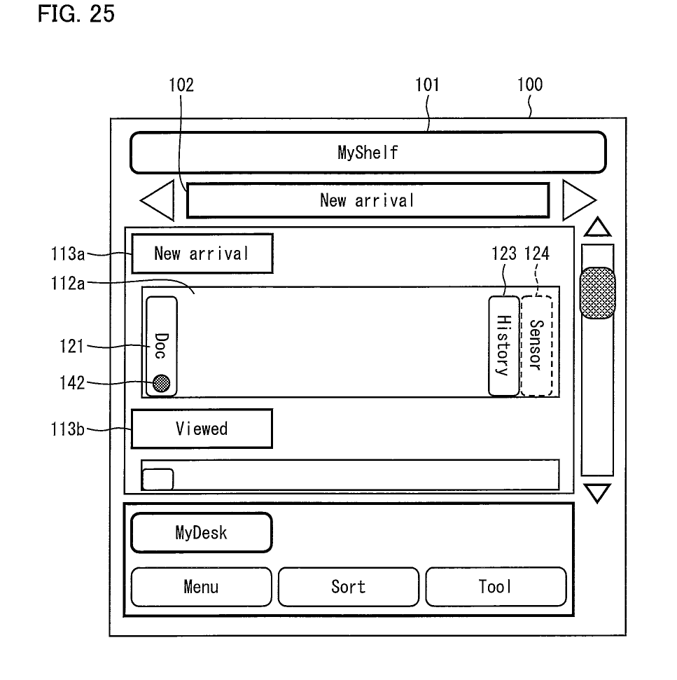

Further, in a case where “New arrival” is selected from the drop-down menu shown in FIG. 24, the shelf display class to be applied to the first shelf is changed to “new arrival”, and the basic operation screen as shown in FIG. 25 is displayed. FIG. 25 is a view showing an exemplary display screen observed when “New arrival” is selected from the drop-down list that has appeared with a touch on the shelf display class display field 102.

In the case where “New arrival” is selected from the drop-down list that has appeared with the touch on the shelf display class display field 102, the shelf display class display field 102 shows “New arrival” as shown in FIG. 25. Then, the shelf 112a displays the book 121 having the new arrival mark 142 attached thereto, i.e., the book 121 having “UPDATED” in the “status” field on the column EC8 of the book information management table.

[Specific Operation Example (in a Case where the Shelf Display Class is Set to “Recommend”)]

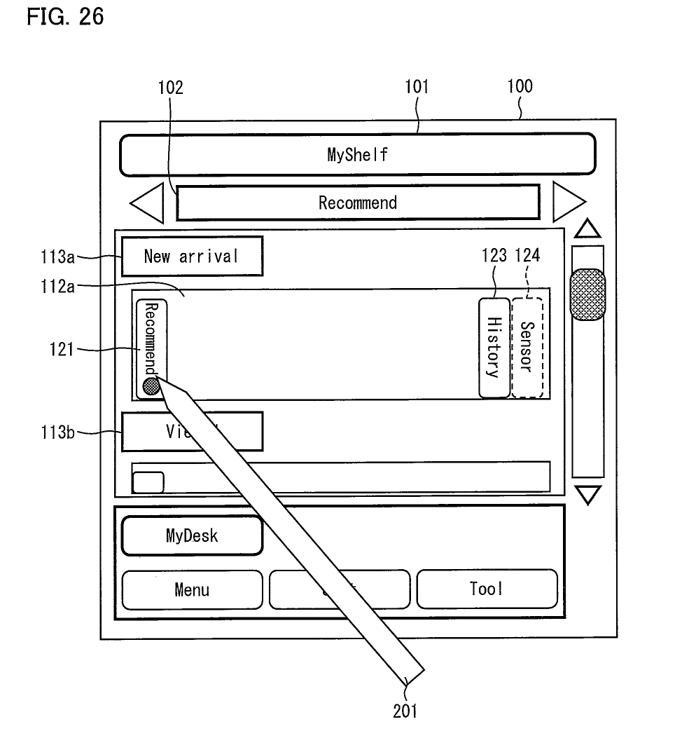

Next, the following describes, with reference to FIG. 26, an exemplary display screen observed when “Recommend” is caused to appear in the shelf display class display field 102. FIG. 26 is a view showing an exemplary display screen observed when “Recommend” is caused to appear in the shelf display class display field 102. As shown in FIG. 26, in the case where “Recommend” is caused to appear in the shelf display class display field 102, a Recommend book is positioned in the shelf 112a. Further, in the example shown in FIG. 26, “New arrival” is shown in the per-shelf shelf display class display field 113a.

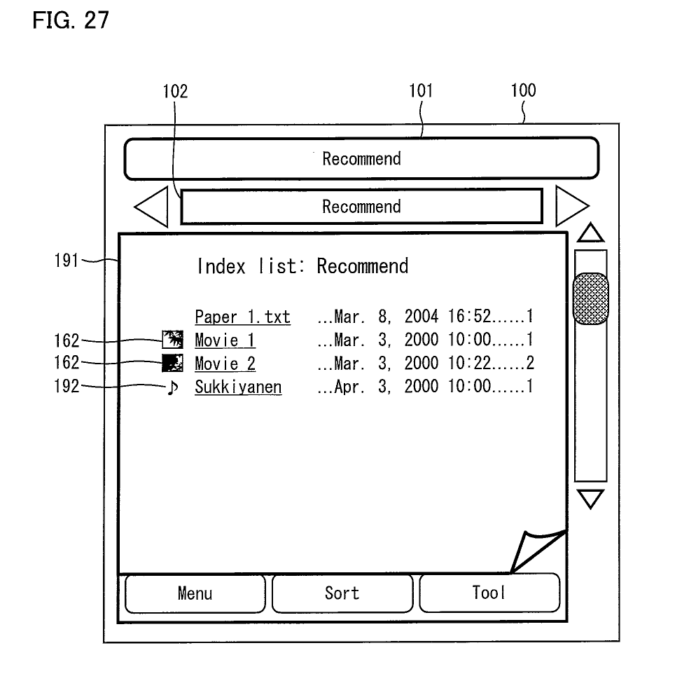

The Recommend book is a book for reference to a content item for which a recommendation flag is set in the field on the column AC16 (see FIG. 2) of the content management table. When the Recommend book is selected, an index list screen 191 for the Recommend book is displayed as shown in FIG. 27. FIG. 27 is a view showing an exemplary index list screen displayed when the Recommend book is selected.

As shown in FIG. 27, the index list screen 191 for the Recommend book shows four contents, specifically, “Paper 1.txt”, “Movie 1”, “Movie 2”, and “Sukkiyanen” in a list form. In the example shown in FIG. 27, these contents are all newly arrived ones, since the Recommend book has been selected from the shelf for new arrival.

As shown in FIG. 27, the thumbnail images 162 for “Movie 1” and “Movie 2”, both of which are moving image files, are respectively displayed on the left sides of these moving image files. Further, a musical note mark 192 is displayed on the left side of “Sukkiyanen”. This shows that the content item “Sukkiyanen” is an audio file. The musical note mark 192 is displayed in the same manner as the thumbnail image 162.

Such a display is realized as a result of the processes of S34 through S37 in FIG. 10. That is, when determining that entry operation for selecting the Recommend book has been performed, the operation information interpreting section 10 notifies it to the layout control section 11. The layout control section 11, upon receipt of the notification, determines that the page view is to be changed (YES in S34 in FIG. 10).

The layout control section 11, which has determined that the page view is to be changed, refers to the content management table in order to select a book resource for displaying the index list screen for the Recommend book (S35 in FIG. 10). That is, the layout control section 11 refers to the content management table in order to extract content names of content items each having “NEW” in the “status” field and the recommendation flag set therein.

Further, since the Recommend book has “YES” in the “thumbnail” field in the processing pattern ruleset, the layout control section 11 reads out the thumbnail image for each of the content items. In a case where the content item is an audio file, the layout control section 11 reads out an image of the musical note mark 192 which is prestored.

Then, the layout control section 11 performs allocation of the resource extracted so as to draw a page, and causes the display section 5 to display the page drawn (S36 and S37 in FIG. 10). This leads to display of the index list screen 191 as shown in FIG. 27.

[Specific Operation Example (Switchover of the Processing Pattern Ruleset to Another)]

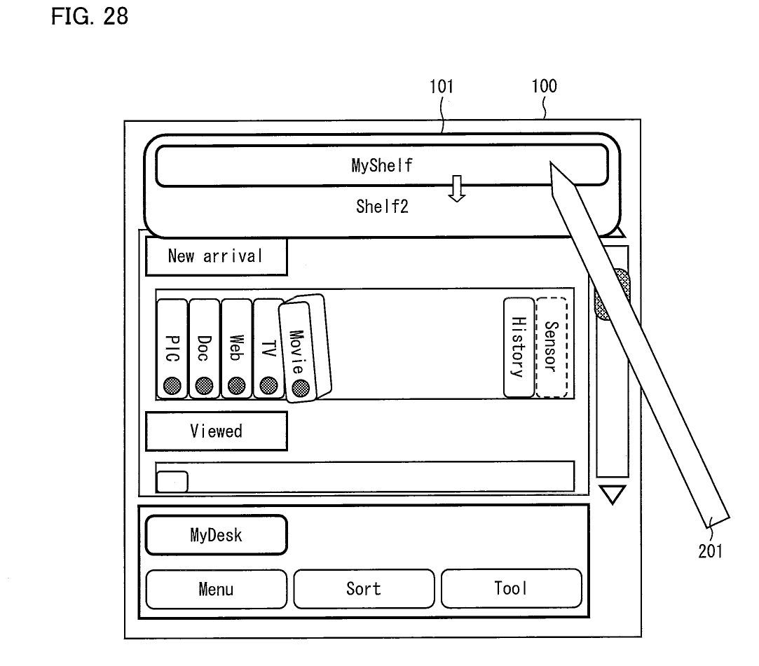

Next, the following describes, with reference to FIGS. 28 to 30, how the content processing apparatus 1 switches the processing pattern ruleset to another. Each of FIGS. 28 to 30 is a view showing an exemplary display screen observed when the processing pattern ruleset is switched to another.

As shown in FIG. 15(a), FIG. 15(b), etc., the basic operation screen is displayed with the name of the bookshelf (metaphor name) shown in the name display field 101. The description herein deals with an example where switchover of the processing pattern ruleset to another is performed through the name display field 101.

With a touch of the name display field 101, in which the name of the bookshelf is shown, using the stylus 201 or the like, a drop-down menu appears as shown in FIG. 28. The drop-down menu shows a name of a shelf which is an alternative candidate for the currently-displayed bookshelf. In the example shown in FIG. 28, “MyShelf”, which is the name of the currently-displayed bookshelf, and “Shelf2”, which is the name of the alternative candidate bookshelf, are displayed, and “MyShelf” has been selected.

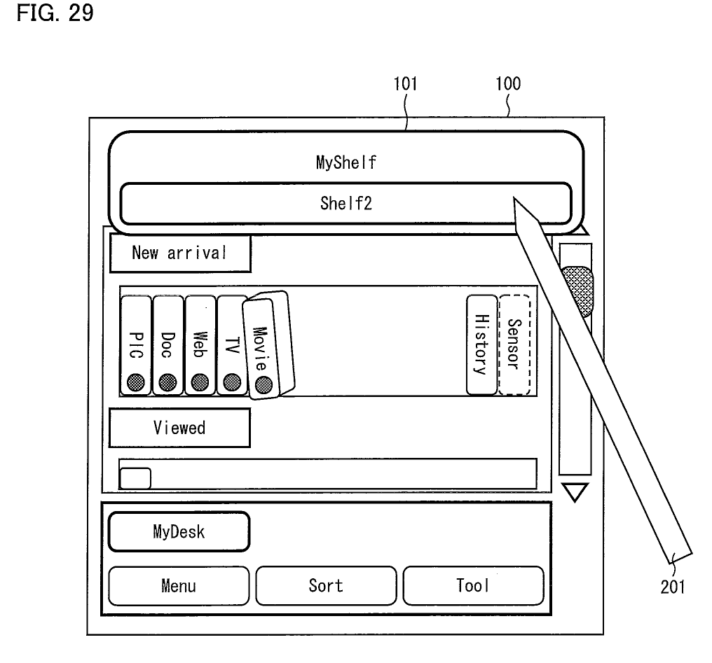

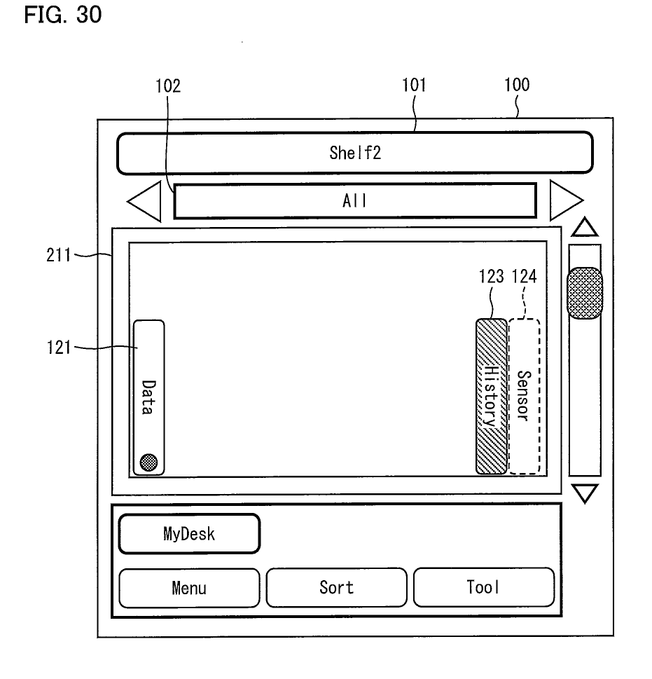

Here, in a case where “Shelf2” is selected as shown in FIG. 29, the name display field 101 shows the selected name “Shelf2” as shown in FIG. 30. Note that a name to be selected is shown after being read out from the metaphor name field (on the column CC12 in FIG. 5) in the metaphor display management table. For a metaphor not stored in the content processing apparatus 1, access to e.g., a server providing an authentication service is made to obtain a metaphor name list, which is designed for metaphors managed by the server. Then, with reference to the obtained list, a name of such a metaphor is shown.

In a case where a metaphor of “Shelf2” selected is stored in the content processing apparatus 1, switchover to the metaphor of “Shelf2” is performed. On the other hand, in a case where the metaphor of “Shelf2” is not stored in the content processing apparatus 1, the metaphor of “Shelf2” is obtained via the transmitter/receiver section 8, and switchover to the metaphor obtained is then performed.

In response to the switchover of the metaphor to another, the processing pattern ruleset and the like, each of which is used for presentation of a content item to the user and for interpretation of user's operation, are also switched to another. With this, the bookshelf to be displayed is switched to the one corresponding to the name “Shelf2”. Consequently, user's operation is interpreted according to the displayed bookshelf.

Specifically, when determining that entry operation for selecting “Shelf2” has been performed, the operation information interpreting section 10 determines that the metaphor is to be changed (YES in S5 in FIG. 9), and notifies it to the metaphor managing section 13. The metaphor managing section 13, upon receipt of the notification, performs the metaphor changing process (S6 in FIG. 9).

In the metaphor changing process, the metaphor managing section 13 selects metaphor ID 2, which is a metaphor ID corresponding to “Shelf2”. Here, if the metaphor of metaphor ID 2 has not been authenticated, the metaphor managing section 13 causes the trust managing section 14 to perform the authentication process in order to make the metaphor of metaphor ID 2 usable by the content processing apparatus 1. If the authentication process has succeeded, the metaphor of metaphor ID 2 is made usable by the content processing apparatus 1. (S41 to S46 in FIG. 11)

In the case where the metaphor of metaphor ID 2 has been made usable in this manner, the metaphor managing section 13 changes the processing pattern ruleset to be applied, to the processing pattern ruleset for metaphor ID 2 (FIG. 4). Besides, the metaphor managing section 13 changes the book information management table to the one (FIG. 7) corresponding to metaphor ID 2 (S54 to S57 in FIG. 11).

Further, the metaphor managing section 13 sets the book layout change flag and the metaphor layout change flag (S58 and S59 in FIG. 11), so as to complete the metaphor changing process. With this, the process goes to S2 in FIG. 9.

Here, since the book layout change flag and the metaphor layout change flag are set, the metaphor layout is changed in the layouting and displaying process performed in S2. Then, the book layout is changed in another layouting and displaying process to be performed after the metaphor layout has been changed.

That is, in the layouting and displaying process performed immediately after the book layout change flag and the metaphor layout change flag have been set, the process branches toward “YES” in S21. Then, the layout control section 11 selects a layout template (see FIG. 5) for the metaphor ID 2 from the field on the column CC10 of the metaphor display management table.

Subsequently, the layout control section 11 refers to the columns CC2 to CC6 of the metaphor display management table so as to determine shelves to be displayed, and reads out from the field on the column CC6 an extraction rule description for each of the shelves determined to be displayed. For example, in a case of using the metaphor display management table shown in FIG. 5, a total number of shelves of the bookshelf is determined to be two, the number of shelves to be displayed in one screen is determined to be one, the first shelf is determined to display a shelf for “all”, and the second shelf is determined to display a shelf for “date, input”. Then, an extraction rule description for each of the first and second shelves is read out.

Further, the layout control section 11 determines a format for a book to be displayed. That is, the layout control section 11 reads out, from the processing pattern ruleset, a title (on the column BC3), substance (on the column BC7), and visible (on the column BC12) for a book to be displayed in each shelf. Furthermore, the layout control section 11 reads out a status (on the column EC8) and an authentication status (on the column EC10) from the book information management table.

The title read out here is shown on a spine label of the book. In a case where the status of the book is “UPDATED”, the new arrival mark 122, which notifies that the book includes a newly-arrived content item, is displayed. Further, a book having “NO” in the substance field and “YES” in the visible field is determined to be displayed in broken lines. Furthermore, a book having “NY” in the authentication status field is determined to be displayed with diagonal lines, like the book 125 in each of FIG. 15(a) and FIG. 15(b).

For example, in a case of using the processing pattern ruleset shown in FIG. 4, “Data” corresponding to the application ID 1, “History” corresponding to the application ID 10, “Sensor” corresponding to the application ID 11, and “Data_oriented” corresponding to the application ID 13 are each defined as a book. Of these, the “Data” book, the “History” book, and the “Sensor” book, each having “YES” in the “visible” field, are regarded as being candidates for a book to be displayed in the bookshelf.

Here, since the “Sensor” book has “NO” in the substance field and “YES” in the visible field, the “Sensor” book is determined to be displayed in broken lines. Further, since the “Data” book has “UPDATED” in the status field, the “Data” book is determined to be displayed with the new arrival mark 122 shown on its spine label. Furthermore, since the “History” book has “NY” in the authentication status field, the “History” book is determined to be displayed with diagonal lines.

Subsequently, the layout control section 11 determines an arrangement of the books. For example, in the metaphor display management table shown in FIG. 5, the metaphor ID 2 having “ON” in a “default shelf display selection” field has “all” in the shelf display class field. Therefore, the layout control section 11 determines that all books are to be positioned in the first shelf of the bookshelf.

Next, the layout control section 11 determines the order of the arrangement of the books to be positioned in each shelf, according to the “positioning” field in the processing pattern ruleset. In the example shown in FIG. 4, the “Data” book has “1” set in the “positioning” field (on the column BC8); the “History” book has “−2” set in the “positioning” field; the “Sensor” book has “−1” set in the “positioning” field; and the “Data_oriented” book has “0” set in the “positioning” field. According to this, the “Data” book is determined to be displayed on the leftmost position in the bookshelf; the “Sensor” book is determined to be displayed on the rightmost position in the bookshelf; the “History” book is determined to be displayed on the second position from the right in the bookshelf; and the “Data_oriented” book is determined not to be displayed.

In this manner, the image of the bookshelf having books arranged in each shelf is generated. Then, this image is positioned on a layout template (see the column CC10 in FIG. 5) in the metaphor display management table, and thus the basic operation screen corresponding to the metaphor ID 2 as shown in FIG. 30 is completed.

After the basic operation screen has been displayed, the metaphor layout change flag is cleared, and the layouting and displaying process is ended once. However, the book layout change flag is still set. Therefore, if no entry operation is detected in S3 in FIG. 9 and the process goes to S2 so that a layouting and displaying process is performed again, the determination “NO” is made in S21 in FIG. 10 and the determination “YES” is made in S28. Then, a series of the processes (S29 to S33) related to change of the book layout is performed.

Note that, in this case, the book information management table for the metaphor ID 2 is referred to in S29, and a layout description file is selected in S30 from the processing pattern ruleset for metaphor ID 2. Further, in this case, since the basic operation screen has been already completed as described above, the process of S31 and S32 are omitted.

[Specific Operation Example (in a Case where the Data Book is Selected)]

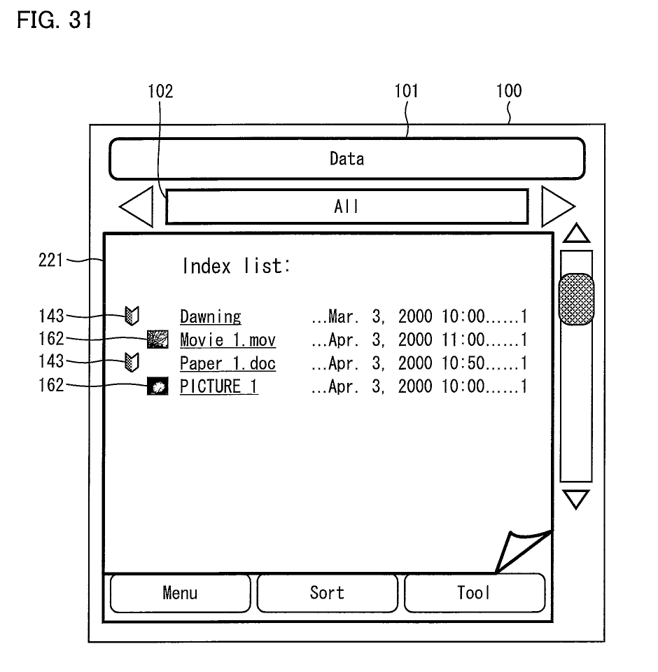

In the example shown in FIG. 30, in a case where the Data book (the book having “Data” on the spine label) is selected, an index list screen for the Data book is displayed. The following describes the index list screen for the Data book with reference to FIG. 31. FIG. 31 is a view showing an exemplary index list screen for the Data book.

As shown in FIG. 31, the name display field 101 shows “Data”, which is a title of the book whose index list is currently displayed. Further, the display operation area 02 displays an index list screen 221.

As shown in FIG. 4, the target extensions set for the Data book includes DOC, TXT, GIF, PNG, MP3, MP4, MOV, and others. Therefore, in the index list screen 221 for the Data book, file names corresponding to content items each having any of these extensions are displayed in a list, out of the content items managed in the content management table. Further, the index list screen 221 for the Data book also displays the bookmarker marks 143 and the thumbnail images 162. This is the same as in the examples shown in FIG. 16, FIG. 19, etc.

[Specific Operation Example (in a Case where the Shelf Display Class is Set to “Date”)]

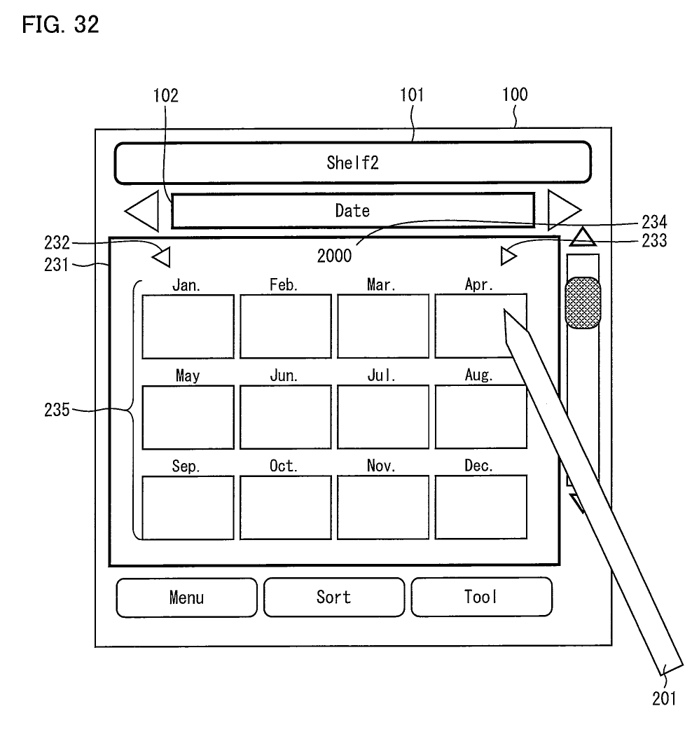

Next, the following describes, with reference to FIG. 32, an exemplary display screen observed when “Date” is caused to appear in the shelf display class display field 102 while the processing pattern ruleset (2) is applied. FIG. 32 is a view showing an exemplary display screen observed when “Date” is caused to appear in the shelf display class display field 102.

As shown in FIG. 32, in the case where “Date” is caused to appear in the shelf display class display field 102, a calendar 231 is displayed. The calendar 231 is configured to allow the user to select a desired date. The calendar in FIG. 32 omits dates, for the purpose of brevity. Actually, however, dates are shown in a rectangular box below the indication of each month.

The calendar 231 further includes a year switchover button (left) 232, a year switchover button (right) 233, and a year indication 234. The year indication 234 shows the year of the calendar 231; the year switchover button (left) 232 is used to switch the calendar 231 to a previous year's one; and the year switchover button (right) 233 is used to switch the calendar 231 to a following year's one.

Further, when determining that entry operation for selecting a date has been performed, the operation information interpreting section 10 displays an index list screen similar to the exemplary index list screen shown in FIG. 21, which displays a list of content items updated on the date selected.

The above arrangement in which a date is selectable from the calendar is preferable, because it allows the user to easily select a desired date. Note that the method for date entry is not limited to this example. Alternatively, for example, a drop-down list may be displayed so that a date is entered through the drop-down list.

Note that the display screen to be displayed when “Date” is caused to appear in the shelf display class display field 102 is defined by the “extraction rule description” (see CC6 in FIG. 5) in the metaphor display management table. The same goes for a display screen to be displayed when “Input” is caused to appear in the shelf display class display field 102. The display screen to be displayed when “Input” is caused to appear in the shelf display class display field 102 may be, for example, an image including a text box or the like into which a key word for a searching purpose is entered.

[Sensor Book]

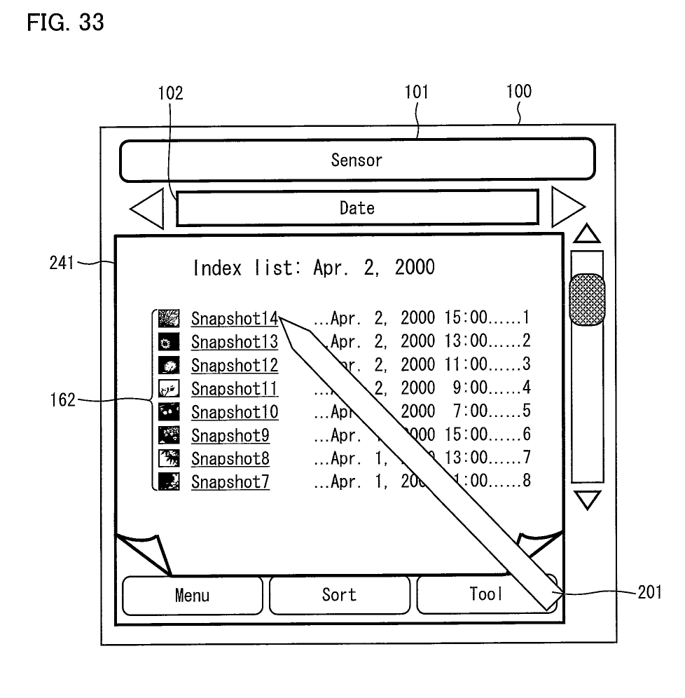

Next, details of the Sensor book (the book having “Sensor” on the spine label) will be described with reference to FIGS. 33 to FIG. 40. As described previously, the Sensor book is a book for reference to a content item whose entity is not stored in the content storage section 22.

FIG. 33 is a view showing an exemplary index list screen displayed when the Sensor book is selected. As shown in FIG. 33, the name display field 101 shows “Sensor”, which is a title of the book whose index list is currently displayed. Further, the shelf display class display field 102 shows “Date”, and the display operation area 02 displays an index list screen 241.

The index list screen 241 displays, in the form of an index list, a list of content items corresponding to that book. Also, in the example shown in FIG. 33, since “Date” is shown in the shelf display class display field 102, content items are displayed on the index list screen 241 in the order in which the content items have been obtained from outside the content processing apparatus 1.

In the example shown in FIG. 33, it is assumed that the content processing apparatus 1 communicates with a camera module through wired connection or wireless connection so that the content processing apparatus 1 can obtain a photograph image from the camera module. Therefore, the index list screen 241 displays, in a list form, Snapshot7 through Snapshot 14, each of which is a file name of an image captured by the camera module. Further, since the Sensor book has “YES” in the “thumbnail” field, the thumbnail images 162 for the images are respectively displayed, in a list form, next to the file names of their corresponding images.

In this manner, in the case of a Sensor book, content items obtained from e.g., a device or a storage medium existing outside the content processing apparatus 1 are displayed in the form of an index list. The index list screen 241 may be configured so as to display only latest content items thus obtained. Alternatively, the index list screen 241 may be configured so as to display content items including previously-obtained content items, as in the example shown in FIG. 33.

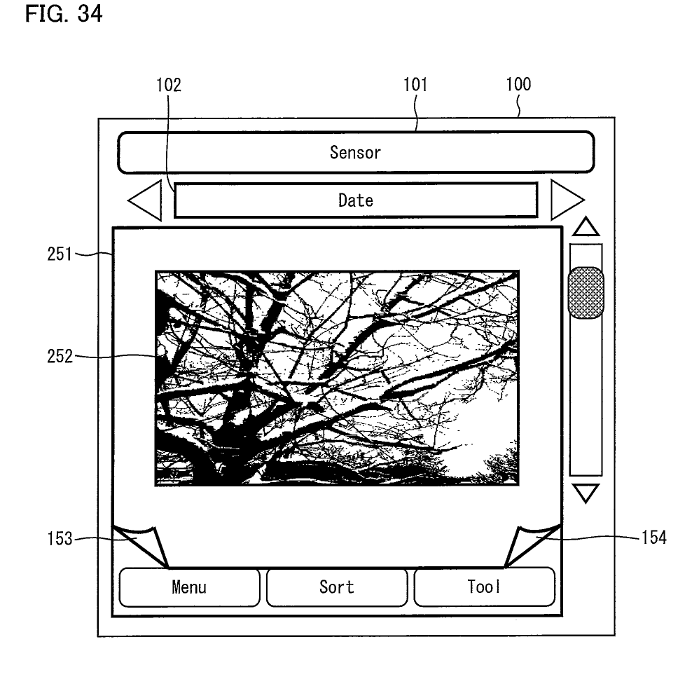

Here, in a case where a file is selected from the index list screen 241, an image of the file selected is displayed as shown in FIG. 34. FIG. 34 is a view showing an exemplary image displayed when “Snapshot14” in FIG. 33 is selected. As shown in FIG. 34, when a content item is selected from the index list displayed, the content processing apparatus 1 outputs the content item selected.

Note that the external device is not particularly limited as long as it is capable of providing the content processing apparatus 1 with a content item. Apart from the camera module described in the above example, for example, such a sensor device is applicable that is provided with a sensor that measures e.g., a temperature and/or a humidity and outputs data of a measured value and a time when the measurement has been carried out.

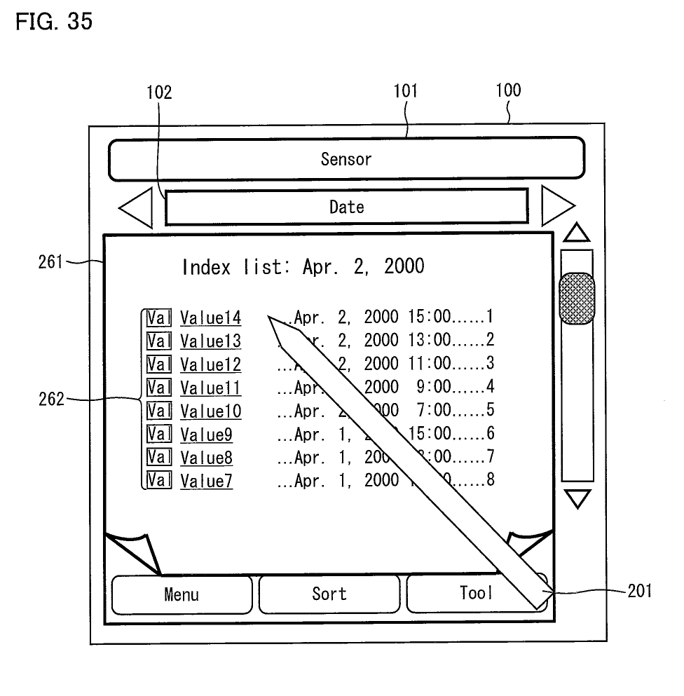

In this case, when a Sensor book is selected, an index list screen 261 as shown in FIG. 33 is displayed. FIG. 35 is a view showing an exemplary index list screen for the Sensor book. As shown in FIG. 35, the index list screen 261 displays, in the form of an index list, Value7 through Value14, each of which is an item indicative of data outputted by the sensor device, and also displays an icon 262 on the left side of each of the items. Each of Value7 through Value14 is data including a numeric value measured by the sensor device and a time when the value has been measured.

The icon 262 indicates that the content item having the icon 262 attached thereto is data indicative of a numeric value. The icon 262 is displayed in the same manner as the musical note mark 192 and the thumbnail image 162 (shown in FIG. 25, etc.).

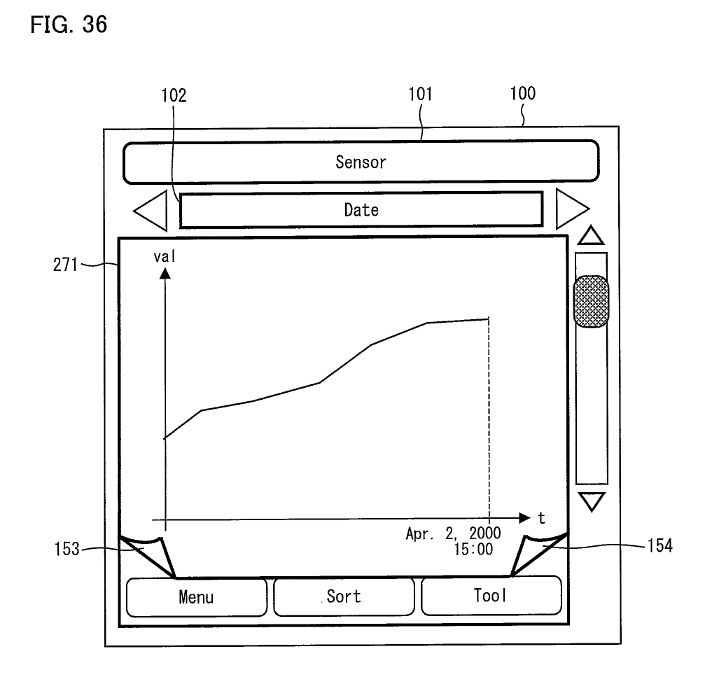

Here, in a case where any of the items is selected, data corresponding to the item selected is displayed as shown in FIG. 35. FIG. 36 is a view showing an exemplary image displayed when “Value14” in FIG. 35 is selected.

As shown in FIG. 35, since Value14 has been updated at 15:00 on Apr. 2, 2000, data obtained at 15:00 on Apr. 2, 2000 is to be displayed. FIG. 36 shows a graph of data obtained during a predetermined period of time ending at 15:00 on Apr. 2, 2000.

From the graph of the data obtained by the sensor device displayed in the above manner, the user can easily recognize the time-course changes of the data obtained by the sensor device. Of course, instead of the above arrangement, only data obtained at 15:00 on Apr. 2, 2000 may be displayed.

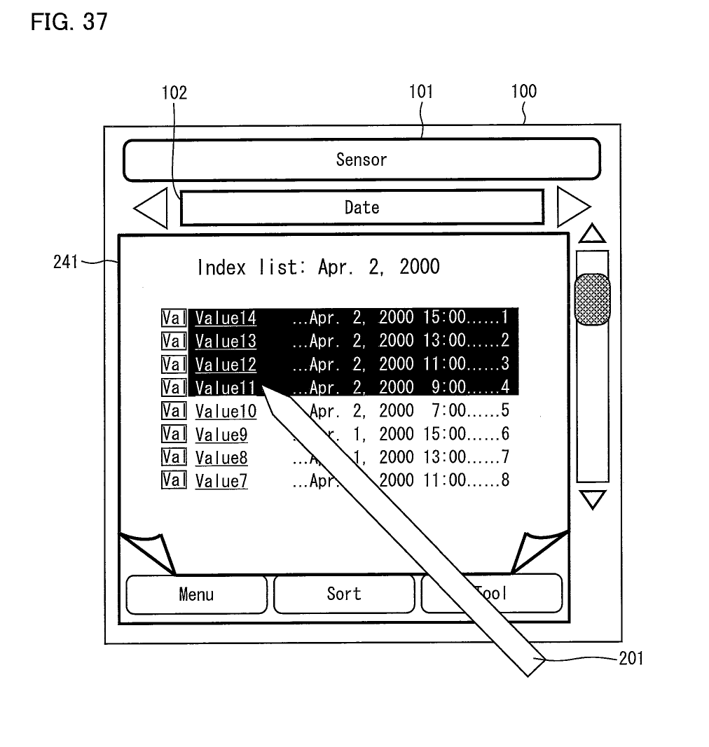

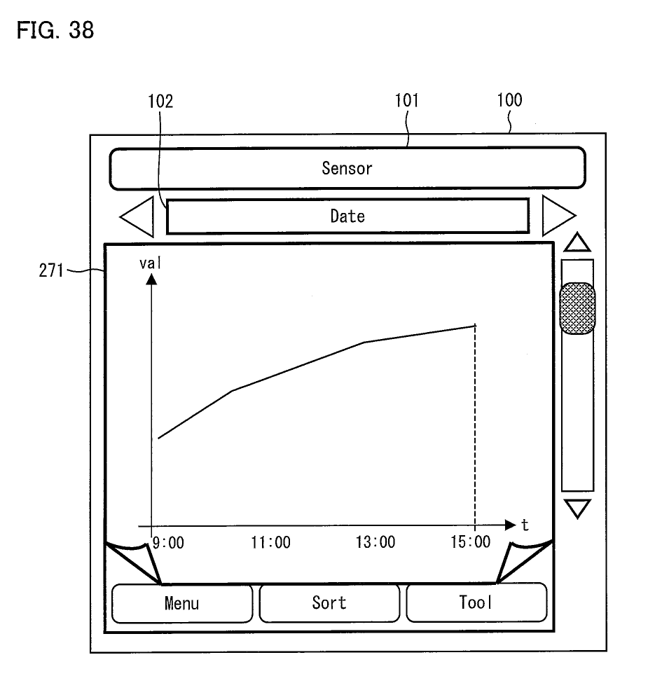

Further, the content processing apparatus 1 may be configured such that a plurality of items can be selected at a time from the index list screen 261 shown in FIG. 34. This will be explained with reference to FIGS. 370 and 38. FIG. 37 is a view showing an exemplary display screen observed when the plurality of items are selected at a time from the index list screen 261 shown in FIG. 35, whereas FIG. 38 is a view showing an exemplary display screen observed after the plurality of items are selected at a time.

Note that entry operation for selecting the plurality of items at a time is not particularly limited. For example, the following is possible: By performing entry operation, using the stylus 201, for pointing particular items of interest on the display section 5 so as to surround them, the plurality of items (Value11 to Value14) are selected as shown in FIG. 37.

In the case where the plurality of items are selected at a time, an image is displayed representing numerical values included in the content items in chronological order, according to the numerical values and times included in data items corresponding to the items selected. More specifically, when the operation information interpreting section 10 detects the entry operation for selecting the plurality of items at a time, the layout control section 11 extracts the numerical values and times from the data items corresponding to the items selected, and displays the image showing the numerical values extracted in chronological order.

The image representing the numerical values in chronological order is preferably a graph such as a line graph or a bar graph, or may be a numerical table in which the values are arranged in the order of time. FIG. 38 shows an example where data of selected items are displayed in the form of a line graph. This allows the user to easily recognize the time-course changes of data on the user-selected dates and times out of the data obtained by the sensor device.

Further, in the case where a list of file names of images is displayed (e.g., in the case of the index list screen 241 shown in FIG. 33), a plurality of file names may be made selectable. In this case, for example, images corresponding to the file names selected may be displayed in a slide show mode, or the images corresponding to the file names selected may be displayed in a list form.

[Specific Operation Example (Sorting)]

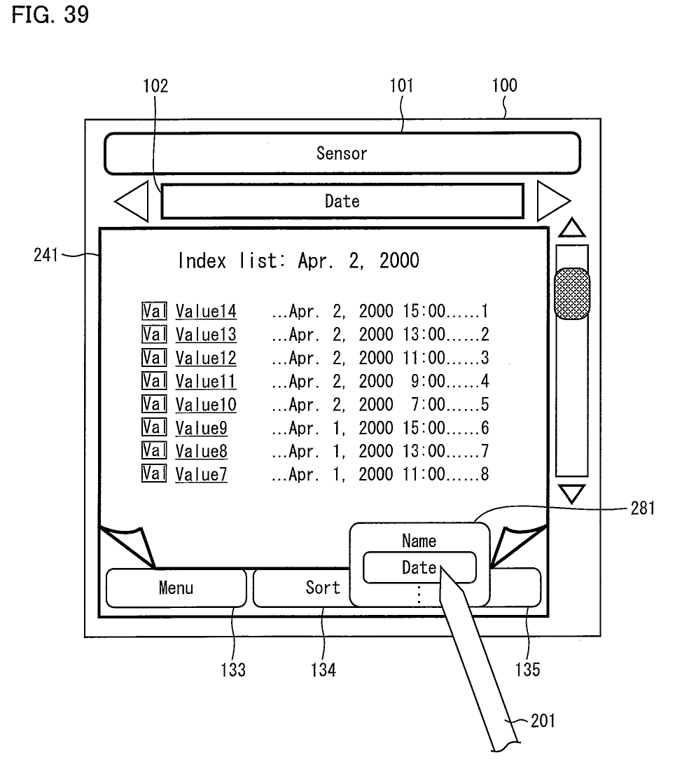

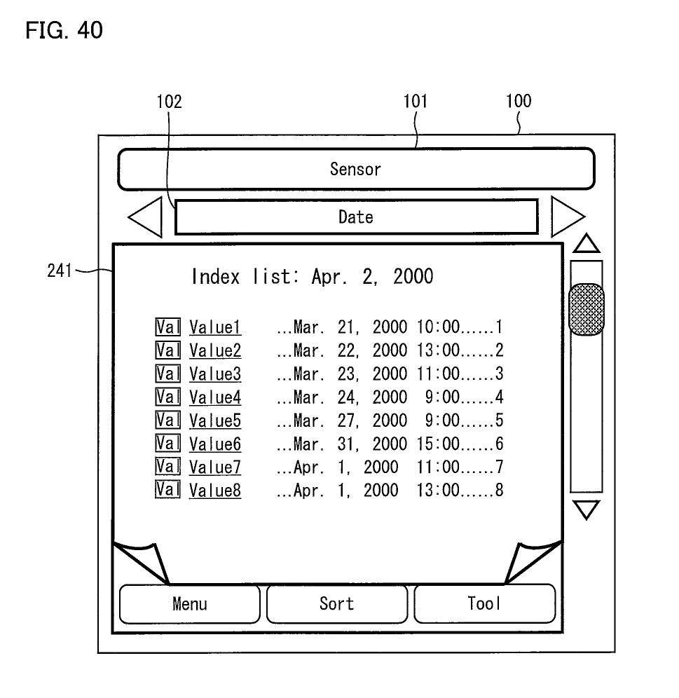

Next, the following describes, with reference to FIGS. 39 and 40, an exemplary display screen observed when sorting of items to be displayed in a list form on an index list screen is performed. FIG. 39 is a view showing an exemplary display screen observed when the sort button 134 is selected, whereas FIG. 40 is a view showing an exemplary display screen observed after the sorting is performed.

As shown in FIG. 39, if the sort button 134 is selected while the index list screen 241 is displayed, a menu window 281 appears. The menu window 281 shows a list of options that are sorting criteria. In the example shown in FIG. 39, the menu window 281 shows two options, “Name” and “Date”.

The “Name” is an option for sorting the item names (file names) displayed on the index list screen in ascending or descending order. The “Date” is an option for sorting the items (files) displayed on the index list screen by date and time of update so as to arrange the items in an ascending or descending order of update time. The sorting function is realized by the “sort control” stored in the field on the column BC10 of the processing pattern ruleset. Therefore, by defining sorting criteria in the “sort control” field in advance, it is possible to perform sorting with given criteria.

In a case where the “Date” is selected here, the items shown on the index list screen 241 are sorted in ascending order of date, as shown in FIG. 40. If the sort button 134 is further selected in this state to select the “Date”, the items shown on the index list screen 241 are sorted in descending order of date.

As described above, an interface apparatus according to the present invention includes: a ruleset selecting section for selecting one ruleset from among a plurality of rulesets, each of the rulesets including information for displaying the entry operation acceptance screen and information for interpreting a nature of an entry operation in a situation where the entry operation acceptance screen is being displayed; a screen display section for displaying the entry operation acceptance screen according to a ruleset selected by the ruleset selecting section; and an operation information interpreting section for interpreting a nature of a user's entry operation according to a ruleset selected by the ruleset selecting section.

This yields the effect that allows the user to manipulate content items in various manners using a single interface apparatus. This also makes it possible to deal with various kinds of content items obtained through various channels of distribution, using a single interface apparatus.

Further, it is preferable that the ruleset includes information for interpreting a nature of an entry operation performed on a content item that has been determined as being selected by the user and information for displaying a screen corresponding to the nature of the entry operation performed on the content item of interest, the operation information interpreting section interprets the nature of the entry operation performed on the content item that has been determined as being selected by the user, according to the ruleset selected by the ruleset selecting section, and the screen display section displays a screen corresponding to a result of interpretation performed by the operation information interpreting section, according to the ruleset selected by the ruleset selecting section.

According to the above arrangement, the ruleset includes information for interpreting a nature of an entry operation performed on a content item and information for displaying a screen corresponding to the nature of the entry operation performed on the content item of interest. Using such a ruleset, the nature of the entry operation performed on the content item that has been determined as being selected by the user is interpreted, and a screen is then displayed as a result of the interpretation. Further, the ruleset for use in interpretation of the entry operation and screen display is the one selected from among the plurality of rulesets.

That is, according to the above arrangement, when the ruleset is selected, the nature of the entry operation performed on the content item that has been determined as being selected by the user is interpreted according to the selected ruleset, and a screen to be displayed as a result of the interpretation is then determined. If the ruleset to be selected is changed, (i) the interpretation of the nature of the entry operation performed on the content item that has been determined as being selected by the user and (ii) the screen to be displayed as a result of the interpretation are changed according to the change of the ruleset.

Thus, according to the above arrangement, it is possible to perform, at a time, not only switching of the manner in which content items are presented to the user so that the user selects a content item from among the content items, but also switching of the manner in which the user manipulates the use-selected content item. This allows the user to manipulate a content item in various manners by using a single interface apparatus.

Further, it is preferable that the ruleset include an extraction criteria for content items, the screen display section displays, on the entry operation acceptance screen, a selection object matching the extraction criteria which are included in the ruleset selected by the ruleset selecting section, and when the operation information interpreting section determines that an entry operation for selecting the selection object has been performed, the screen display section displays a content name of a content item having been extracted according to the extraction criteria corresponding to the selection object of interest.

According to the above arrangement, the selection object matching the extraction criteria which are defined by the ruleset is displayed on the entry operation acceptance screen. Then, when the displayed selection object is selected, a content name of a content item extracted according to an extraction criteria corresponding to the thus selected selection object is displayed.

Therefore, according to the above arrangement, by selecting the selection object, the user can easily check only the content items extracted according to a predetermined extraction criteria.

Note that the extraction criteria may be one set of extraction criteria or plural sets of extraction criteria. If the extraction criteria is plural sets of extraction criteria, selection objects which match the respective sets of extraction criteria are preferably displayed, and each of the selection objects is preferably displayed with information indicating the extraction criteria associated with the selection object of interest.

The above-described extraction criteria is not particularly limited as long as it is criteria for extraction of a content item. For example, the above-described extraction criteria may be an extension. In such a case, it is possible to easily check content items with the same extension. Apart from this, the extraction criteria may be, for example, a filename, or a date of file update. Alternatively, the above-described extraction criteria may be entered by the user, so that a keyword or date entered by the user is used as the above-described extraction criteria.

Further, the above-described extraction criteria corresponding to one selection object may be one set of extraction criteria or plural sets of extraction criteria. In a case where on selection object is associated with plural sets of extraction criteria, a content item satisfying any of the sets of extraction criteria associated, or a content name of a content item satisfying all of the sets of extraction criteria associated may be displayed.

Besides, it is preferable that the displayed content name is made use-selectable, and when the content name is selected, a content item with the selected content name is outputted. That is, it is preferable that the content name and the corresponding content item are linked together. This allows the user to search for a desired content item and then output it.

Note that the output of a content item refers to display output, audio output, printed output of a content item. Moreover, the content item may be outputted to the above-described interface apparatus or an external device.

Still further, it is preferable that the ruleset includes a sub-rule that includes information for the screen display section providing a screen display after the selection object has been selected, and information for the operation information interpreting section interpreting the user's entry operation according to the screen display, the interface apparatus further comprises a sub-rule authenticating section for transmitting identification information, which identifies the interface apparatus of interest or the user of the interface apparatus, to a sub-rule authentication server, which authorizes a use of the sub-rule in response to a request from a predetermined entity, so as to make a request for authorization to use the sub-rule, and when the operation information interpreting section determines that the entry operation for selecting the selection object has been performed, the screen display section provides a screen display according to a sub-rule corresponding to the selected selection object if the sub-rule corresponding to the selected selection object is a sub-rule that the sub-rule authenticating section has obtained authorization to use from the sub-rule authentication server, and the operation information interpreting section then interprets the nature of the user's entry operation according to the screen display.

After the selection object has been selected, a content name of the content item extracted according to the extraction criteria corresponding to the selected selection object is displayed. The screen displayed after the selection of the selection object and the interpretation of the nature of the entry operation has a significant influence on the usability of a content item for the user and other elements. That is, a rule (sub-rule) that defines the screen display and the interpretation of the nature of the entry operation after the selection of the selection object is worthy in itself.

According to the above arrangement, authorization to use a sub-rule included in a ruleset is obtained from the sub-rule authentication server. When a selection object corresponding to the sub-rule the use of which has been authorized has been selected, the sub-rule is used for provision of a screen display and interpretation of the nature of the entry operation.

Conversely, according to the above arrangement, when a selection object corresponding to the sub-rule the use of which has not been authorized has been selected, the sub-rule is not used for provision of a screen display and interpretation of the nature of the entry operation.

With such an arrangement, it is possible to control the use of a useful sub-rule via the sub-rule authentication server. For example, it is possible to prevent an unauthorized user from using the sub-rule without proper authorization.

Yet further, the ruleset includes selection criteria for selection of a selection object to be displayed in a predetermined area on the entry operation acceptance screen, and the screen display section displays, in the predetermined area, the selection object selected according to the selection criteria.

According to the above arrangement, the selection object selected according to the selection criteria is displayed in the predetermined area. That is, according to the above arrangement, the selection object displayed in the predetermined area satisfies the selection criteria. This allows the user to smoothly access a content item that satisfies selection criteria.

The predetermined area may comprise one area, preferably a plurality of areas. It is preferable that the plurality of predetermined areas are associated with respectively different sets of selection criteria. Further, the selection criteria associated with the predetermined area may be changed by the user. This allows the user to more smoothly access a desired content item.

Further, it is preferable that the ruleset includes book image information that indicates appearance of a book, and the screen display section displays the selection object based on the book image information so that the selection object appears to be a book.

According to the above arrangement, the selection object appears to be a book on screen. That is, a book is displayed as the selection object on the entry operation acceptance screen. This allows the user to, by selecting the on-screen book, check a content name that satisfies the extraction criteria associated with the selected book (i.e. the selected selection object).

The on-screen book preferably has a spine label or the like on which information indicating the extraction criteria associated with the corresponding selection object is provided as a book title. This allows the user to manipulate a content item in much the same way that the user selects a book, which is convenient to users who are unfamiliar with computers.

Further, it is preferable that when the operation information interpreting section determines that the entry operation for selecting the selection object has been performed, the screen display section displays an image of a page of an opened book on which page the content name of the content item that has been extracted according to the extraction criteria corresponding to the selected selection object is provided, according to the book image information.

According to the above arrangement, when the book (i.e. selection object) displayed on the entry operation acceptance screen is selected, an image of an opened book is displayed thereon with a content name appeared on a page of the opened book. Therefore, the above arrangement allows the user to manipulate a content item in much the same way that the user selects a book and opens the book, which is convenient to users who are unfamiliar with computers.

Further, it is preferable that the interface apparatus further includes a yet-to-be selected content item information storage section for storing yet-to-be selected content item information that indicates a content item that has not yet been selected by the user, wherein in a case where a content item identified by the yet-to-be selected content item information is contained in content items having been extracted according to the extraction criteria corresponding to the selection object, the screen display section displays information indicating inclusion of a yet-to-be selected content item, together with the selection object.

According to the above arrangement, information indicating inclusion of a yet-to-be selected content item is displayed together with the selection object. This allows the user to find out a selection object for reference to the yet-to-be selected content item with the help of the displayed information, which allows the user to smoothly access the yet-to-be selected content item.

The yet-to-be selected content item includes not only a content item that has not outputted in the past by the interface apparatus and has not yet outputted by an external device according to instructions from the interface apparatus, but also a content item that has been outputted by the interface apparatus or the external device but has not been outputted after updating, i.e. a content item that has not been selected after updating.

It is preferable that the interface apparatus further includes: a selected content item information storage section for storing selected content item information indicating a content item that has been selected by the user, wherein the screen display section displays a selected content item selection object, and when the operation information interpreting section determines that an entry operation for selecting the selected content item selection object has been performed, the screen display section displays a content name of a content item identified by the selected content item information, with reference to the selected content item information storage section.

According to the above arrangement, a selected content item selection object for reference to the selected content item is displayed. When the selected content item selection object is selected, a content name of the selected content item is displayed. This allows the user to easily check a content item that has been selected in the past.

The selected content item refers to a content item such that the user has selected using the interface apparatus, when the content item of interest is to be outputted by the interface apparatus or the external device and in the like cases.

As with the above content item selection object, the selected content item selection object is preferably displayed in the form of a book. Moreover, the selected content item information and the yet-to-be selected content item information, both of which indicate the presence or absence of selection of each content item, may be the same data. That is, if a data item indicating the presence or absence of selection of each content item is provided, the data item can be used as the selected content item information or as the yet-to-be selected content item information.

Further, it is preferable that the interface apparatus further includes: an external data receiving section for receiving a content item from an external device that exists outside the interface apparatus, wherein the screen display section displays an external content selection object, and when the operation information interpreting section determines that an entry operation for selecting the external content selection object has been performed, the screen display section displays a content name of a content item having been received from the external device.

According to the above arrangement, the external content selection object for reference to the content item having been received from the external device is displayed. When the external content selection object is selected, a content name of the content item having been received from the external device is displayed. This allows the user to easily check a content item having been received from the external device.

Further, it is preferable that the content item is data including a numeric value and time, and when a plurality of content names have been selected from among content names displayed on the screen display section, the screen display section displays, on a basis of numerical values and times contained in content items identified by the selected content names, an image representing the numerical values contained in the respective content items in chronological order.

In a case where a plurality of content items have been received from the external device, content names of the respective content items received are displayed. According to the above arrangement, when a plurality of content names are selected from among the content items having been received from the external device, an image representing numerical values contained in the respective content items in chronological order is displayed on the basis of the numerical values and times contained in the respective content items.

This allows the user to easily recognize changes over time in the numerical values contained in the content items having been received from the external device. For example, assume that the external device obtains temperatures at predetermined intervals then outputs numerical values of the obtained temperatures and times when the temperatures have been obtained. In such a case, with the interface apparatus, changes in temperature over time can be easily checked. The image representing the numerical values in chronological order is preferably a line graph, a bar graph, or any other graphs, but it can be a numerical table in which the numerical values are arranged in the order of time.

Further, it is preferable that the interface apparatus further includes a communication section for connecting to a network for communications; and a ruleset obtaining section for obtaining the ruleset via the communication section from other apparatus that is connected to the network.

According to the above arrangement, display of the screen and interpretation of the user's entry operation are performed according to the ruleset having been obtained via the communication section. That is, according to the above arrangement, it is possible to obtain the ruleset from outside the interface apparatus via the communication section, and the displayed screen and interpretation of entry operation vary according to the obtained ruleset.

Therefore, the above arrangement allows the user to manipulate content items in various manners using a single interface apparatus. This also makes it possible to deal with various kinds of content items obtained through various channels of distribution, using a single interface apparatus.

Besides, according to the above arrangement, it is possible to install via the network a ruleset created by a person skilled in manipulations of devices and information. This makes it possible to easily obtain a know-how of such a person, and to easily implement an interface for common use among a plurality of interface apparatuses. This makes it possible to increase the efficiency in usage of services providing content items.

Further, it is preferable that the interface apparatus further includes: a ruleset authenticating section for transmitting identification information, which identifies the interface apparatus or the user of the interface apparatus, to a ruleset authentication server, which authorizes a use of the ruleset in response to a request from a predetermined entity, so as to make a request for authorization to use the ruleset, wherein the ruleset selecting section selects a ruleset that the ruleset authenticating section has obtained authorization to use from the ruleset authentication server.

As described previously, the sub-rule for screen display and interpretation of the entry operation has a significant influence on the usability of a content item for the user and other elements and is therefore worthy in itself. Similarly, the ruleset for screen display and interpretation of the entry operation is worthy in itself.

According to the above arrangement, authorization to use the ruleset is obtained from the ruleset authentication server. Only a ruleset use of which has been authorized is subjected to selection. Conversely, a ruleset use of which has not been authorized is not subjected to selection.

With such an arrangement, it is possible to control the use of a useful ruleset via the ruleset authentication server. For example, it is possible to prevent an unauthorized user from using the ruleset without proper authorization.

In a case where the sub-rule is contained in the ruleset, authorization to use the sub-rule may be obtained concurrently with authorization to use the ruleset, or authorization to use the sub-rule may be obtained separately.

Furthermore, the interface apparatus may be realized by a computer. In this case, the present invention also encompasses a control program of an interface apparatus that causes a computer to realize the interface apparatus by operating the computer as the foregoing sections, and a computer-readable storage medium storing the control program.

[Supplementary Remarks]

In the examples given above, when a content item to be outputted is selected from the image for entry operation, the content processing apparatus 1 outputs the selected content item. Alternatively, an external device may output the selected content item. That is, the content processing apparatus 1 needs to serve at least as a user interface that presents content items and accepts selection entries.

The present invention is not limited to the aforementioned embodiments and is susceptible of various changes within the scope of the accompanying claims. That is, embodiments obtained by suitable combinations of technical means modified within the scope of the accompanying claims are also included within the technical scope of the present invention.

[Examples of Software-Based Implementation]

Finally, each of the blocks in the content processing apparatus 1, particularly the operation information interpreting section 10, the layout control section 11, the content managing section 12, the metaphor managing section 13, and the trust managing section 14 may be constituted by hardware logic or realized by software by means of a CPU (central processing unit) as shown below.

That is, the content processing apparatus 1 includes a CPU that executes the order of a control program for realizing the aforesaid functions, ROM (read only memory) that stores the control program, RAM (random access memory) that develops the control program in executable form, and a storage device (storage medium), such as memory, that stores the control program and various types of data therein. The object of the present invention is realized by a predetermined storage medium. The storage medium stores, in computer-readable manner, program codes (executable code program, intermediate code program, and source program) of the control program of the content processing apparatus 1, which is software for realizing the aforesaid functions. The storage medium is provided to the content processing apparatus 1. With this arrangement, the content processing apparatus 1 (alternatively, CPU or MPU) as a computer reads out and executes program code stored in the storage medium provided.

The storage medium may be tape based, such as a magnetic tape or cassette tape; disc based, such as a magnetic disk including a Floppy® disc and hard disk and optical disk including CD-ROM, MO, MD, DVD, and CD-R; card based, such as an IC card (including a memory card) and an optical card; or a semiconductor memory, such as a mask ROM, EPROM, EEPROM, and a flash ROM.

Further, the content processing apparatus 1 may be arranged so as to be connectable to a communications network so that the program code is supplied to the content processing apparatus 1 through the communications network. The communications network is not to be particularly limited. Examples of the communications network include the Internet, intranet, extranet, LAN, ISDN, VAN, CATV communications network, virtual private network, telephone network, mobile communications network, and satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared light, Bluetooth®, 802.11, HDR, mobile phone network, satellite connections, and terrestrial digital network. Note that the present invention can be also realized by the program codes in the form of a computer data signal embedded in a carrier wave which is embodied by electronic transmission.

Specific embodiments or examples implemented in the description of the embodiments only show technical features of the present invention and are not intended to limit the scope of the invention. Variations can be effected within the spirit of the present invention and the scope of the following claims.

### INDUSTRIAL APPLICABILITY

A content processing apparatus of the present invention allows the user to easily refer to and output a desired content item, and can be suitably applied to an apparatus that performs content management, content output, and the like operations. For example, a content processing apparatus of the present invention can be suitably applied to a personal computer (PC), a mobile PC, a smart phone, a portable telephone, an electronic dictionary, a portable game machine, a television set, etc.

### REFERENCE SIGNS LIST

1 content processing apparatus (interface apparatus)
3 processing pattern control section
7 external data input/output section (external data receiving section)
8 transmitter/receiver section (communication section)
10 operation information interpreting section (operation information interpreting section)
11 layout control section (screen display section)
12 content managing section
13 metaphor managing section (ruleset selecting section, ruleset obtaining section)
14 trust managing section (sub-rule authenticating section, ruleset authenticating section)
21 processing pattern rule storage section
23 metaphor management data storage section (selected content item information storage section, yet-to-be selected content item information storage section)

1. An interface apparatus which displays an entry operation acceptance screen for causing a user to select one or more content items from among a plurality of content items and interprets an entry operation inputted by the user according to the displayed entry operation acceptance screen so as to determine a content item selected by the user,
the interface apparatus comprising:
a ruleset selecting section for selecting one ruleset from among a plurality of rulesets, each of the rulesets including information for displaying the entry operation acceptance screen and information for interpreting a nature of an entry operation in a situation where the entry operation acceptance screen is being displayed;
a screen display section for displaying the entry operation acceptance screen according to a ruleset selected by the ruleset selecting section; and
an operation information interpreting section for interpreting a nature of a user's entry operation according to a ruleset selected by the ruleset selecting section.

2. The interface apparatus according to claim 1, wherein
the ruleset includes information for interpreting a nature of an entry operation performed on a content item that has been determined as being selected by the user and information for displaying a screen corresponding to the nature of the entry operation performed on the content item of interest,
the operation information interpreting section interprets the nature of the entry operation performed on the content item that has been determined as being selected by the user, according to the ruleset selected by the ruleset selecting section, and
the screen display section displays a screen corresponding to a result of interpretation performed by the operation information interpreting section, according to the ruleset selected by the ruleset selecting section.

3. The interface apparatus according to claim 1, wherein
the ruleset include an extraction criteria for content items,
the screen display section displays, on the entry operation acceptance screen, a selection object matching the extraction criteria which are included in the ruleset selected by the ruleset selecting section, and
when the operation information interpreting section determines that an entry operation for selecting the selection object has been performed, the screen display section displays a content name of a content item having been extracted according to the extraction criteria corresponding to the selection object of interest.

4. The interface apparatus according to claim 3, wherein
the ruleset includes a sub-rule that includes information for the screen display section providing a screen display after the selection object has been selected, and information for the operation information interpreting section interpreting the user's entry operation according to the screen display,
the interface apparatus further comprises a sub-rule authenticating section for transmitting identification information, which identifies the interface apparatus of interest or the user of the interface apparatus, to a sub-rule authentication server, which authorizes a use of the sub-rule in response to a request from a predetermined entity, so as to make a request for authorization to use the sub-rule, and
when the operation information interpreting section determines that the entry operation for selecting the selection object has been performed, the screen display section provides a screen display according to a sub-rule corresponding to the selected selection object if the sub-rule corresponding to the selected selection object is a sub-rule that the sub-rule authenticating section has obtained authorization to use from the sub-rule authentication server, and the operation information interpreting section then interprets the nature of the user's entry operation according to the screen display.

5. The interface apparatus according to claim 3, wherein
the ruleset includes selection criteria for selection of a selection object to be displayed in a predetermined area on the entry operation acceptance screen, and
the screen display section displays, in the predetermined area, the selection object selected according to the selection criteria.

6. The interface apparatus according to claim 3, wherein
the ruleset includes book image information that indicates appearance of a book, and
the screen display section displays the selection object based on the book image information so that the selection object appears to be a book.

7. The interface apparatus according to claim 6, wherein
when the operation information interpreting section determines that the entry operation for selecting the selection object has been performed, the screen display section displays an image of a page of an opened book on which page the content name of the content item that has been extracted according to the extraction criteria corresponding to the selected selection object is provided, according to the book image information.

8. The interface apparatus according to claim 3, further comprising:
a yet-to-be selected content item information storage section for storing yet-to-be selected content item information that indicates a content item that has not yet been selected by the user, wherein
in a case where a content item identified by the yet-to-be selected content item information is contained in content items having been extracted according to the extraction criteria corresponding to the selection object, the screen display section displays information indicating inclusion of a yet-to-be selected content item, together with the selection object.

9. The interface apparatus according to claim 1, further comprising:
a selected content item information storage section for storing selected content item information indicating a content item that has been selected by the user,
wherein
the screen display section displays a selected content item selection object, and
when the operation information interpreting section determines that an entry operation for selecting the selected content item selection object has been performed, the screen display section displays a content name of a content item identified by the selected content item information, with reference to the selected content item information storage section.

10. The interface apparatus according to claim 1, further comprising:
an external data receiving section for receiving a content item from an external device that exists outside the interface apparatus,
wherein
the screen display section displays an external content selection object, and
when the operation information interpreting section determines that an entry operation for selecting the external content selection object has been performed, the screen display section displays a content name of a content item having been received from the external device.

11. The interface apparatus according to claim 10, wherein
the content item is data including a numeric value and time, and
when a plurality of content names have been selected from among content names displayed on the screen display section, the screen display section displays, on a basis of numerical values and times contained in content items identified by the selected content names, an image representing the numerical values contained in the respective content items in chronological order.

12. The interface apparatus according to claim 1, further comprising:
a communication section for connecting to a network for communications; and
a ruleset obtaining section for obtaining the ruleset via the communication section from other apparatus that is connected to the network.

13. The interface apparatus according to claim 1, further comprising:
a ruleset authenticating section for transmitting identification information, which identifies the interface apparatus or the user of the interface apparatus, to a ruleset authentication server, which authorizes a use of the ruleset in response to a request from a predetermined entity, so as to make a request for authorization to use the ruleset, wherein
the ruleset selecting section selects a ruleset that the ruleset authenticating section has obtained authorization to use from the ruleset authentication server.

14. A control method of an interface apparatus which displays an entry operation acceptance screen for causing a user to select one or more content items from among a plurality of content items and interprets an entry operation inputted by the user according to the displayed entry operation acceptance screen so as to determine a content item selected by the user,
the control method comprising:
a ruleset selecting step of selecting one ruleset from among a plurality of rulesets, each of the rulesets including information for displaying the entry operation acceptance screen and information for interpreting a nature of an entry operation in a situation where the entry operation acceptance screen is displayed;
a screen display step of displaying the entry operation acceptance screen according to a ruleset selected in the ruleset selecting step; and
an operation information interpreting step of interpreting a nature of a user's entry operation according to a ruleset selected in the ruleset selecting step.

15. A computer-readable storage medium storing a control program for operating an interface apparatus which displays an entry operation acceptance screen for causing a user to select one or more content items from among a plurality of content items and interprets an entry operation inputted by the user according to the displayed entry operation acceptance screen so as to determine a content item selected by the user,
the control program causing a computer to execute:
a ruleset selecting step of selecting one ruleset from among a plurality of rulesets, each of the rulesets including information for displaying the entry operation acceptance screen and information for interpreting a nature of an entry operation in a situation where the entry operation acceptance screen is displayed;
a screen display step of displaying the entry operation acceptance screen according to a ruleset selected in the ruleset selecting step; and
an operation information interpreting step of interpreting a nature of a user's entry operation according to a ruleset selected in the ruleset selecting step.
